(19) United States
(12) Patent Application Publication
(10) Pub. No.: US 2015/0222705 A1
(43) Pub. Date: Aug. 6, 2015

(54) LARGE-SCALE DATA STORAGE AND DELIVERY SYSTEM

(71) Applicant: PI-CORAL, INC., San Jose, CA (US)

(72) Inventor: Donpaul C. Stephens, Houston, TX (US)

(73) Assignee: Pi-Coral, Inc., San Jose, CA (US)

(21) Appl. No.: 14/426,567

(22) PCT Filed: Sep. 6, 2013
(86) PCT No.: PCT/US2013/058643

§ 371 Date: Mar. 6, 2015

Related U.S. Application Data
(60) Provisional application No. 61/697,711, filed on Sep. 6, 2012.
(60) Provisional application No. 61/799,487, filed on Mar. 15, 2013.

(51) Int. Cl. H04L 29/08

(52) U.S. Cl. CPC H04L 67/1097; H04L 67/2842

(57) ABSTRACT

This described technology generally relates to a data management system configured to implement, among other things, web-scale computing services, data storage and data presentation. Web-scale computing services are the fastest growing segment of the computing technology and services industry. In general, web-scale refers to computing platforms that are reliable, transparent, scalable, secure, and cost-effective. Illustrative web-scale platforms include utility computing, on-demand infrastructure, cloud computing, Software as a Service (SaaS), and Platform as a Service (PaaS). Consumers are increasingly relying on such web-scale services, particularly cloud computing services, and enterprises are progressively migrating applications to operate through web-scale platforms.

### CROSS REFERENCE TO RELATED APPLICATIONS

This application claims the benefit of U.S. Provisional Application Nos. 61/697,711 filed on Sep. 6, 2012 and 61/799,487 filed on Mar. 15, 2013 the contents of which are incorporated by reference in their entirety as if fully set forth herein.

### BACKGROUND

Web-scale computing services are the fastest growing segment of the computing technology and services industry. In general, web-scale refers to computing platforms that are reliable, transparent, scalable, secure, and cost-effective. Illustrative web-scale platforms include utility computing, on-demand infrastructure, cloud computing, Software as a Service (SaaS), and Platform as a Service (PaaS). Consumers are increasingly relying on such web-scale services, particularly cloud computing services, and enterprises are progressively migrating applications to operate through web-scale platforms.

This increase in demand has exposed challenges that result from scaling computing devices and networks to handle web-scale applications and data requests. For example, web-scale data centers typically have cache coherency problems and an inability to be consistent, available, and partitioned concurrently. Attempts to manage these problems on such a large scale in a cost-effective manner have proven ineffective. For example, current solutions typically use existing consumer or enterprise equipment and devices, leading to a trade-off between capital costs and operational costs. For instance, enterprise equipment typically leads to systems with higher capital costs and lower operational costs, while consumer equipment typically leads to systems with lower capital costs and higher operational costs. In the current technological environment, small differences in cost may be the difference between success and failure for a web-based service. Accordingly, a need exists to provide custom equipment and devices that allow for cost-effective scaling of applications and data management that are capable of meeting the demands of web-scale services.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a data storage array may comprise at least one array access module operatively coupled to a plurality of computing devices, the at least one array access module being configured to receive data requests from the plurality of computing devices, the data requests comprising read requests and write requests, format the data requests for transmission to a data storage system comprising a cache storage component and a persistent storage component, and format output data in response to a data request for presentation to the plurality of computing devices; and at least one cache lookup module operatively coupled to the at least one array access module and the persistent storage component, the at least one cache lookup module having at least a portion of the cache storage component arranged therein, wherein the at least one cache lookup module is configured to: receive the data requests from the at least one array access module, lookup meta-data associated with the data requests in the data storage system, read output data associated with read data requests from the data storage system for transmission to the at least one array access module, and store input data associated with the write data requests in the data storage system.

In an embodiment, a method of managing access to data stored in a data storage array for a plurality of computing devices, the method comprising: operatively coupling at least one array access module to a plurality of computing devices; receiving data requests from the plurality of computing devices at the at least one array access module, the data requests comprising read requests and write requests; formatting, by the at least one array access module, the data requests for transmission to a data storage system comprising a cache storage component and a persistent storage component; formatting, by the at least one array access module, output data in response to a data request for presentation to the plurality of computing devices; operatively coupling at least one cache lookup module to the at least one array access module and the persistent storage component, the at least one cache lookup module having at least a portion of the cache storage component arranged therein; receiving the data requests from the at least one array access module at the at least one cache lookup module; looking up, by the at the at least one cache lookup module, meta-data associated with the data requests in the data storage system; reading, by the at the at least one cache lookup module, output data associated with read data requests from the data storage system for transmission to the at least one array access module; and storing, by the at the at least one cache lookup module, input data associated with the write data requests in the data storage system.

### BRIEF DESCRIPTION OF THE FIGURES

FIGS. 1A and 1B depict an illustrative data management system according to some embodiments.

FIGS. 2A-G depicts an illustrative array access module (AAM) according to multiple embodiments.

FIG. 3A-D depicts an illustrative cache lookup module (CLM) according to multiple embodiments.

FIG. 4A depicts a top view of a portion of an illustrative data storage array according to a first embodiment.

FIG. 4B depicts a media-side view of a portion of an illustrative data storage array according to a first embodiment.

FIG. 4C depicts a cable-side view of a portion of an illustrative data storage array according to a first embodiment.

FIG. 4D depicts a side view of a portion of an illustrative data storage array according to a first embodiment.

FIG. 4E depicts a top view of a portion of an illustrative data storage array according to a second embodiment.

FIG. 4F depicts a top view of a portion of an illustrative data storage array according to a third embodiment.

FIG. 4G depicts a top view of a portion of an illustrative data storage array according to a fourth embodiment.

FIG. 4H depicts an illustrative system control module according to some embodiments.

FIG. 5A depicts an illustrative persistent storage element according to a first embodiment.

FIG. 5B depicts an illustrative persistent storage element according to a second embodiment.

FIG. 5C depicts an illustrative persistent storage element according to a third embodiment.

FIG. 6A depicts an illustrative flash card according to a first embodiment.

FIG. 6B depicts an illustrative flash card according to a second embodiment.

FIG. 6C depicts an illustrative flash card according to a third embodiment.

FIG. 7A depicts connections between AAMs and CLMs according to an embodiment.

FIG. 7B depicts an illustrative CLM according to an embodiment.

FIG. 7C depicts an illustrative AAM according to an embodiment.

FIG. 7D depicts an illustrative CLM according to an embodiment.

FIG. 7E depicts illustrative connections between a CLM and a plurality of persistent storage devices.

FIG. 7F depicts illustrative connections between CLMs, AAMs and persistant storage according to an embodiment.

FIG. 7G depicts illustrative connections between CLMs and persistent storage according to an embodiment.

FIGS. 8A and 8B depict flow diagrams for an illustrative method of performing a read input/output (IO) request according to an embodiment.

FIGS. 9A-9C depict flow diagrams for an illustrative method of performing a write IO request according to an embodiment.

FIG. 10 depicts a flow diagram for an illustrative method of performing a compare and swap (CAS) IO request according to an embodiment.

FIG. 11 depicts a flow diagram for an illustrative method of retrieving data from persistent storage according to a second embodiment.

FIG. 12 depicts an illustrative orthogonal RAID (random array of independent disks) configuration according to some embodiments.

FIG. 13A depicts an illustrative non-fault write in an orthogonal RAID configuration according to an embodiment.

FIG. 13B depicts an illustrative data write using a parity module according to an embodiment.

FIG. 13C depicts an illustrative cell page to cache data write according to an embodiment.

FIGS. 14A and 14B depict illustrative data storage configurations using logical block addressing (LBA) according to some embodiments.

FIG. 14C depicts an illustrative LBA mapping configuration 1410 according to an embodiment.

FIG. 15 depicts a flow diagram of data from AAMs to persistent storage according to an embodiment.

FIG. 16 depicts address mapping according to some embodiments.

FIG. 17 depicts at least a portion of an illustrative persistent storage element according to some embodiments.

FIG. 18 depicts an illustrative configuration of RAID from CLMs to persistent storage devices (PSMs) and from PSMs to CLMs.

FIG. 19 depicts an illustrative power distribution and hold unit (PDHU) according to an embodiment.

FIG. 20 depicts an illustrative system stack according to an embodiment.

FIG. 21A depicts an illustrative data connection plane according to an embodiment.

FIG. 21B an illustrative control connection plane according to a second embodiment.

FIG. 22A depicts an illustrative data-in-flight data flow on a persistent storage device according to an embodiment.

FIG. 22B depicts an illustrative data-in-flight data flow on a persistent storage device according to a second embodiment.

FIG. 23 depicts an illustrative data reliability encoding framework according to an embodiment.

FIGS. 24A-25B depict illustrative read and write data operations according to some embodiments.

FIG. 25 depicts an illustration of non-transparent bridging for remapping addressing to mailbox/doorbell regions according to some embodiments.

FIG. 26 depicts an illustrative addressing method of writes from a CLM to a PSM according to some embodiments.

FIG. 27A and FIG. 27B depict an illustrative flow diagram of a first part and second part, respectively, of a read transaction.

FIG. 27C depicts an illustrative flow diagram of a write transaction according to some embodiments.

FIGS. 28A and 28B depict illustrative data management system units according to some embodiments.

FIG. 29 depicts an illustrative web-scale data management system according to an embodiment.

FIG. 30 depicts an illustrative flow diagram of data access within a data management system according to certain embodiments.

FIG. 31 depicts an illustrative redistribution layer according to an embodiment.

FIG. 32A depicts an illustrative write transaction for a large-scale data management system according to an embodiment.

FIG. 32B depicts an illustrative read transaction for a large-scale data management system according to an embodiment.

FIGS. 32C and 32D depict a first part and a second part, respectively, of an illustrative compare-and-swap (CAS) transaction for a large-scale data management system according to an embodiment.

FIG. 33A and depicts an illustrative storage magazine chamber according to a first embodiment.

FIG. 33B and depicts an illustrative storage magazine chamber according to a first embodiment.

FIG. 34 depicts an illustrative system for connecting secondary storage to a cache.

FIG. 35A depicts a top view of an illustrative storage magazine according to an embodiment.

FIG. 35B depicts a media-side view of an illustrative storage magazine according to an embodiment.

FIG. 35C depicts a cable-side view of an illustrative storage magazine according to an embodiment.

FIG. 36A depicts a top view of an illustrative data servicing core according to an embodiment.

FIG. 36B depicts a media-side of an illustrative data servicing core according to an embodiment.

FIG. 36C depicts a to cable-side p view of an illustrative data servicing core according to an embodiment.

FIG. 37 depicts an illustrative chamber control board according to an embodiment.

FIG. 38 depicts an illustrative RX-blade according to an embodiment.

### DETAILED DESCRIPTION

In the following detailed description, reference is made to the accompanying figures, which form a part hereof. In the drawings, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

System described herein enables:

A. A single physical storage chassis which enables construction of a DRAM caching layer which is over 10× as large as any existing solution through the use of a custom fabric and software solution while leveraging Commercial Off The Shelf components in the construction. This system can leverage a very large (100 DIMM+effective DRAM cache after internal overheads) to enable cache sizes which can contain tens of seconds to minutes of expected access from external clients (users) thereby enabling significant reduction in the IO operations to any back-end storage system. As the cache size can be extremely large, spatial locality of external access is far more likely to be captured by the temporal period during which content will be in the DRAM cache. Data which is frequently overwritten, such as relatively small journals or synchronization structures, are highly likely to exist purely in the DRAM cache layer.

B. The large number of memory modules that can be employed in the cache can enable large capacity DRAM modules or just large number of mainstream density DRAM modules—depending on the desired caching capability.

C. The scale of the DRAM cache and the temporal coverage so provided enables a far more efficient Lookup Table system wherein data can be represented in larger elements as finer grain components may be entirely operated on in the cache without any need for operation natively to the back-end storage. The reduction in the size of the Lookup Tables compensates for the size of the DRAM cache in that the number of elements in the Lookup Tables is significantly reduced from a traditional Flash storage system that employs granularity at 1 KB to 4 KB vs. 16 KB+ in this system. The reduction in elements constructively enables the cache to be kept in the space gained back by reducing the table size. The result is a system with far more efficient use of DRAM while at the same time providing higher performance through parallelism.

D. The size of the enabled DRAM cache could be used to enable a system such as this that employs mechanical disk based storage to constructively outperform a storage array architecture which uses Flash SSDs, therefore applying such a DRAM caching system in conjunction with a Flash solution enables exceptionally low latency and high bandwidth to a massive shared DRAM cache while preserving sub millisecond access to data which was not found in the DRAM cache.

E. A system wherein external read operations of 4K can typically be serviced with a single access to back-end flash storage on a cache miss without loss of RAID protection for the data.

F. Whereas the limitations of size of existing DRAM caching solutions are well known, in that only a few DRAM DIMMs can be used, and as these existing solutions generally leverage “locally power backed” devices and the media to store the contents, they are far smaller than high capacity DRAM DIMMs available for computing servers. This system enables over 5× the number of memory modules (through more servers operating as part of a single caching layer) and over 4× increase in the density of the modules (through moving the power backup to a separate serviceable unit).

G. A system for constructing a large caching system through the use of Commercial Off The Shelf components which functions as a RAID array to facilitate both increased capacity and performance of a caching layer which is shared across a number of active-active controllers that all have symmetric access to any of the data or DRAM cache in the system.

H. A system for enhancing the reliability of a set of servers through the use of a Redundant Array of Independent Devices approach wherein the data stored across the set of servers may be stored in a different RAID arrangement from the meta-data describing the data. The servers running the processes operate where each serves as a master (primary server) for select tasks and a slaves (backup copy) for other tasks. When any server fails, the tasks can be picked up by the remaining members of the array—thereby preventing faults in the software in one server from taking the system down.

I. As the software on the servers communicate through APIs for all operations, the software versions on each of the servers may be different—thereby enabling in-service-upgrades of capabilities . . . whether the upgrade of software within a server or the replacement of one server by a newer server in the system.

J. A method for distributing the meta-data for a storage complex across a number of parallel controllers so that a number of all front-end controllers have symmetric access to any data stored across the system while having full access to

K. Whilst storage arrays designed for use with Flash memory minimize DRAM in the controllers and rely primarily on the back-end performance of underlying Flash media, this system can leverage a very large (100 DIMM+effective cache) to enable DRAM to deliver far higher throughput to data in the cache at far lower latencies than is possible with Flash media.

This described technology generally relates to a data management system configured to implement, among other things, web-scale computing services, data storage and data presentation. In particular, embodiments provide for a data management system in which data may be stored in a data storage array. Data stored within the data storage array may be accessed through one or a plurality of logic or computing elements employed as array access modules (AAMs). The AAMs may receive client data input/output (I/O or IO) requests, including requests to read data, write data, and/or compare and swap data (for example, a value is transmitted for comparison to a currently stored value, if the values match, the currently stored value is replaced with the provided value). The requests may include, among other things, the address for the data associated with the request. The AAMs may format the requests for presentation to the storage components of the data storage array using a plurality of computers employed as lookup modules (LMs), which may be configured to provide lookup services for the data storage array.

The data may be stored within the data storage array in cache storage or persistent storage. The cache storage may be implemented as a cache storage layer using one or more computing elements configured as cache modules (CMs) and the persistent storage implemented using one or more computing elements configured as a persistent storage module (PSM or “clip”). According to some embodiments, an LM and a CM may be configured as a shared or co-located module configured to perform both lookup and cache functions (a cache lookup module (CLM)). As such, use of the term LM and/or CM in this description, may refer to an LM, a CM, and/or a CLM. For instance, LM may refer to the lookup functionality of a CLM and/or CM may refer to the cache functionality of a CLM. In an embodiment, internal tables (for example, address tables, logical address tables, physical address tables, or the like) may be mirrored across LMs and/or CLMs and the CMs and/or CLMs may be RAID (random array of independent disks) protected to protect the data storage array and its tables from the failure of an individual LM, CM and/or CLM.

Each CLM may be configured according to a standard server board for software, but may function as both a cache and lookup engine as described according to some embodiments herein. Cache entries may be large in comparison to lookup table entries. As such, some embodiments may employ RAID parity across a number of CMs and/or CLMs. For example, 4+1 parity may allow a CM and/or CLM to be serviced without loss of data from the cache. Lookup table entries may be mirrored across LMs and/or CLMs. Lookup table data may be arranged so that each LM, CM and/or CLM has its mirror data approximately evenly distributed amongst the other LMs, CMs and/or CLMs in the system so that in the event of a LM, CM and/or CLM CLM fault all remaining LMs, CMs and/or CLMs may only experience a moderate increase in load (for example, as opposed to a doubling of the load).

According to some embodiments, internal system meta-data in a storage array system controller (“array controller” or “array system controller”) may be stored in a 1+1 (mirrored) configuration with a “master” and a “slave” CLM for each component of system meta-data. In one embodiment, at least a portion of the system meta-data initially comprises the Logical to Physical Tables (LPT). For instance, the LPT data may be distributed so that all or substantially all CLMs encounter equal loading for LPT events, including both master and slave CLMs.

According to some embodiments, an LPT table may be used to synchronize access, for example, when writes commit and data is committed for writing to persistent storage (flash). For instance, each LPT may be associated with a single master (CLM and/or PSM) and a single slave (CLM and/or PSM). In an embodiment, commands for synchronizing updates between the master (CLM and/or PSM) and slave (CLM and/or PSM) may be done via mailbox/doorbell mechanism using the PCIe switches.

According to some embodiments, potential “hot spots” may be avoided by distributing the “master/slave.” A non-limiting example provides for taking a portion of the logical address space and using it to define the mapping for both master and slave. For instance, by using six (6) low-order LBA address bits to reference a mapping table. Using six (6) bits (64 entries) to divide the map tables across the 6 iCLMs may provide 10⅔ entries, on average, at each division. As such, four (4) CLMs may have eleven (11) entries and two (2) may have 10, resulting in about a 10% difference between the CLMs. As each LPT is mirrored, a yield of two (2) CLMs with twenty-two (22) “entries” from the set and four (4) with twenty-one (21) “entries” may be produced. As such, an about 5% difference between the total effective load for the CLMs may be achieved.

According to some embodiments, the CLMs may be configured for “flash RAID.” A non-restrictive example provides for for modular “parity” (e.g., single, double, triple, etc.). In another non-restrictive example, single parity may be XOR parity. Higher orders may be configured similar to FEC in wireless communication. In a further non-restrictive example, complex parity may initially be bypassed such that single-parity may be used to get the system operational.

In an embodiment, the mapping of a logical address to a LM, CM and/or CLM, which has a corresponding lookup table, may be fixed and known by a data management system central controller, for example, to reduce the latency for servicing requests. In an embodiment, the LMs, CMs and/or CLMs may be hot-serviced, for example, providing for replacement of one or more entire-cards and/or memory capacity increases over time. In addition, software on the CLMs may be configured to facilitate upgrading in place.

When servicing data access requests, the AAMs may obtain the location of cache storage used for the access from the LMs, which may operate as the master location for addresses being accessed in the data access request. The data access request may then be serviced via the CM caching layer. Accordingly, an AAM may receive the location of data requested in a service request via a LM and may service the request using via a CM. If the data is not located in the CM, the data storage array may read the data from the PSM into the CM before transmitting the data along the read path to the requesting client.

In an embodiment, the AAMs, LMs, CMs, CLMs, and/or PSMs (the “storage array modules” or “storage array cards”) may be implemented as separate logic or computing elements including separate boards (for example, a printed circuit board (PCB), card, blade or other similar form), separate assemblies (for example, a server blade), or any combination thereof. In other embodiments, one or more of the storage array modules may be implemented on a single board, server, assembly, or the like. Each storage array module may execute a separate operating system (OS) image. For instance, each AAM, CLM and PSM may be configured on a separate board, with each board operating under a separate OS image.

In an embodiment, each storage array module may include separate boards located within a server computing device. In another embodiment, the storage array modules may include separate boards arranged within multiple server computing devices. The server computing devices may include at least one processor configured to execute an operating system and software, such as a data management system control software. The data management system control software may be configured to execute, manage or otherwise control various functions of the data management system and/or components thereof (“data management system functions”), such as the LMs, CLMs, AAMs, and/or PSMs, described according to some embodiments. According to some embodiments, the data management system functions may be executed through software (for example, the data management system control software, firmware, or a combination thereof), hardware, or any combination thereof.

The storage array modules may be connected using various communication elements and/or protocols, including, without limitation, Internet Small Computer System Interface (iSCSI) over an Ethernet Fabric, Internet Small Computer System Interface (iSCSI) over an Infiniband fabric, Peripheral Component Interconnect (PCI), PCI-Express (PCIe), Non-Volatile Memory Express (NVMe) over a PCI-Express fabric, Non-Volatile Memory Express (NVMe) over an Ethernet fabric, and Non-Volatile Memory Express (NVMe) over an Infiniband fabric.

The data storage array may use various methods for protecting data. According to some embodiments, the data management system may include data protection systems configured to enable storage components (for instance, data storage cards such as CMs) to be serviced hot, for example, for upgrades or repairs. In an embodiment, the data management system may include one or more power hold units (PHUs) configured to hold power for a period of time after an external power failure. In an embodiment, the PHUs may be configured to hold power for the CLMs and/or PSMs. In this manner, operation of the data management system may be powered by internal power supplies provided through the PHUs such that data operations and data integrity may be maintained during the loss of external power. In an embodiment, the amount of “dirty” or modified data maintained in the CSMs may be less than the amount which can be stored in the PSMs, for example, in the case of a power failure or other system failure.

In an embodiment, the cache storage layer may be configured to use various forms of RAID (random array of independent disks) protection. Non-limiting examples of RAID include mirroring, single parity, dual parity (P/Q), and erasure codes. For example, when mirroring across multiple CMs and/or PSMs, the number of mirrors may be configured to be one more than the number of faults which the system can tolerate simultaneously. For instance, data may be maintained with two (2) mirrors, with either one of the mirrors covering in the event of a fault. If three (3) mirrors (“copies”) are used, then any two (2) may fault without data loss. According to some embodiments, the CMs and the PSMs may be configured to use different forms of RAID.

In an embodiment, RAID data encoding may be used wherein the data encoding may be fairly uniform and any minimal set of read responses can generate the transmitted data reliably with roughly uniform computational load. For example, the power load may be more uniform for data accesses and operators may have the ability to determine a desired level of storage redundancy (e.g., single, dual, triple, etc.).

The data storage array may be configured to use various types of parity-based RAID configurations. For example, N modules holding data may be protected by a single module which maintains a parity of the data being stored in the data modules. In another example, a second module may be employed for error recovery and may be configured to store data according to a “Q” encoding which enables recovery from the loss of any two other modules. In a further example, erasure codes may be used which include a class of algorithms in which the number of error correction modules M may be increased to handle a larger number of failures. In an embodiment, the erasure code algorithms may be configured such that the number of error correction modules M is greater than two and less than the number of modules holding data N.

According to some embodiments, data may be moved within memory classes. For example, data may be “re-encoded” in which data to be “re-encoded” may be migrated from a “cache-side” to a “flash-side.” Data which is “pending flash write,” may be placed in a separate place in memory pending the actual commitment to flash.

According to some embodiments, the data storage array may be configured to use meta-data for various aspects of internal system operation. This meta-data may be protected using various error correction mechanisms different than or in addition to any data protection methods used for the data stored in the data storage array itself. For instance, meta-data may be mirrored while the data is protected by 4+1 parity RAID.

According to some embodiments, the storage array system described herein may operate on units of data which are full pages in the underlying media. For example, a flash device may move up to about 16 kilobyte pages (for example, the internal size where the device natively performs any read or write), such that the system may access data at this granularity or a multiple thereof. In an embodiment, system meta-data may be stored inside the storage space presented by the “user” addressable space in the storage media, for instance, so as not to require generation of a low-level controller. In an embodiment, the cache may be employed to enable accesses (for example, reads, writes, compare and swaps, or the like) to any access size smaller than a full page. Reads may pull data from the permanent storage into cache before the data can be provided to the client, unless it has never been written before, at which point some default value (for example, zero) can be returned. Writes may be taken into cache for fractions of the data storage units kept in permanent storage. If data is to be de-staged to permanent storage before the user has written (re-written) all of the sectors in the data block, the system may read the prior contents from the permanent storage and integrate it so that the data can be posted back to permanent storage.

According to some embodiments, the AAMs may aggregate IO requests into a particular logical byte addressing (LBA) unit granularity (for example, 256 LBA (about 128 kilobyte)) and/or may format IO requests into one or more particular data size units (for example, 16 kilobytes). In particular, certain embodiments provide for a data storage array in which there is either no additional storage layer or in which certain “logical volumes/drives” do not have their data stored in a further storage layer. For the “logical volumes/drives” embodiments, there may not be a further storage layer. Applications that require data that must be serviced at the speed of the cache and/or applications that do not require data to be stored in a further, and generally slower, storage layer in the event of a system shutdown may, for example, use a “logical volumes/drives” storage configuration.

As described above, a data storage array configured according to some embodiments may include a “persistent” storage layer, implemented through one or more PSMs, in addition to cache storage. In such embodiments, data writes may be posted into the cache storage (for instance, a CM) and, if necessary, de-staged to persistent memory (for instance, a PSM). In another example, data may be read directly from the cache storage or, if the data is not in the cache storage, the data storage array may read the data from persistent memory into the cache before transmitting the data along the read path to the requesting client. “Persistent storage element,” “persistent storage components,” PSM, or similar variations thereof may refer to any data source or destination element, device or component, including electronic, magnetic, and optical data storage and processing elements, devices and components capable of persistent data storage.

The persistent storage layer may use various forms of RAID protection across a plurality of PSMs. Data stored in the PSMs may be stored with a different RAID protection than employed for data that is stored in the CMs. In an embodiment, the PSMs may store data in one or more RAID disk strings. In another embodiment, the data may be protected in an orthogonal manner when it is in the cache (for example, stored in a CM) compared to when it is stored in permanent storage (for example, in the PSM). According to some embodiments, data may be stored in a CM RAID protected in an orthogonal manner to data stored in the PSMs. In this manner, cost and performance tradeoffs may be realized at each respective storage tier while having similar bandwidth on links between the CMs and PSMs, for instance, during periods where components in either or both layers are in a fault-state.

According to some embodiments, the data management system may be configured to implement a method for storing (writing) and retrieving (reading) data including receiving a request to access data from an AAM configured to obtain the location of the data from a LM. During a read operation, the LM may receive a data request from the AAM and operate to locate the data in a protected cache formed from a set of CMs. In an embodiment, the protected cache may be a RAID-protected cache. In another embodiment, the protected cache may be a Dynamic Random Access Memory (DRAM) cache. If the LM locates the data in the protected cache, the AAM may read the data from the CM or CMs storing the data. If the LM does not find the data in the cache, the LM may operate to load the data from a persistent storage implemented through a set of PSMs into a CM or CMs before servicing the transaction. The AAM may then read the data from the CM or CMs. For a write transaction, the AAM may post a write into the protected cache in a CM.

According to some embodiments, data in the CMs may be stored orthogonal to the PSMs. As such, multiple CMs may be used for every request and a single PSM may be used for smaller read accesses.

In an embodiment, all or some of the data transfers between the data management system components may be performed in the form of “posted” writes. For example, using a “mailbox” and a “doorbell” to deliver incoming messages and flagging messages that they have arrived, for example, as a read is a composite operation which may also include a response. The addressing requirements intrinsic to a read operation are not required for posted writes. In this manner, data transfer is simpler and more efficient when reads are not employed across the data management system communication complex (for example, PCIe complex). In an embodiment, a read may be performed by sending a message that requests a response that may be fulfilled later.

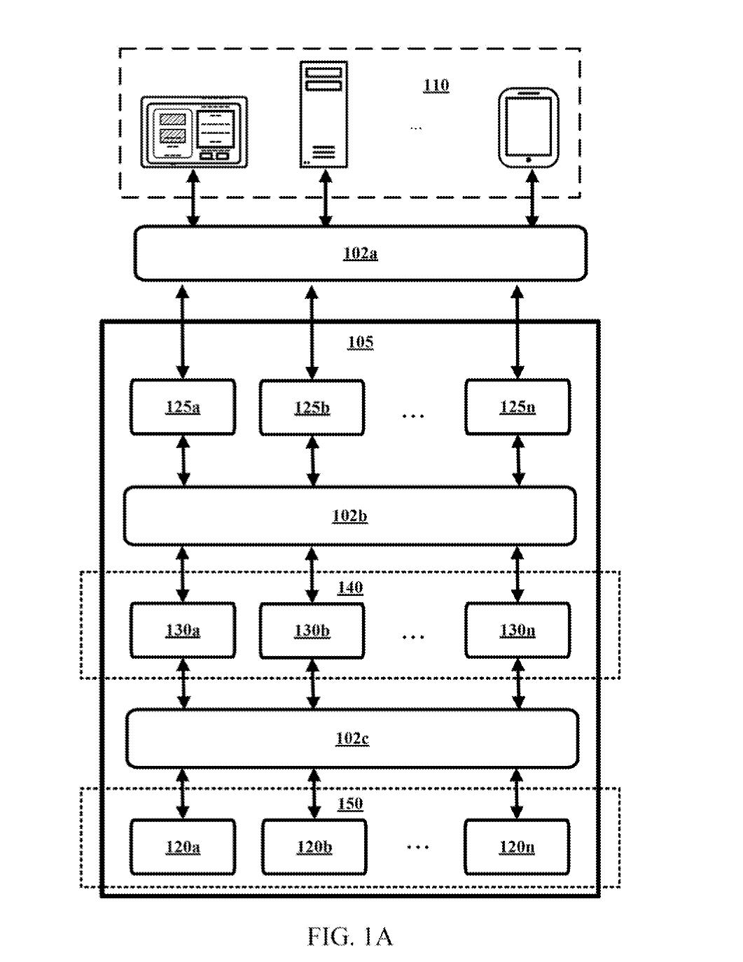

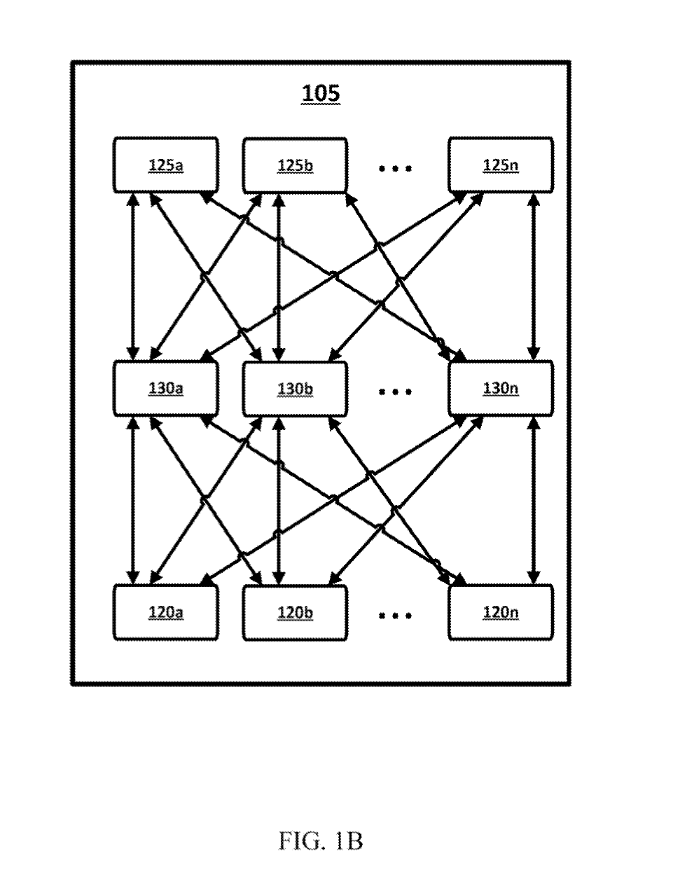

FIGS. 1A and 1B depict an illustrative data management system according to some embodiments. As shown in FIG. 1A, the data management system may include one or more clients 110 which may be in operative communication with a data storage array 105. Clients 110 may include various computing devices, networks and other data consumers. For example, clients 110, may include, without limitation, servers, personal computers (PCs), laptops, mobile computing devices (for example, tablet computing devices, smart phones, or the like), storage area networks (SANs), and other data storage arrays 105. The clients 110 may be in operable communication with the data storage array 105 using various connection protocols, topologies and communications equipment. For instance, as shown in FIG. 1A, the clients 110 may be connected to the data storage array 105 by a switch fabric 102a. In an embodiment, the switch fabric 102a may include one or more physical switches arranged in a network and/or may be directly connected to one or more of the connections of the storage array 105.

It is worthy to note that “a” and “b” and “c” and similar designators as used herein are intended to be variables representing any positive integer. Thus, for example, if an implementation sets a value for n=6 CLMs 130, then a complete set of CLMs 130 may include CLMs 130-1, 130-2, 130-3, 130-4, 130-5, and 130-6. The embodiments are not limited in this context.

In one embodiment, clients 110 may include any system and/or device having the functionality to issue a data request to the data storage array 105, including a write request, a read request, a compare and swap request, or the like. In an embodiment, the clients 110 may be configured to communicate with the data storage array 105 using one or more of the following communication protocols and/or topologies: Internet Small Computer System Interface (iSCSI) over an Ethernet Fabric, Internet Small Computer System Interface (iSCSI) over an Infiniband fabric, Peripheral Component Interconnect (PCI), PCI-Express (PCIe), Non-Volatile Memory Express (NVMe) over a PCI-Express fabric, Non-Volatile Memory Express (NVMe) over an Ethernet fabric, and Non-Volatile Memory Express (NVMe) over an Infiniband fabric. Those skilled in the art will appreciate that the invention is not limited to the aforementioned protocols and/or fabrics.

The data storage array 105 may include one or more AAMs 125a-125n. The AAMs 125a-125n may be configured to interface with various clients 110 using one or more of the aforementioned protocols and/or topologies. The AAMs 125a-125n may be operatively coupled to one or more CLMs 130a-130n arranged in a cache storage layer 140. The CLMs 130a-130n may include separate CMs, LMs, CLMs, and any combination thereof.

The CLMs 130a-130n may be configured to, among other things, store data and/or meta-data in the cache storage layer 140 and to provide data lookup services, such as meta-data lookup services. Meta-data may include, without limitation, block meta-data, file meta-data, structure meta-data, and/or object meta-data. The CLMs 130a-130n may include various memory and data storage elements, including, without limitation, dual in-line memory modules (DIMMs), DIMMs containing Dynamic Random Access Memory (DRAM) and/or other memory types, flash-based memory elements, hard disk drives (HDD) and a processor core operative to handle IO requests and data storage processes. The CLMs 130a-130n may be configured as a board (for example, a printed circuit board (PCB), card, blade or other similar form), as a separate assembly (for example, a server blade), or any combination thereof. According to some embodiments, the one or more memory elements on the CLMs 130a-130n may operate to provide cache storage within the data storage array 105. In an embodiment, cache entries within the cache storage layer 140 may be spread across multiple CLMs 130a-130n. In such an embodiment, the table entries may be split across multiple CLMs 130a-130n, such as across six (6) CLMs such that ⅙^{th} of the cache entries are not in a particular CLM as the cache entries are in the other five (5) CLMS. In another embodiment, tables (for instance, address tables, LPT tables, or the like) may be maintained in “master” and “slave” CLMs 130a-130n.

As shown in FIG. 1B, each AAM 125a-125n may be operatively coupled to some or all CLMs 130a-130n and each CLM may be operatively coupled to some or all PSMs 120a-120n. Accordingly, the CLMs 130a-130n may act as in interface between the AAMs 125a-125n and data stored within the persistent storage layer 150. According to some embodiments, the data storage array 105 may be configured such that any data stored in the persistent storage layer 150 within the storage PSMs 120a-120n may be accessed through the cache storage layer 140.

In an embodiment, data writes may be posted into the cache storage layer 140 and de-staged to the persistent storage layer 150 based on one or more factors, including, without limitation, the age of the data, the frequency of use of the data, the client computing devices associated with the data, the type of data (for example, file type, typical use of the data, or the like), the size of the data, and/or any combination thereof. In another embodiment, read requests for data stored in the persistent storage layer 150 and not in the cache storage layer 140 may be obtained from the persistent storage in the PSMs 120a-120n and written to the CLMs 130a-130n before the data is provided to the clients 110. As such, some embodiments provide that data may not be directly written to or read from the persistent storage layer 150 without the data being stored, at least temporarily, in the cache storage layer 140. The data storage array components, such as the AAMs 125a-125n, may interact with the CLMs 130a-130n which handle interactions with the PSMs 120a-120n. Using the cache storage in this manner, among other things, provides lower latency times for accesses to data in the cache storage layer 140 while providing a unified control as higher level components, such as the AAMs 125a-125n, inside the system data storage array 105 and clients 110 outside the data storage array are able to operate without being aware of the cache storage and/or its specific operations.

The AAMs 125a-125n may be configured to communicate with the client computing devices 110 through one or more data ports. For example, the AAMs 125a-125n may be operatively coupled to one or more Ethernet switches (not shown), such as a top-of-rack (TOR) switch. The AAMs 125a-125n may operate to receive IO requests from the client computing devices 110 and to handle low-level data operations with other hardware components of the data storage array 105 to complete the IO transaction. For example, the AAMs 125a-125n may format data received from a CLM 130a-130n in response to a read request for presentation to a client computing device 110. In another example, the AAMs 125a-125n may operate to aggregate client IO requests into unit operations of a certain size, such as 256 logical block address (LBA) (about 128 kilobyte) unit operations. As described in more detail below, the AAMs 125a-125n may include a processor based component configured to manage data presentation to the client computing devices 110 and an integrated circuit based component configured to interface with other components of the data storage array 105, such as the PSMs 120a-120n.

According to some embodiments, each data storage array 105 module having a processor (a “processor module”), such as an AAM 125a-125n, CLM 130a-130n and/or PSM 120a-120n may include at least one PCIe communication port for communication between each pair of processor modules. In an embodiment, these processor module PCIe communication ports may be configured in a non-transparent (NT) mode as known to those having ordinary skill in the art. For instance, an NT port may provide an NT communication bridge (NTB) between two processor modules with both sides of the bridge having their own independent address domains. A processor module on one side of the bridge may not have access to or visibility of the memory or IO space of the processor module on the other side of the bridge. To implement communication across an NTB, each endpoint (processor module) may have openings exposed to portions of their local system (for example, registers, memory locations, or the like). In an embodiment, address mappings may be configured such that each sending processor may write into a dedicated memory space in each receiving processor.

Various forms of data protection may be used within the data storage array 105. For example, meta-data stored within a CLM 130a-130n may be mirrored internally. In an embodiment, persistent storage may use N+M RAID protection which may enable the data storage array 105, among other things, to tolerate multiple failures of persistent storage components (for instance, PSMs and/or components thereof). For example, the N+M protection may be configured as 9+2 RAID protection. In an embodiment, cache storage may use N+1 RAID protection for reasons including simplicity of configuration, speed, and cost. An N+1 RAID configuration may allow the data storage array 105 to tolerate the loss of one (1) CLM 130a-130n.

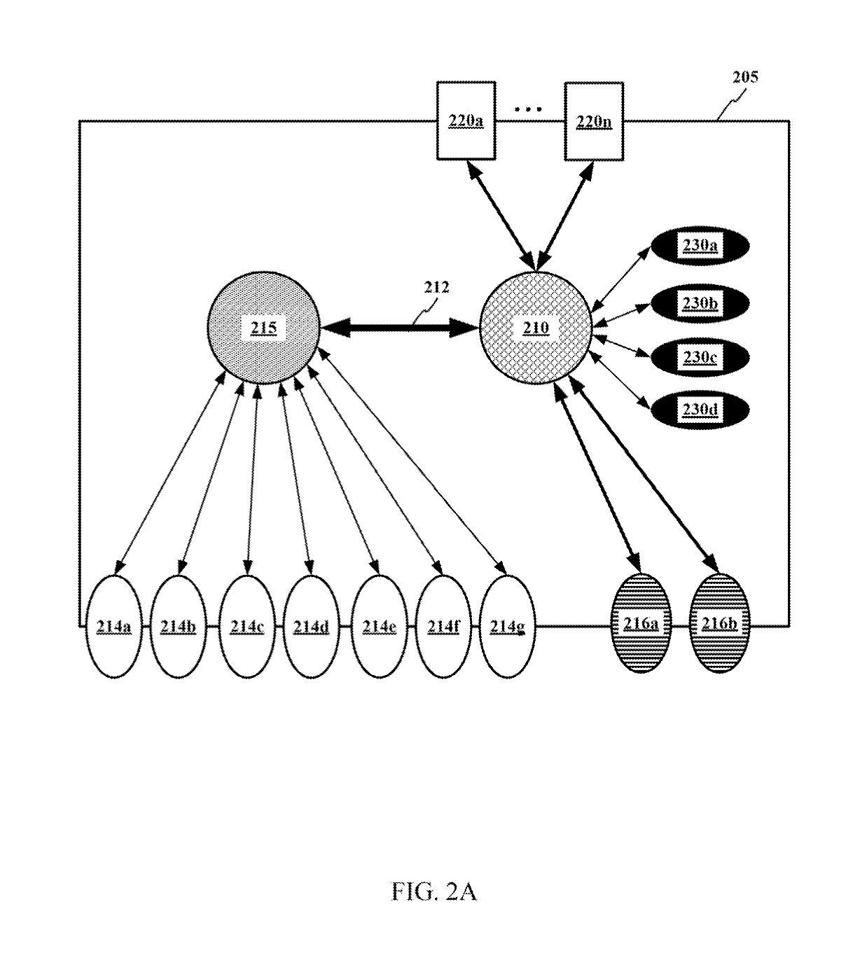

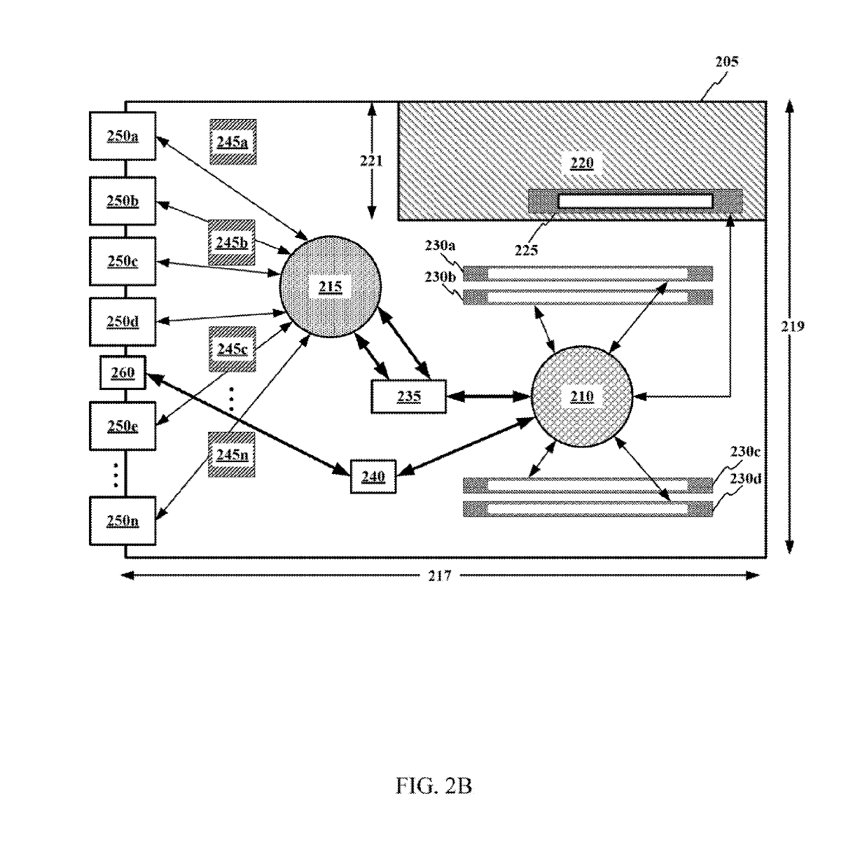

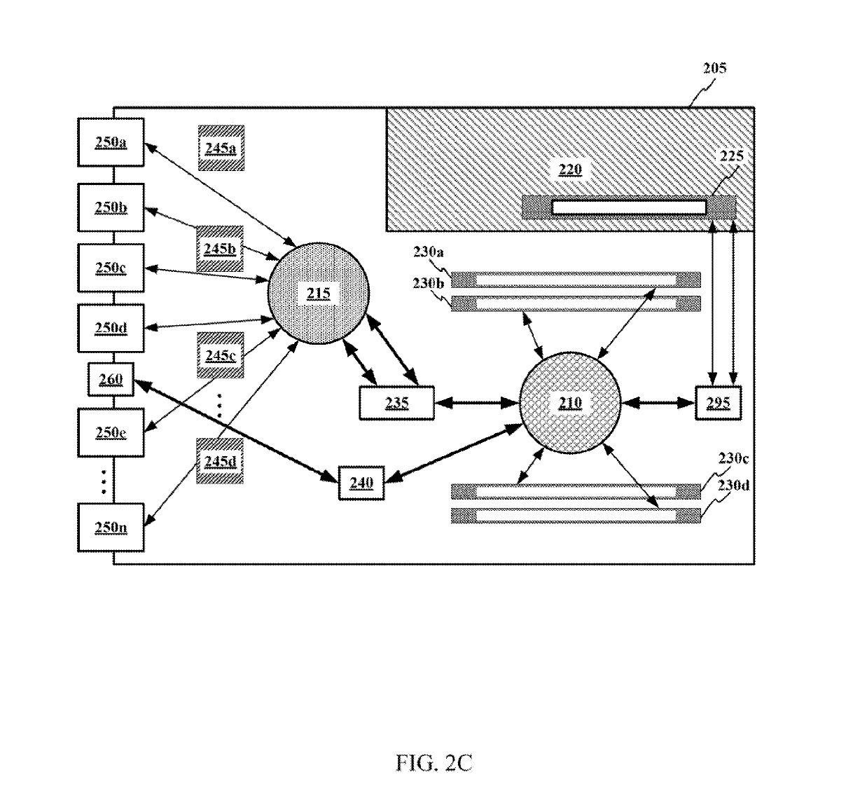

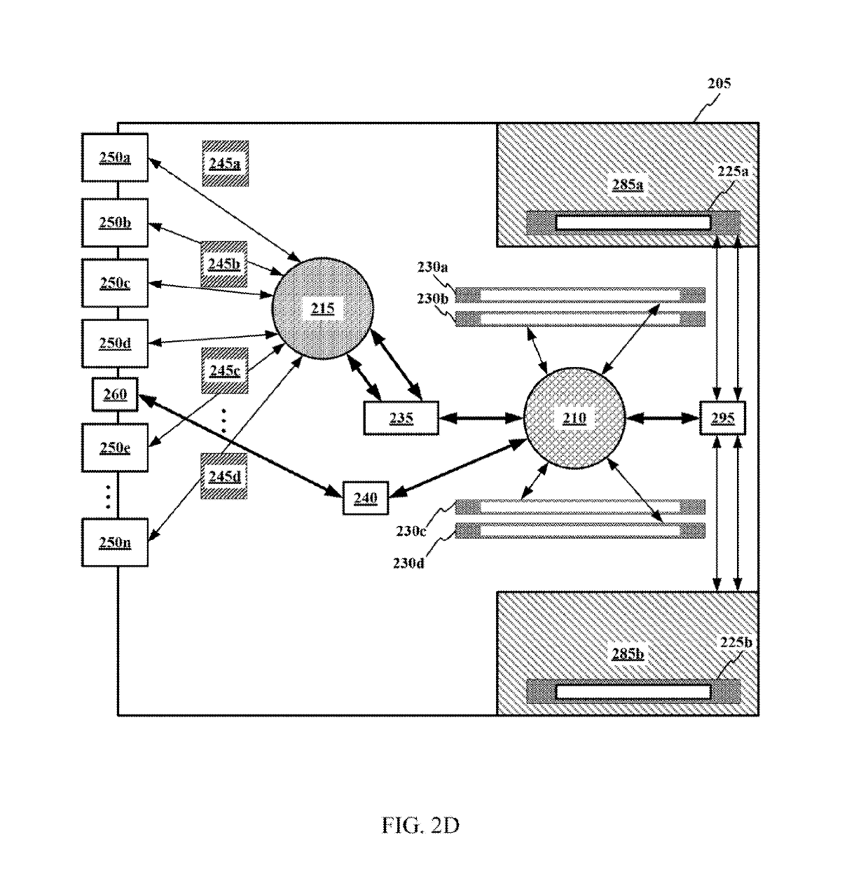

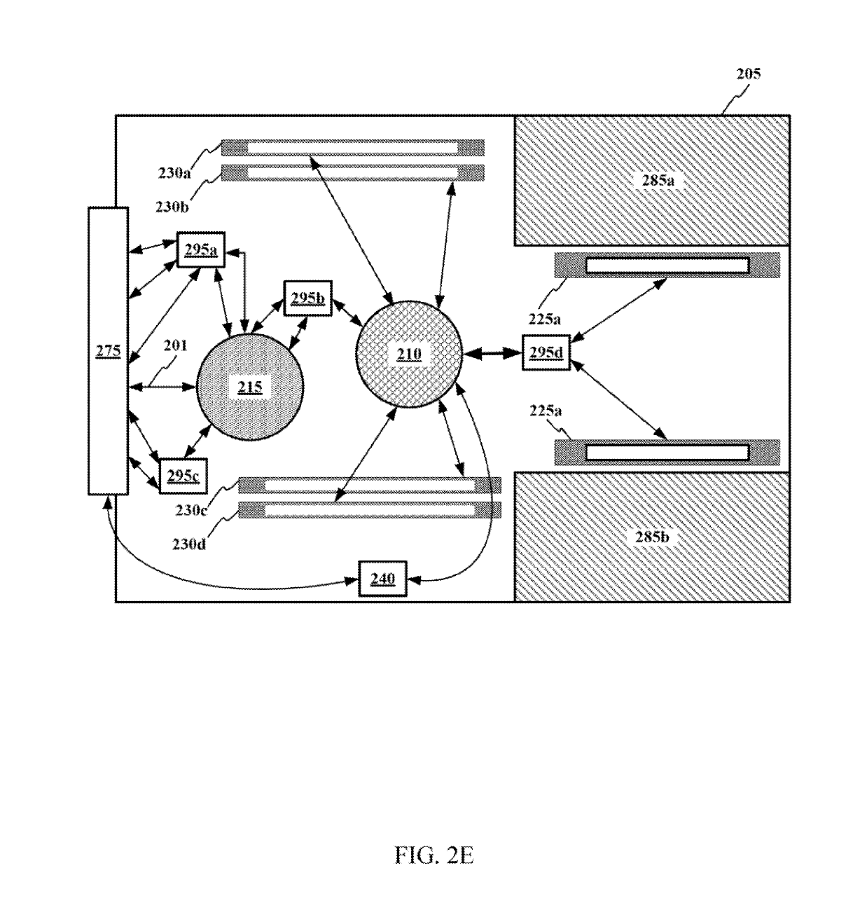

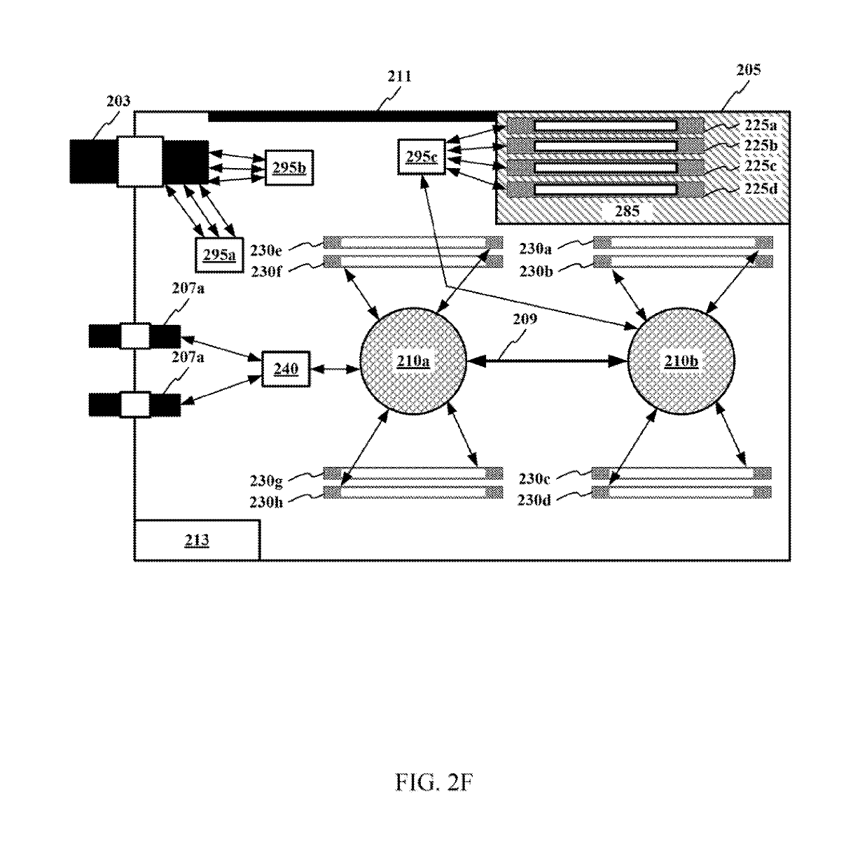

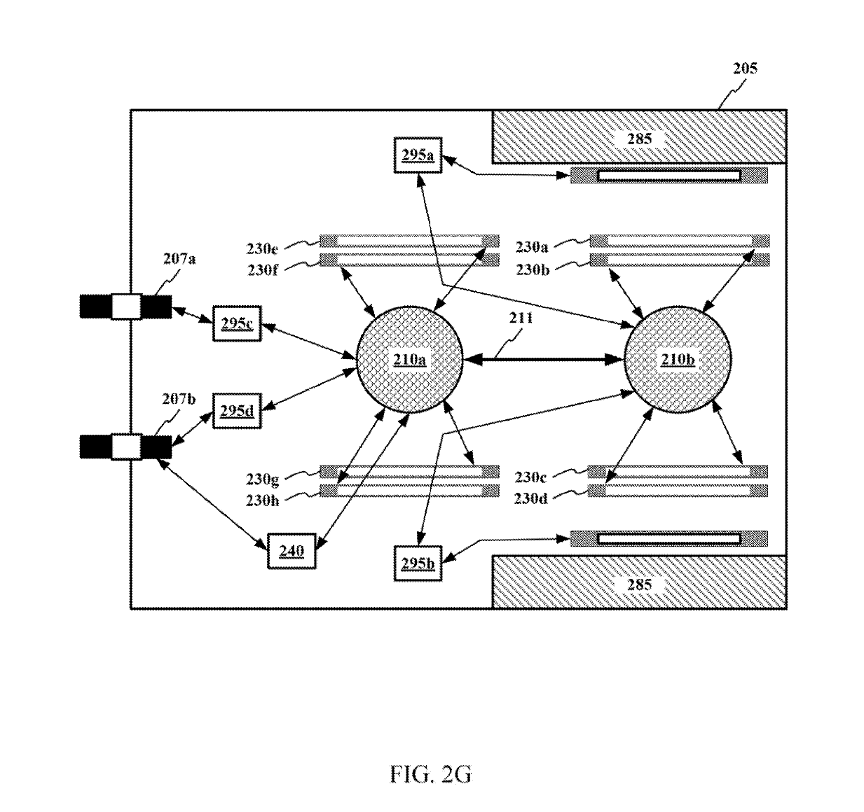

FIG. 2A depicts an illustrative AAM according to a first embodiment. The AAM 205 may be configured as a board (for example, a printed circuit board (PCB), card, blade or other similar form) that may be integrated into a data storage array. As shown in FIG. 2A, the AAM may include communication ports 220a-220n configured to provide communication between the AAM and various external devices and network layers, such as external computing devices or network devices (for example, network switches operatively coupled to external computing devices). The communication ports 220a-220n may include various communication ports known to those having ordinary skill in the art, such as host bus adapter (HBA) ports or network interface card (NIC) ports. Illustrative HBA ports include HBA ports manufactured by the QLogic Corporation, the Emulex Corporation and Brocade Communications Systems, Inc. Non-limiting examples of communication ports 220a-220n may include Ethernet, fiber channel, fiber channel over Ethernet (FCoE), hypertext transfer protocol (HTTP), HTTP over Ethernet, peripheral component interconnect express (PCIe) (including non-transparent PCIe ports), InfiniBand, integrated drive electronics (IDE), serial AT attachment (SATA), express SATA (eSATA), small computer system interface (SCSI), and Internet SCSI (iSCSI).

In an embodiment, the number of communication ports 220a-220n may be determined based on required external bandwidth. According to some embodiments, PCIe may be used for data path connections and Ethernet may be used for control path instructions within the data storage array. In a non-limiting example, Ethernet may be used for boot, diagnostics, statistics collection, updates, and/or other control functions. Ethernet devices may auto-negotiate link speed across generations and PCIe connections may auto-negotiate link speed and device lane width. Although PCIe and Ethernet are described as providing data communication herein, they are for illustrative purposes only, as any data communication standard and/or devices now in existence or developed in the future capable of operating according to embodiments is contemplated herein.

Ethernet devices, such as Ethernet switches, buses, and other communication elements, may be isolated such that internal traffic (for example, internal traffic for the internal data storage array, AAMs, LMs, CMs, CLMs, PSMs, or the like) does not extend out of a particular system. Accordingly, internal Internet protocol (IP) addresses may not be visible outside of each respective component unless specifically configured to be visible. In an embodiment, the communication ports 220a-220n may be configured to segment communication traffic.

The AAM 205 may include at least one processor 210 configured, among other things, to facilitate communication of IO requests received from the communication ports 220a, 220n and/or handle a storage area network (SAN) presentation layer. The processor 210 may include various types of processors, such as a custom configured processor or processors manufactured by the Intel® Corporation, AMD, or the like. In an embodiment, the processor 210 may be configured as an Intel® E5-2600 series server processor, which is sometimes referred to as IA-64 for “Intel Architecture 64-bit.”

The processor 210 may be operatively coupled to one or more data storage array control plane elements 216a, 216b, for example, through Ethernet for internal system communication. The processor 210 may have access to memory elements 230a-230d for various memory requirements during operation of the data storage array. In an embodiment, the memory elements 230a-230d may comprise dynamic random-access memory (DRAM) memory elements. According to some embodiments, the processor 210 may include DRAM configured to include 64 bytes of data and 8 bytes of error checking code (ECC) or single error correct, double error detect (SECDED) error checking.

An integrated circuit 215 based core may be arranged within the AAM 205 to facilitate communication with the processor 210 and the internal storage systems, such as the CLMs (for example, 130a, 130n in FIG. 1). According to some embodiments, the integrated circuit 215 may include a field-programmable gate array (FPGA) configured to operate according to embodiments described herein. The integrated circuit 215 may be operatively coupled to the processor 210 through various communication buses 212, such as peripheral component interconnect express (PCIe) or non-volatile memory express (NVM express or NVMe). In an embodiment, the communication bus 212 may comprise an eight (8) or sixteen lane (16) wide PCIe connection capable of supporting, for example, data transmission speeds of at least 100 gigabytes/second.

The integrated circuit 215 may be configured to receive data from the processor 210, such as data associated with IO requests, including data and/or meta-data read and write requests. In an embodiment, the integrated circuit 215 may operate to format the data from the processor 210. Non-limiting examples of data formatting functions carried out by the integrated circuit 215 include aligning data received from the processor 210 for presentation to the storage components, padding (for example, T10 data integrity feature (T10-DIF) functions), and/or error checking features such as generating and/or checking cyclic redundancy checks (CRCs). The integrated circuit 215 may be implemented using various programmable systems known to those having ordinary skill in the art, such as the Virtex® family of FPGAs provided by Xilinx®, Inc.

One or more transceivers 214a-214g may be operatively coupled to the integrated circuit 215 to provide a link between the AAM 205 and the storage components of the data storage array, such as the CLMs. In an embodiment, the AAM 205 may be in communication with each storage component, for instance, each CLM (for example, 130a, 130n in FIG. 1) through the one or more transceivers 214a-214g. The transceivers 214a-214g may be arranged in groups, such as eight (8) groups of about one (1) to about four (4) links to each storage component.

FIG. 2B depicts an illustrative AAM according to a second embodiment. As shown in FIG. 2B, the AAM 205 may include a processor in operable communication with memory elements 230a-230d, for example, DRAM memory elements. According to embodiments, each of memory elements 230a-230d may be configured as a data channel, for example, memory elements 230a-230d may be configured as data channels A-D, respectively. The processor 210 may be operatively coupled with a data communication bus connector 225, such as through a sixteen (16) lane PCIe bus, arranged within a communication port 220 (for example, an HBA slot). The processor 210 may also be operatively coupled through an Ethernet communication element 240 to an Ethernet port 260 configured to provide communication to external devices, network layers, or the like.

The AAM 205 may include an integrated circuit 215 core operatively coupled to the processor through a communication switch 235, such as a PCIe communication switch or card (for example, a thirty-two (32) lane PCIe communication switch) via dual eight (8) lane PCIe communication buses. The processor 210 may be operatively coupled to the communication switch 235 through a communication bus, such as a sixteen (16) lane PCIe communication. The integrated circuit 215 may also be operatively coupled to external elements, such as data storage elements, through one or more data communication paths 250a-250n.

The dimensions of the AAM 205 and components thereof may be configured according to system requirements and/or constraints, such as space, heat, cost, and/or energy constraints. For example, the types of cards, such as PCIe cards, and processor 210 used may have an effect on the profile of the AAM 205. In another example, some embodiments provide that the AAM 205 may include one or more fans 245a-245n and/or types of fans, such as dual in-line counter-rotating (DICR) fans, to cool the AAM. The number and types of fans may have an effect on the profile of the AAM 205.

In an embodiment, the AAM 205 may have a length 217 of about 350 millimeters, about 375 millimeters, about 400 millimeters, about 425 millimeters, about 450 millimeters, about 500 millimeters, and ranges between any two of these values (including endpoints). In an embodiment, the AAM 205 may have a height 219 of about 250 millimeters, about 275 millimeters, about 300 millimeters, about 310 millimeters, about 325 millimeters, about 350 millimeters, about 400 millimeters, and ranges between any two of these values (including endpoints). In an embodiment, the communication port 220 may have a height 221 of about 100 millimeters, about 125 millimeters, about 150 millimeters, and ranges between any two of these values (including endpoints).

FIG. 2C depicts an illustrative AAM according to a third embodiment. As shown in FIG. 2C, the AAM 205 may use a communication switch 295 to communicate with the data communication bus connector 225. In an embodiment, the communication switch 295 may comprise a thirty-two (32) lane PCIe switch with a sixteen (16) lane communication bus between the processor 210 and the communication switch 295. The communication switch 285 may be operatively coupled to the data communication bus connector 225 through one or more communication buses, such as dual eight (8) lane communication buses.

FIG. 2D depicts an illustrative AAM according to a fourth embodiment. As shown in FIG. 2D, the AAM 205 may include a plurality of risers 285a, 285b for various communication cards. In an embodiment, the risers 285a, 285b may include at least one riser for a PCIe slot. A non-limiting example of a riser 285a, 285b includes a riser for a dual low-profile, short-length PCIe slot. The AAM 205 may also include a plurality of data communication bus connectors 225a, 225b. In an embodiment, the data communication bus connectors 225a, 225b may be configured to use the PCIe second generation (Gen 2) standard.

FIG. 2E depicts an illustrative AAM according to a fifth embodiment. As shown in FIG. 2E, the AAM 205 may comprise a set of PCIe switches 295a-295d that provide communication to the storage components, such as to one or more CLMs. In an embodiment, the set of PCIe switches 295a-295d may include PCIe third generation (Gen 3) switches configured, for instance, with the PCIe switch 295a as a forty-eight (48) lane PCIe switch, the PCIe switch 295b as a thirty-two (32) lane PCIe switch, and the PCIe switch 295c as a twenty-four (24) lane PCIe switch. As shown in FIG. 2D, the PCIe switch 295b may be configured to facilitate communication between the processor 210 and the integrated circuit 215.

According to some embodiments, PCIe switches 295a and 295c may communicate with storage components through a connector 275 and may be configured to facilitate, among other things, multiplexer/de-multiplexer (mux/demux) functions. In an embodiment, the processor 210 may be configured to communicate with the Ethernet communication element 240 through an eight (8) lane PCIe Gen 3 standard bus. For embodiments in which the data storage array includes a plurality of AAMs 205, the integrated circuit 215 of each AAM may be operatively coupled to the other AAMs, at least in part, through one or more dedicated control/signaling channels 201.

FIG. 2F depicts an illustrative AAM according to a sixth embodiment. As shown in FIG. 2F, the AAM 205 may include a plurality of processors 210a, 210b. A processor-to-processor communication channel 209 may interconnect the processors 210a, 210b. In an embodiment in which the processors 210a, 210b are Intel® processors, such as IA-64 architecture processors manufactured by the Intel® Corporation of Santa Clara, Calif., United States, the processor-to-processor communication channel 209 may comprise a QuickPath Interconnect (QPI) communication channel.

Each of the processors 210a, 210b may be in operative connection with a set of memory elements 230a-230h. The memory elements 230a-230h may be configured as memory channels for the processors 210a, 210b. For example, memory elements 230a-230d may form memory channels A-D for the processor 210b, while memory elements 230e-230h may form memory channels E-H for the processor 210a, with one DIMM for each channel.

According to some embodiments, the AAM 205 may be configured as a software-controlled AAM. For example, the processor 210b may execute software configured to control various operational functions of the AAM 205 according to embodiments described herein, including through the transfer of information and/or commands communicated to the processor 210a.

As shown in FIG. 2F, some embodiments provide that the AAM 205 may include power circuitry 213 directly on the AAM board. A plurality of communication connections 203, 207a, 207b may be provided to connect the AAM to various data storage array components, external devices, and/or network layers. For example, communication connections 207a and 207b may provide Ethernet connections and communication connection 203 may provide PCIe communications, for instance, to each CLM.

FIG. 2G depicts an illustrative AAM according to a seventh embodiment. The AAM 205 of FIG. 2G may be configured as a software-controlled AAM that operates without an integrated circuit, such as integrated circuit 215 in FIGS. 2A-2F. The processor 210a may be operatively coupled to one or more communication switches 295c, 295d that facilitate communication with storage components (for instance, LMs, CMs, and/or CLMs) through the communication connectors 207a, 207b. In an embodiment, the communication switches 295c, 295d may include thirty-two (32) lane PCIe switches connected to the processor 210a through sixteen (16) lane PCIe buses (for example, using the PCIe Gen 3 standard).

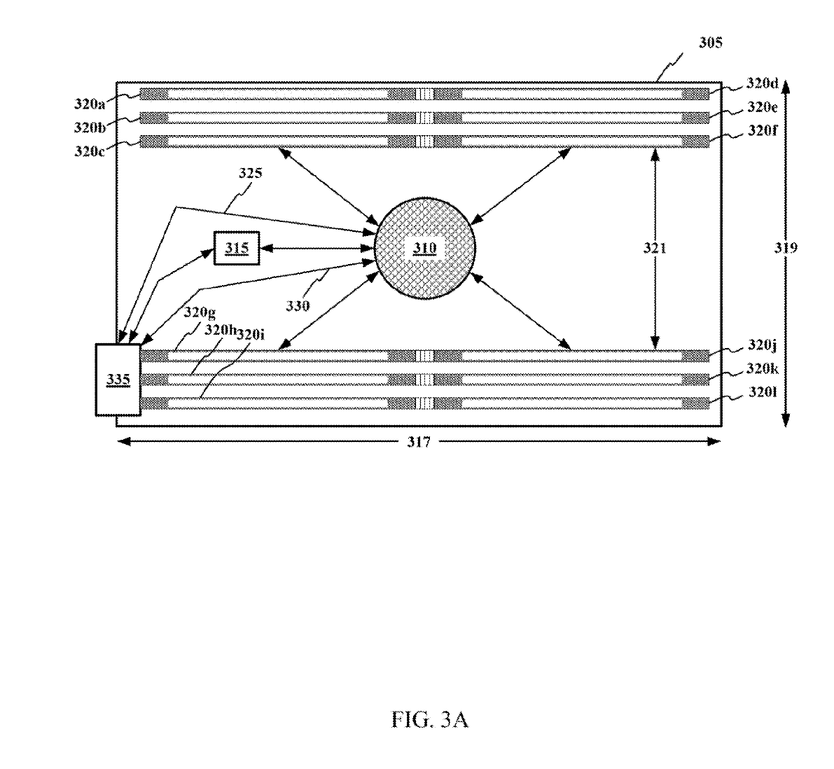

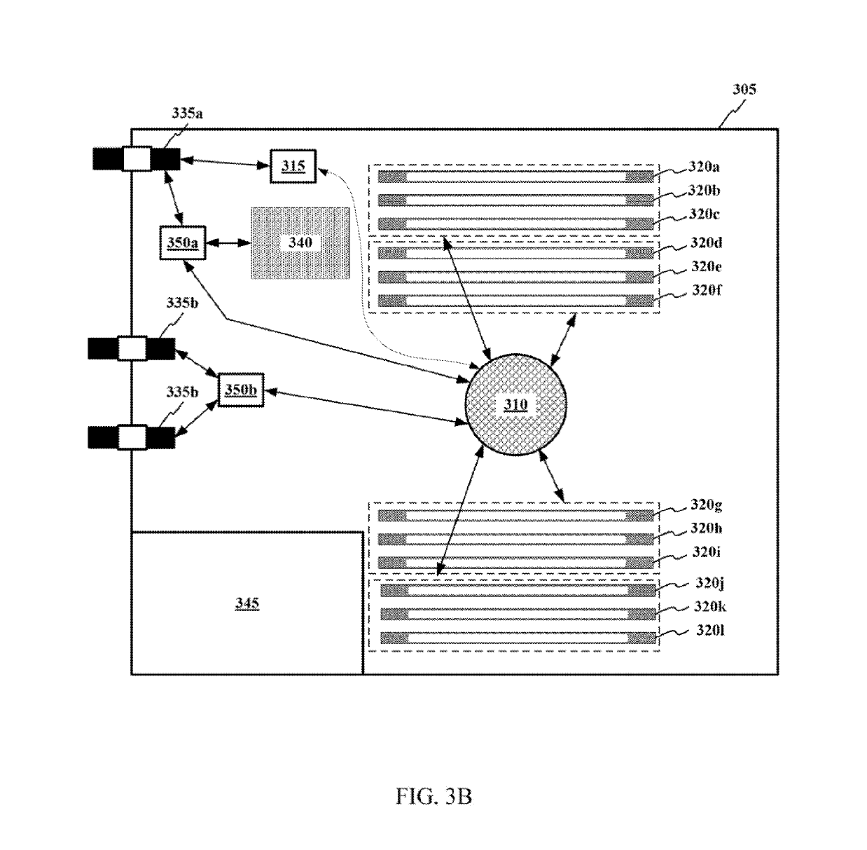

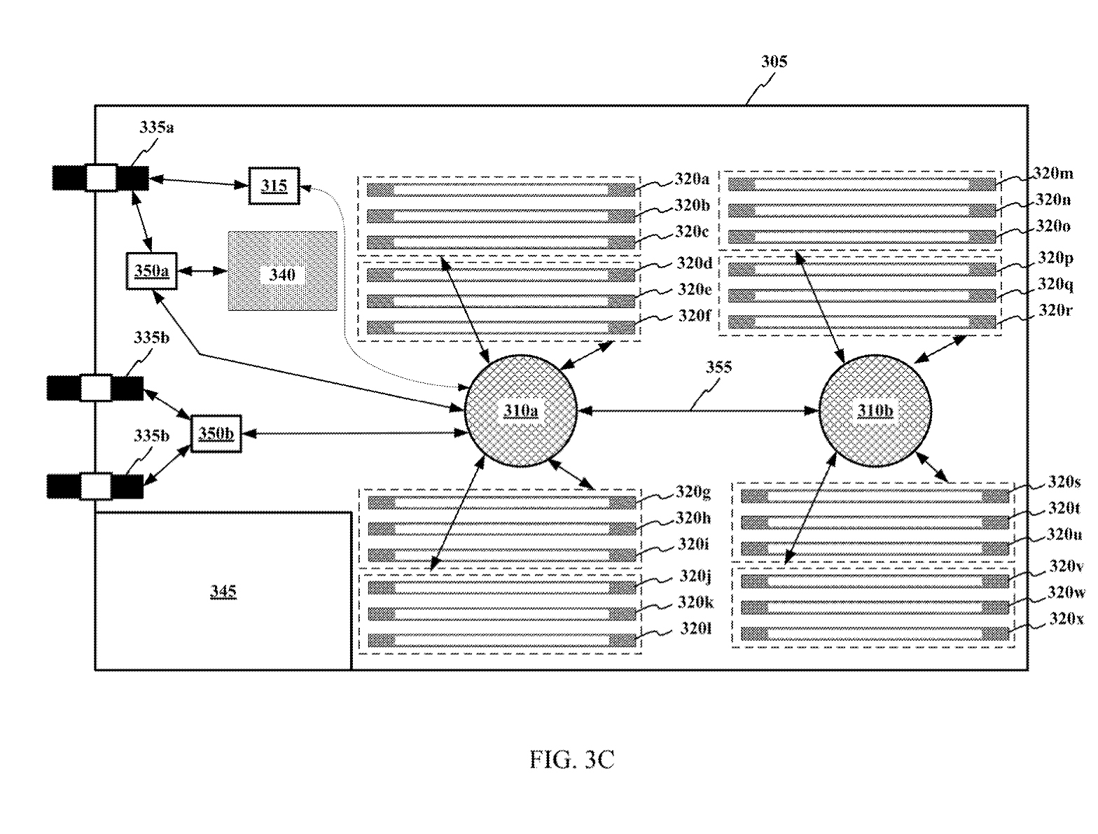

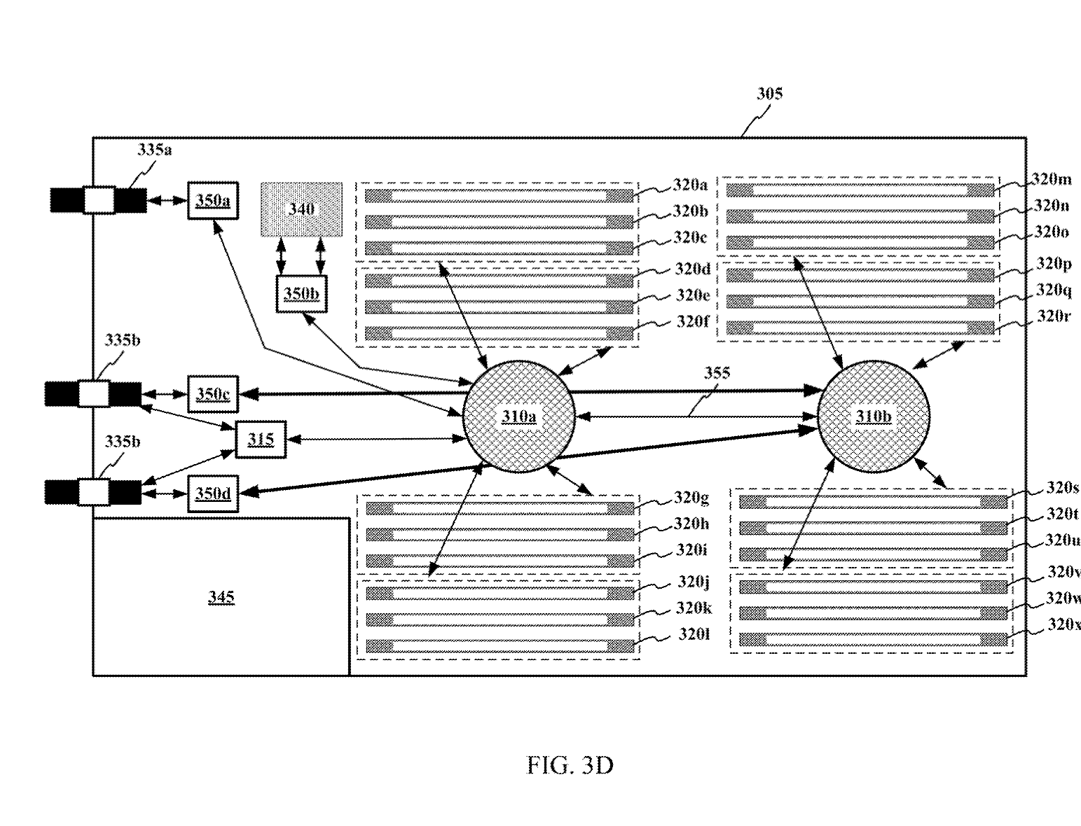

FIG. 3A depicts an illustrative CLM according to a first embodiment. The CLM 305 may include a processor 310 operatively coupled to memory elements 320a-3201. According to some embodiments, the memory elements 320a-3201 may include DIMM and/or flash memory elements arranged in one or more memory channels for the processor 310. For example, memory elements 320a-320c may form memory channel A, memory elements 320d-320f may form memory channel B, memory elements 320g-320i may form memory channel C, and memory elements 320j-3201 may form memory channel D. The memory elements 320a-3201 may be configured as cache storage for the CLM 305 and, therefore, provide at least a portion of the cache storage for the data storage array, depending on the number of CLMs in the data storage array. Although components of the CLM 305 may be depicted as hardware components, embodiments are not so limited. Indeed, components of the CLM 305, such as the processor 310, may be implemented in software, hardware, or a combination thereof.

In an embodiment, storage entries in the memory elements 320a-320c may be configured as 16 kilobytes in size. In an embodiment, the CLM 305 may store the logical to physical table (LPT) that stores a cache physical address, a flash storage physical address and tags configured to indicate a vital state. Each LPT entry may be of various sizes, such as 64 bits.

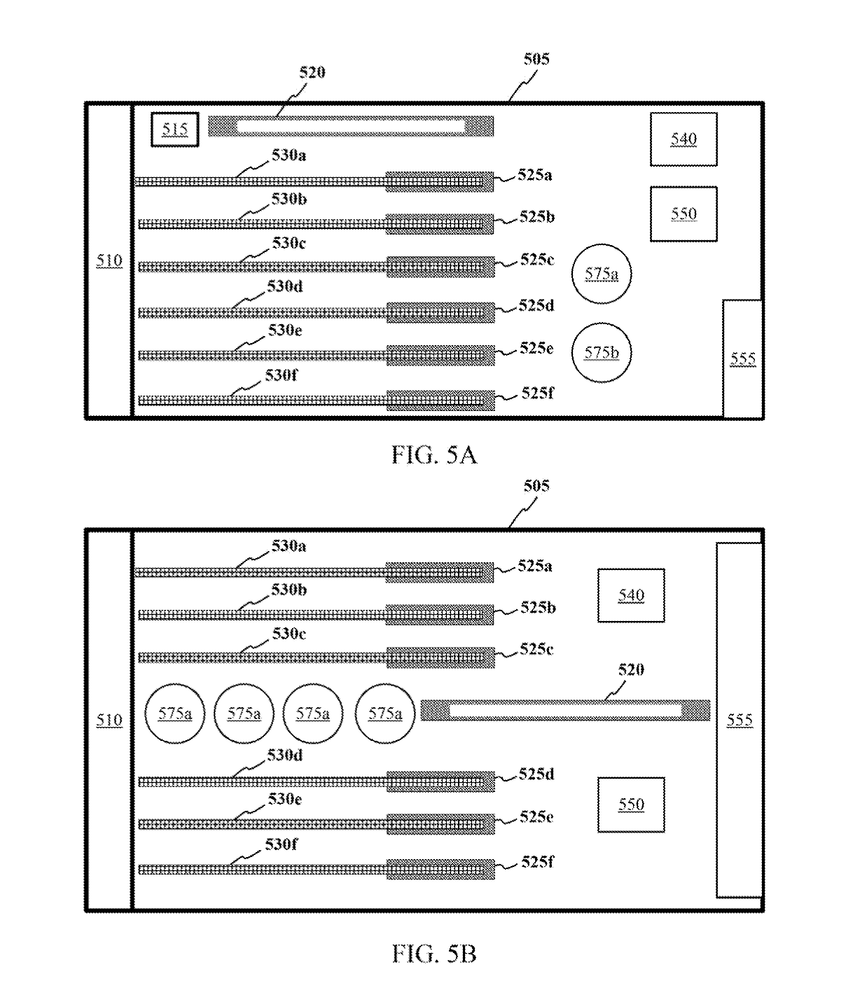

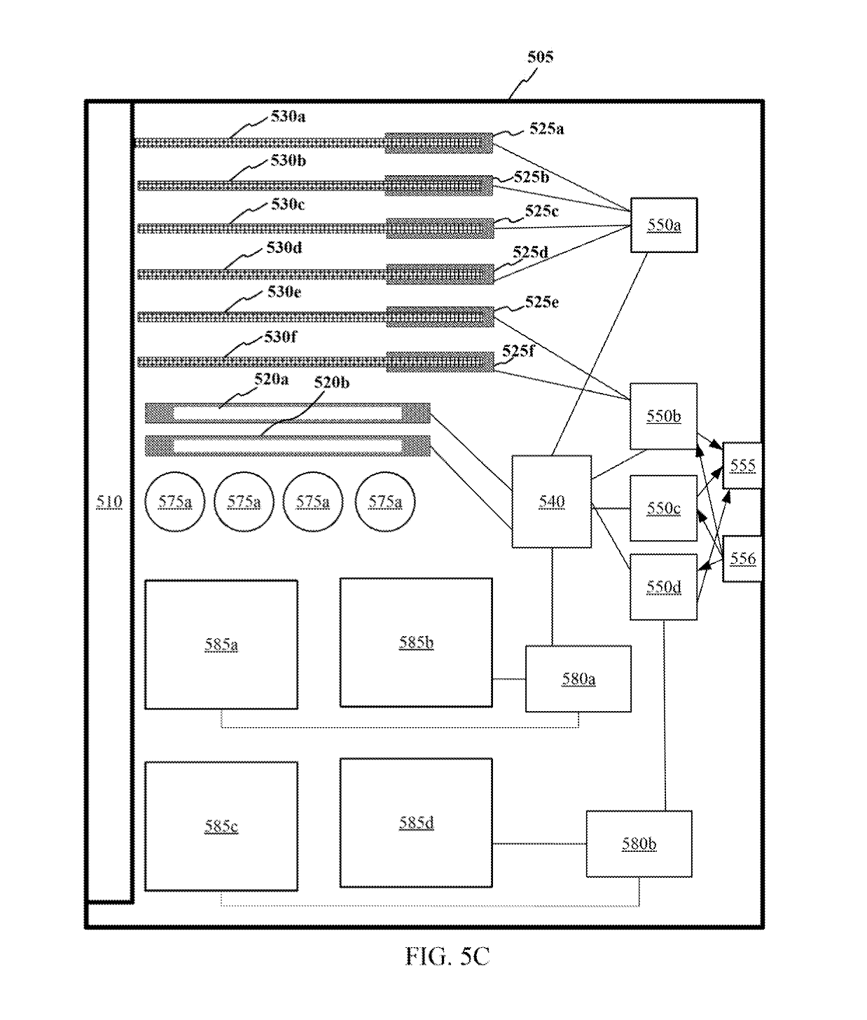

The processor 310 may include various processors, such as an Intel® IA-64 architecture processor, configured to be operatively coupled with an Ethernet communication element 315. The Ethernet communication element 315 may be used by the CLM 305 to provide internal communication, for example, for booting, system control, and the like. The processor 310 may also be operatively coupled to other storage components through communication buses 325, 330. In the embodiment depicted in FIG. 3A, the communication bus 325 may be configured as a sixteen (16) lane PCIe communication connection to persistent storage (for example, the persistent storage layer 150 of FIGS. 1A and 1B; see FIGS. 5A-5D for illustrative persistent storage according to some embodiments), while the communication bus 330 may be configured as an eight (8) lane PCIe communication connection to a storage components. In an embodiment, the communication buses 325, 330 may use the PCIe Gen 3 standard. A connection element 335 may be included to provide a connection between the various communication paths (such as 325, 330 and Ethernet) of the CLM 305 and the external devices, network layers, or the like.

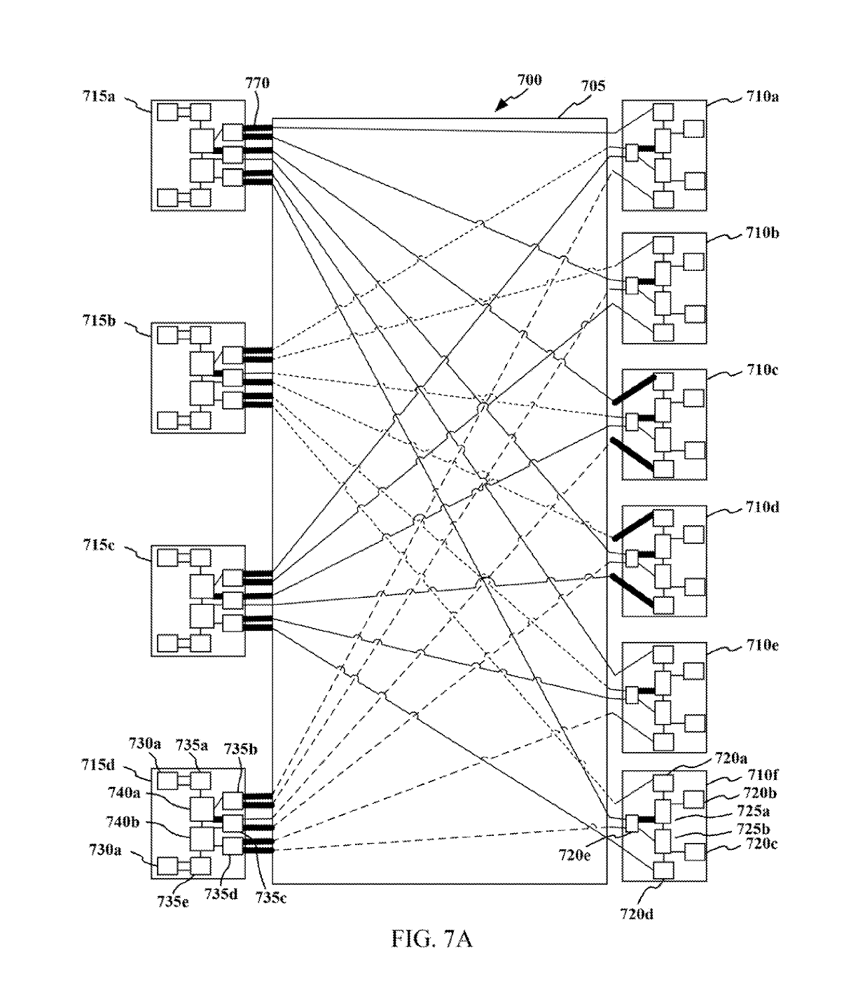

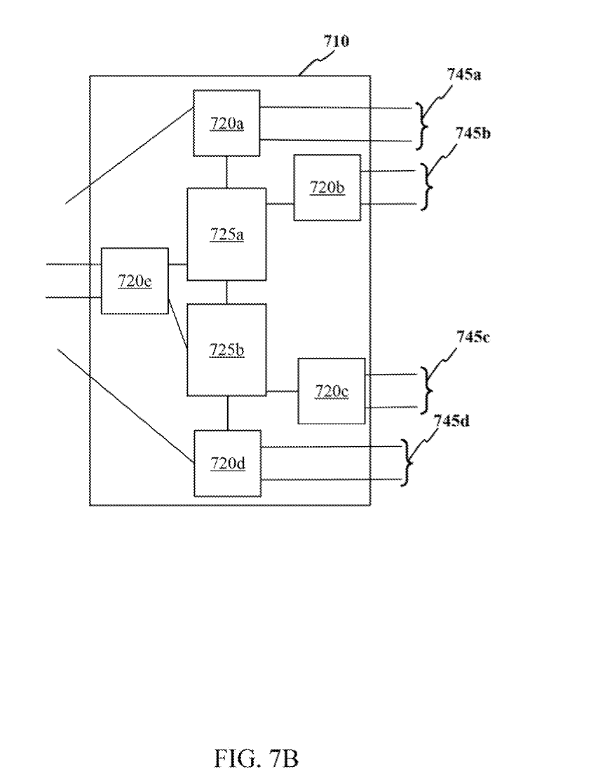

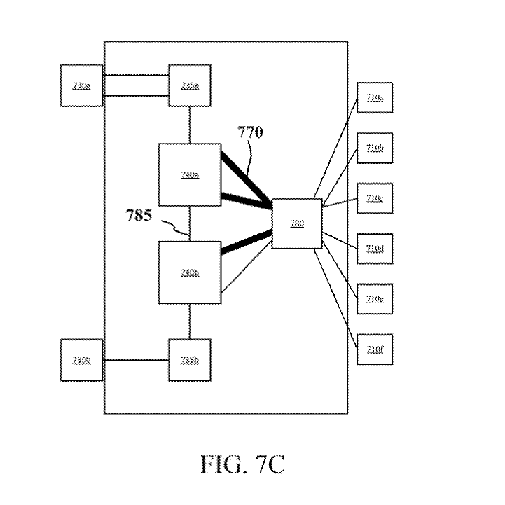

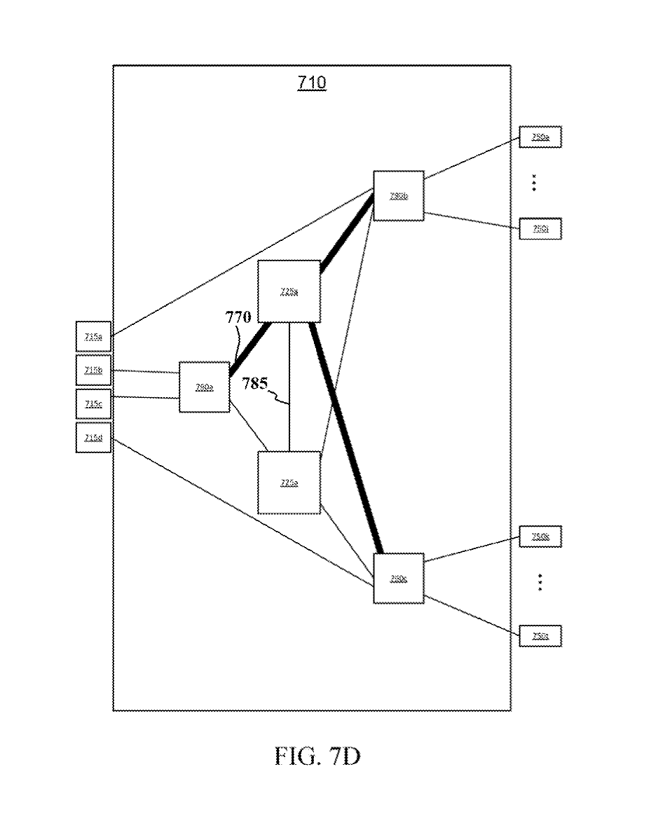

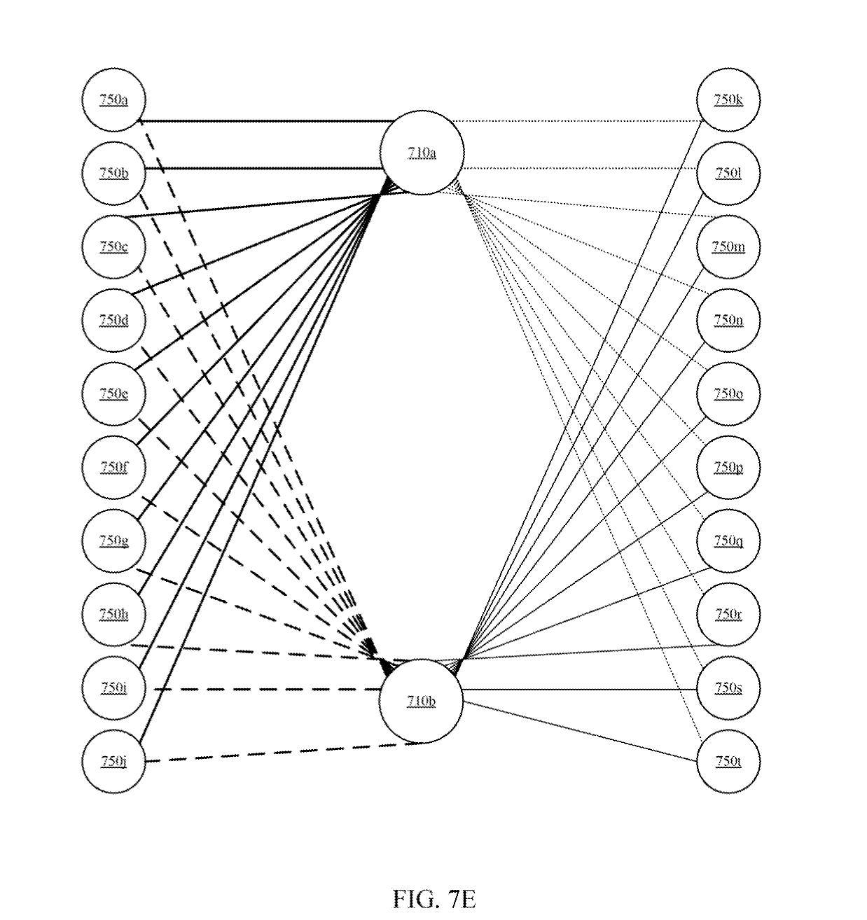

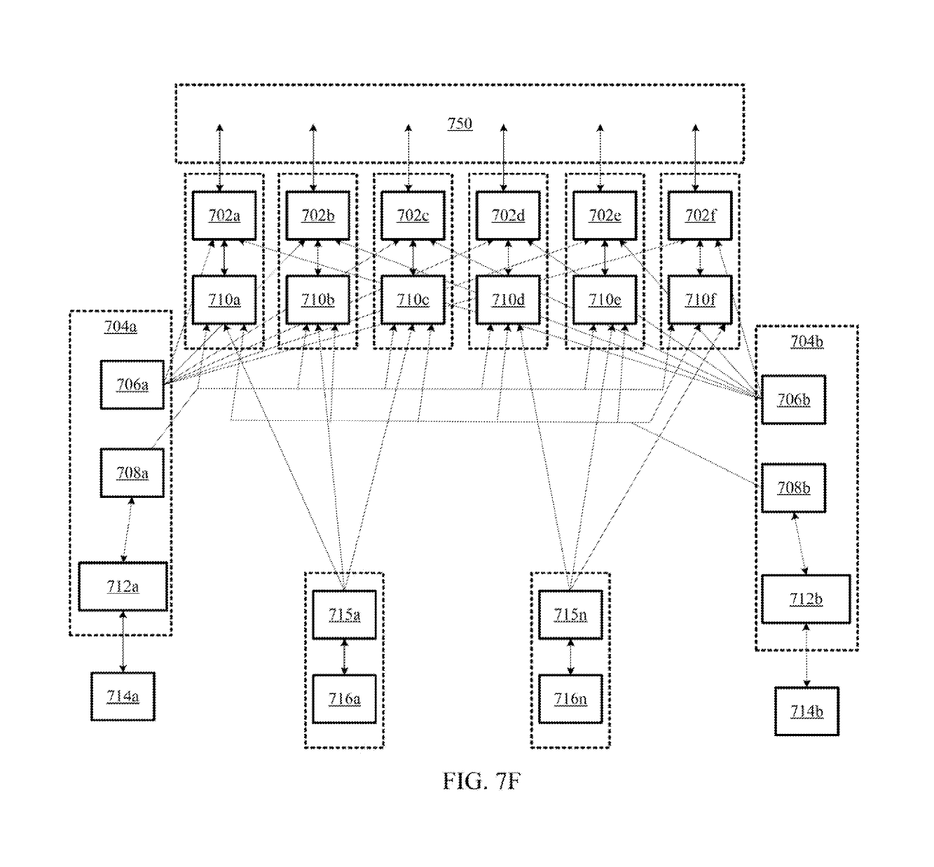

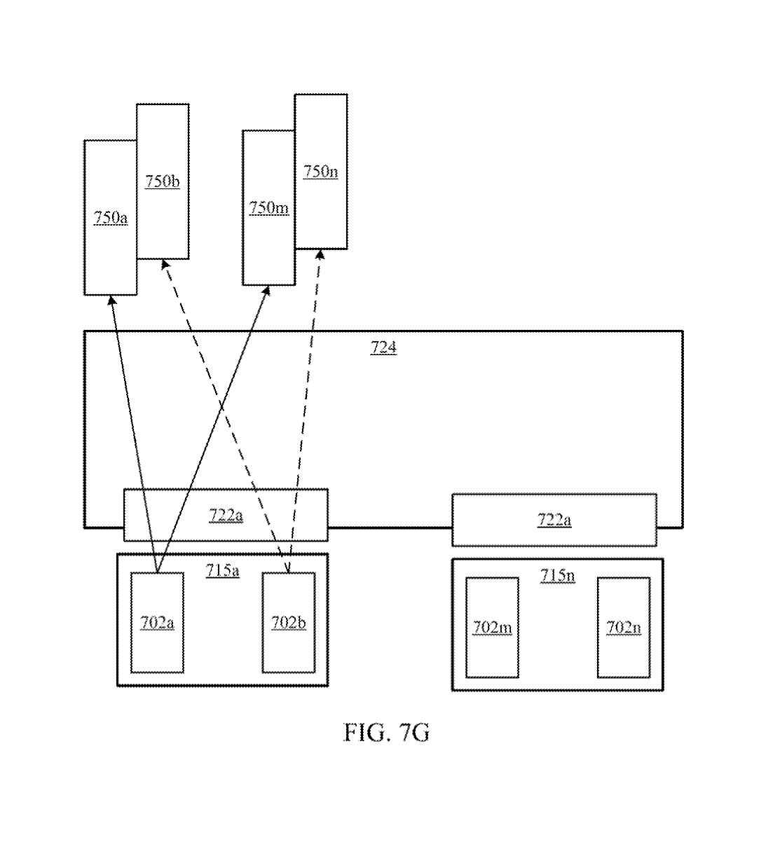

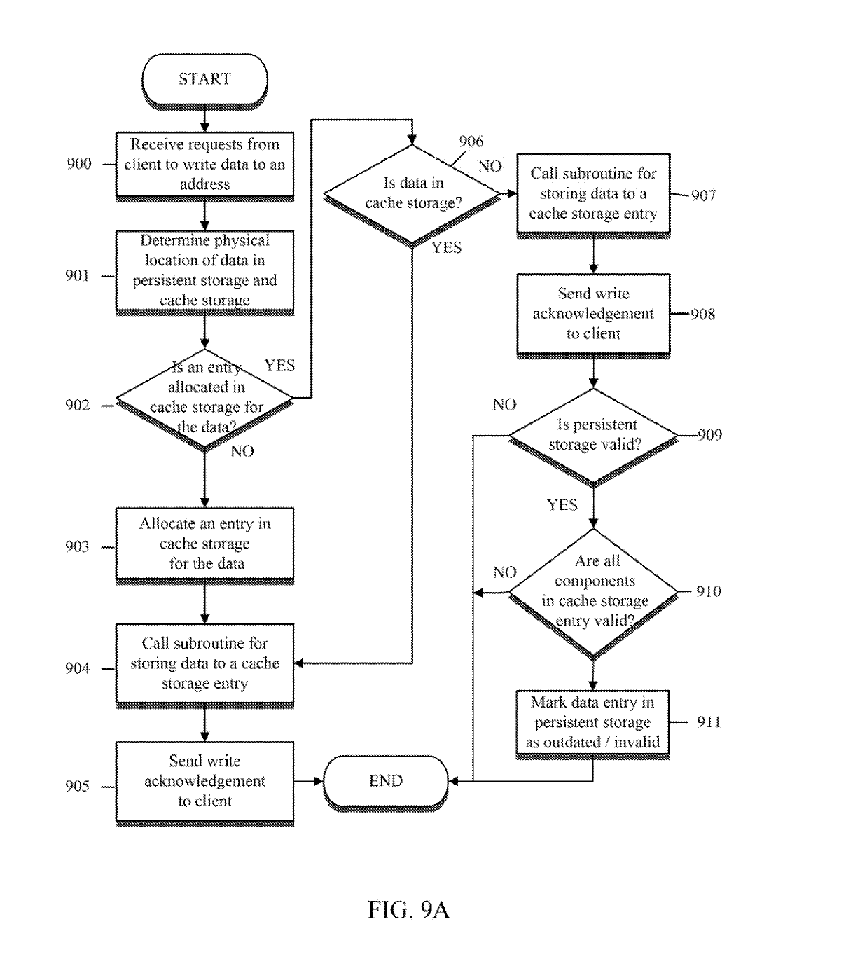

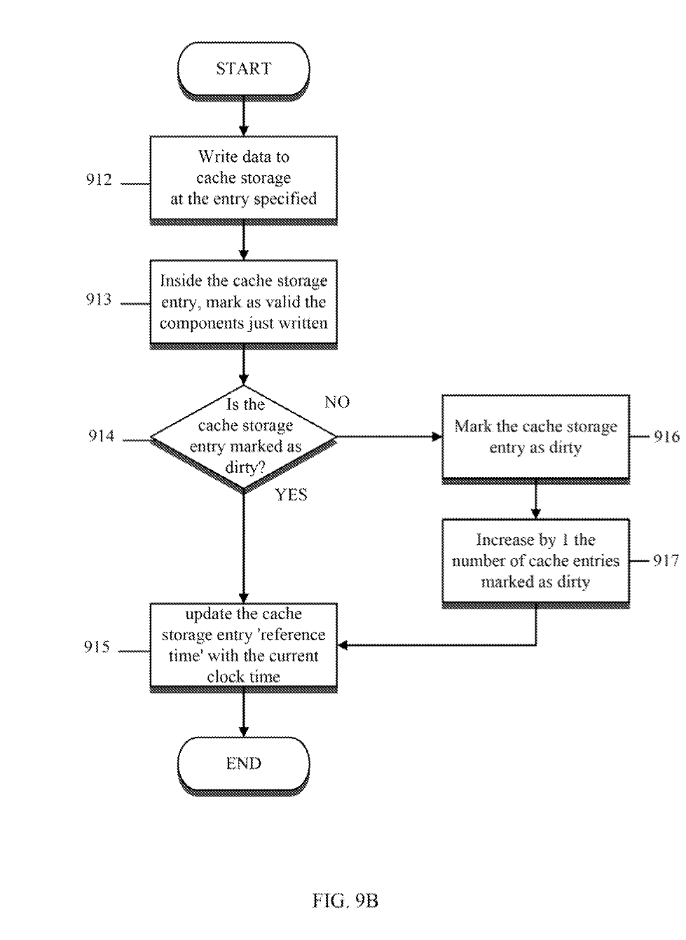

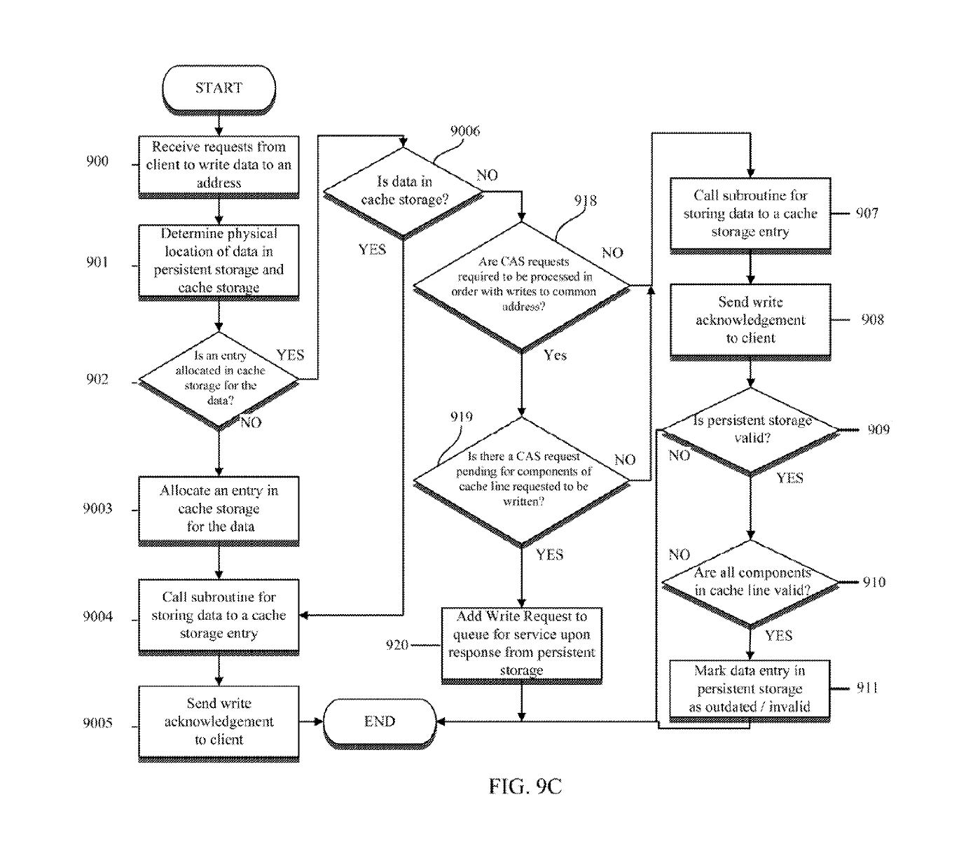

An AAM, such as AAM 205 depicted in FIGS. 2A-2F, may be operatively connected to the CLM 305 to facilitate client IO requests (see FIG. 7A for connections between AAMs and CLMs according to an embodiment; see FIGS. 9-11 for operations, such as read and write operations, between an AAM and a CLM). For example, an AAM may communicate with the CLM 305 through Ethernet as supported by the Ethernet communication element 315.

As with the AAM, the CLM 305 may have certain dimensions based on one or more factors, such as spacing requirements and the size of required components. In an embodiment, the length 317 of the CLM 305 may be about 328 millimeters. In another embodiment, the length 317 of the CLM 305 may be about 275 millimeters, about 300 millimeters, about 325 millimeters, about 350 millimeters, about 375 millimeters, about 400 millimeters, about 425 millimeters, about 450 millimeters, about 500 millimeters, about 550 millimeters, about 600 millimeters, and ranges between any two of these values (including endpoints). In an embodiment, the height 319 of the CLM 305 may be about 150 millimeters, about 175 millimeters, about 200 millimeters, about 225 millimeters, about 250 millimeters and ranges between any two of these values (including endpoints).

The components of the CLM 305 may have various dimensions and spacing depending on, among other things, size and operational requirements. In an embodiment, each of the memory elements 330a-330b may be arranged in slots or connectors that have an open length (for example, clips used to hold the memory elements in the slots are in an expanded, open position) of about 165 millimeters and a closed length of about 148 millimeters. The memory elements 330a-330b themselves may have a length of about 133 millimeters. The slots may be about 6.4 millimeters apart along a longitudinal length thereof. In an embodiment, a distance between channel edges of the slots 321 may be about 92 millimeters to provide for processor 310 cooling and communication routing.

FIG. 3B depicts an illustrative CLM according to a second embodiment.

As shown in FIG. 3B, the CLM 305 may include an integrated circuit 340 configured to perform certain operational functions. The CLM 305 may also include power circuitry 345 configured to provide at least a portion of the power required to operate the CLM.

In an embodiment, the integrated circuit 340 may include an FPGA configured to provide, among other things, data redundancy and/or error checking functions. For example, the integrated circuit 340 may provide RAID and/or forward error checking (FEC) functions for data associated with the CLM 305, such as data stored in persistent storage and/or the memory elements 330a-330b. The data redundancy and/or error checking functions may be configured according to various data protection techniques. For instance, in an embodiment in which there are nine (9) logical data “columns,” the integrated circuit 340 may operate to generate X additional columns such that if any of the X columns of the 9+X columns are missing, delayed, or otherwise unavailable, the data which was stored on the original nine (9) may be reconstructed. During initial booting of the CLM 305 in which only a single parity is employed (for example, number of columns X=1), the data may be generated using software executed by the processor 310. In an embodiment, software may also be provided to implement P/Q parity through the processor 310, for example, for persistent storage associated with the CLM 305.

Communication switches 350a and 350b may be included to facilitate communication between components of the CLM 305 and may be configured to use various communication protocols and to support various sizes (for example, communication lanes, bandwidth, throughput, or the like). For example, communication switches 350a and 350b may include PCIe switches, such as twenty-four (24), thirty-two (32) and/or forty-eight (48) lane PCIe switches. The size and configuration of the communication switches 350a and 350b may depend on various factors, including, without limitation, required data throughput speeds, power consumption, space constraints, energy constraints, and/or available resources.

The connection element 335a may provide a communication connection between the CLM 305 and an AAM. In an embodiment, connection element 335a may include an eight (8) lane PCIe connection configured to use the PCIe Gen 3 standard. The connection elements 335b and 335c may provide a communication connection between the CLM 305 and persistent storage elements. In an embodiment, the connection elements 335b and 335c may include eight (8) PCIe connections having two (2) lanes each. Some embodiments provide that certain of the connections may not be used to communicate with persistent storage but may be used, for example, for control signals.

FIG. 3C depicts an illustrative CLM according to a third embodiment. The CLM 305 may include a plurality of processors 310a, 310b operatively coupled to each other through a processor-to-processor communication channel 355. In an embodiment in which the processors 310a, 310b are Intel® processors, such as IA-64 architecture processors, the processor-to-processor communication channel 355 may comprise a QPI communication channel. In an embodiment, the processors 310a, 310b may be configured to operate in a similar manner to provide more processing and memory resources. In another embodiment, one of the processors 310a, 310b may be configured to provide at least partial software control for the other processor and/or other components of the CLM 305.

FIG. 3D depicts an illustrative CLM according to a fourth embodiment. As shown in FIG. 3D, the CLM 305 may include two processors 310a, 310b. The processor 310a may be operatively coupled to the integrated circuit 340 and to AAMs within the data storage array through the communication connection 335a. The processor 310b may be operatively coupled to persistent storage through the communication connections 335b and 335c. The CLM 305 illustrated in FIG. 3D may operate to provide increased bandwidth (for example, double the bandwidth) to persistent storage as the AAMs of the data storage array have to the cache storage subsystem. This configuration may operate, among other things, to minimize latency for operations involving persistent storage, for example, due to data transfer, as the primary activities may include data reads and writes to the cache storage subsystem.

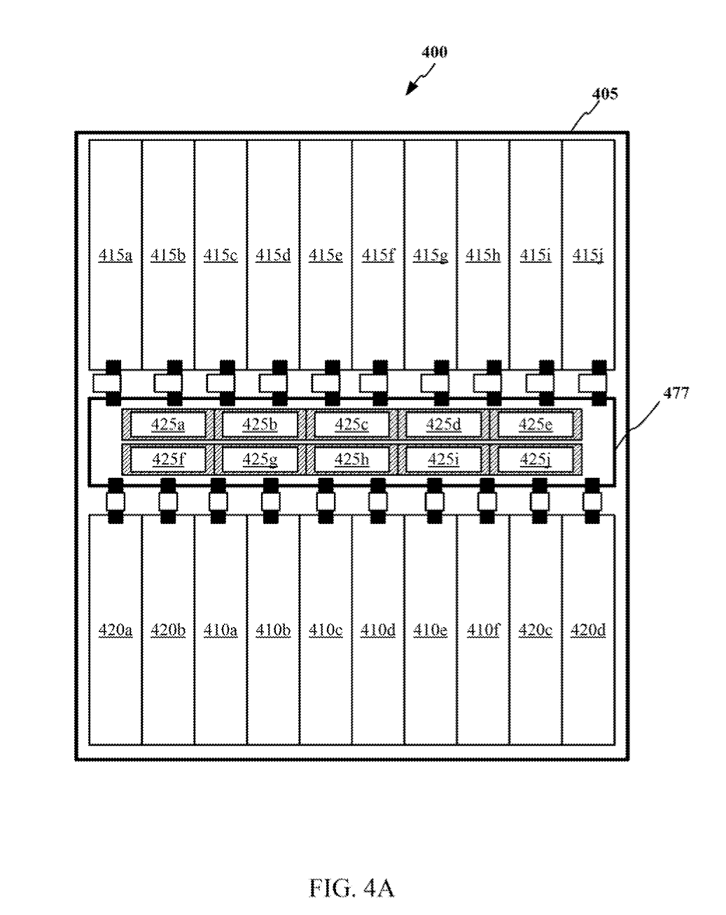

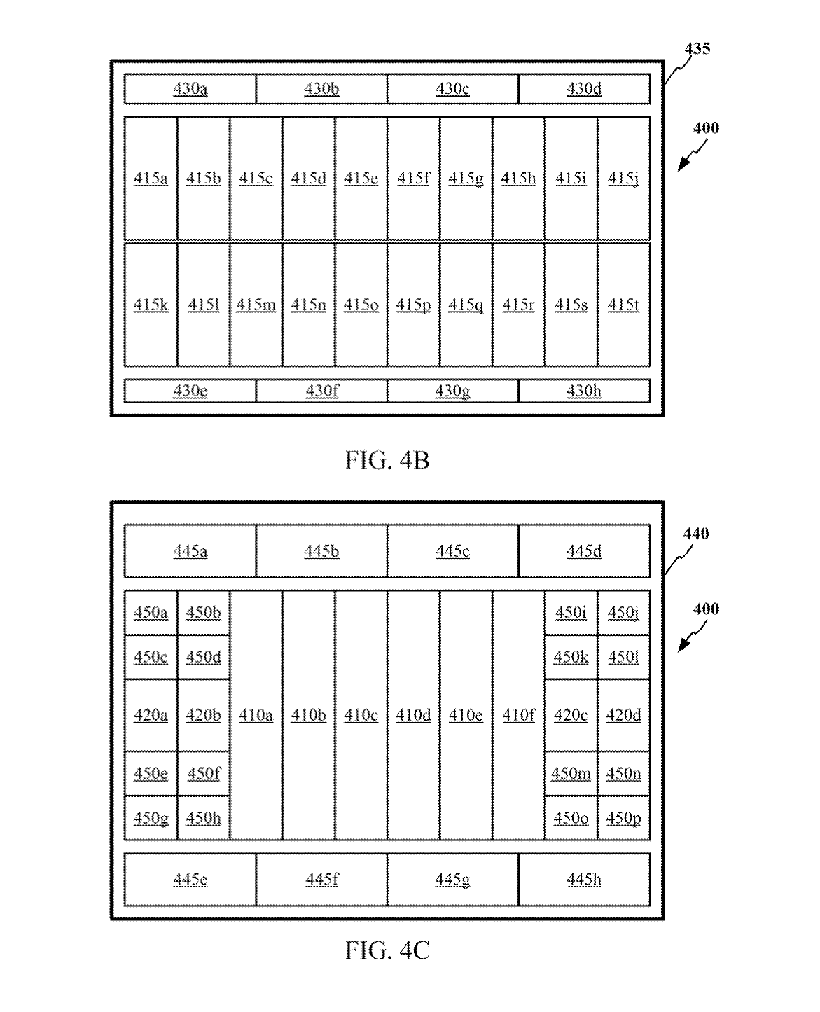

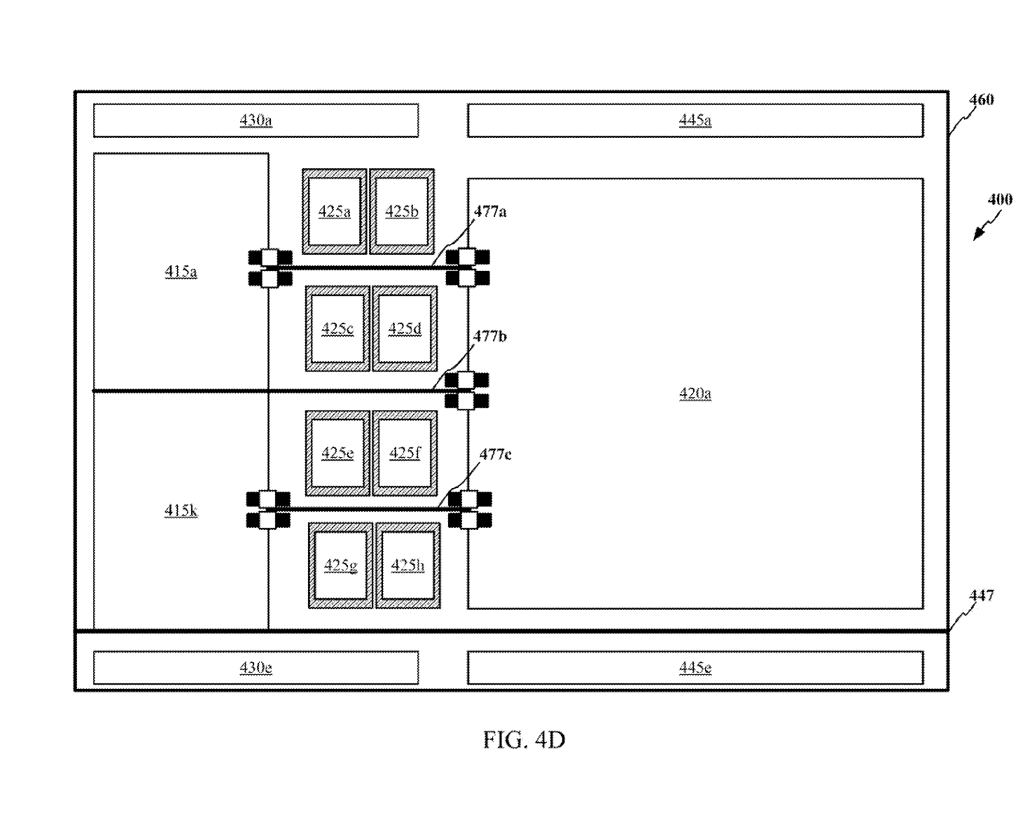

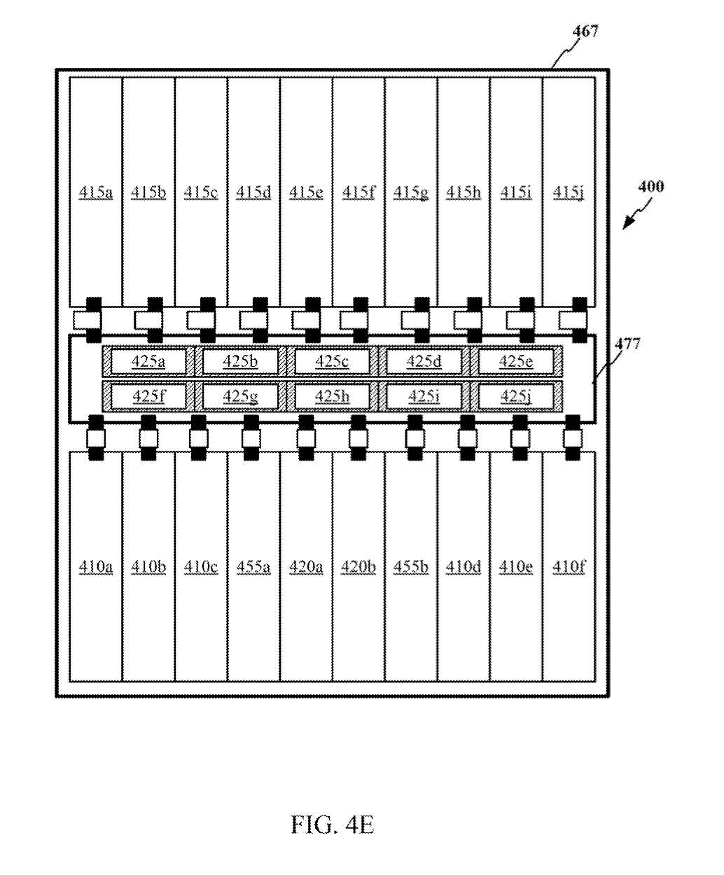

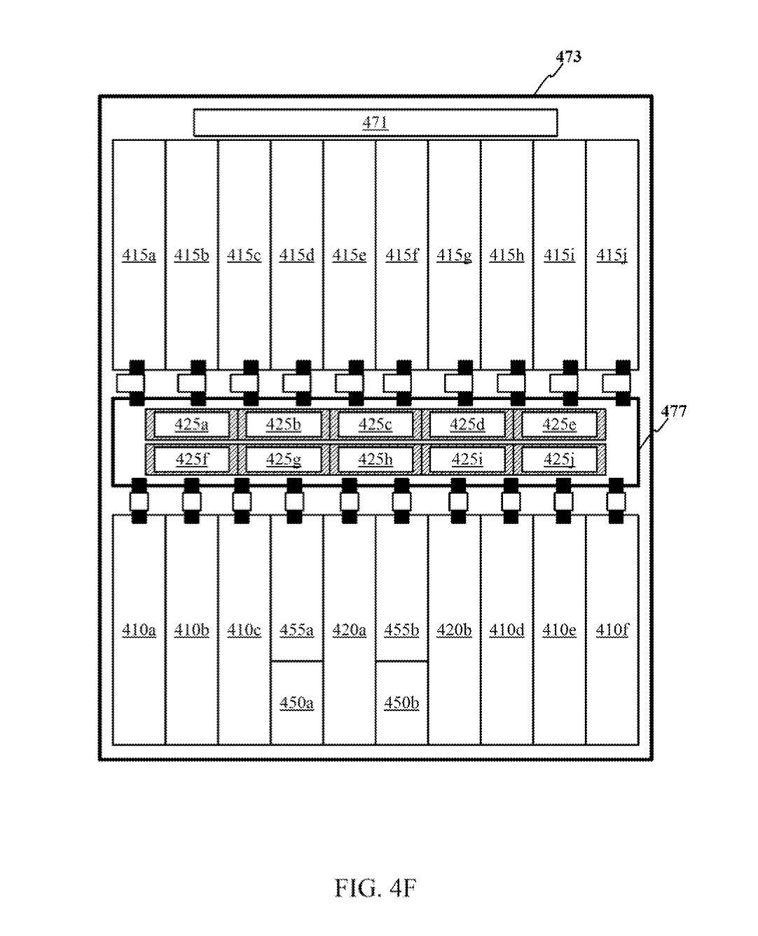

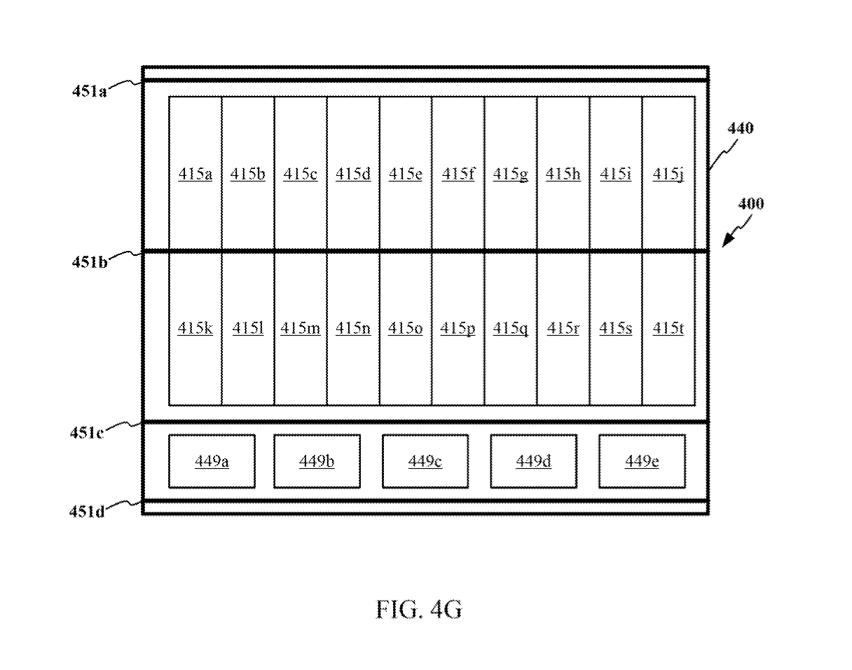

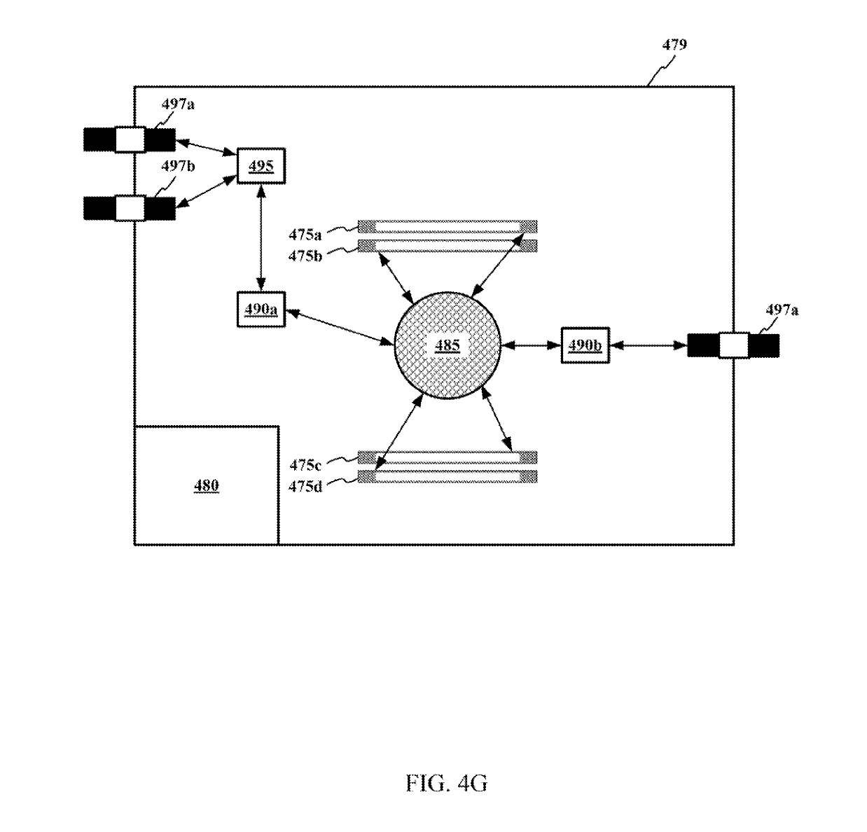

FIG. 4A depicts a top view of a portion of an illustrative data storage array according to a first embodiment. As shown in FIG. 4A, a top view 405 of a portion of data storage array 400 may include persistent storage elements 415a-415j. According to some embodiments, the persistent storage elements 415a-415j may include, but are not limited to PSMs, flash storage devices, hard disk drive storage devices, and other forms of persistent storage (see FIGS. 5A-5D for illustrative forms of persistent storage according to some embodiments). The data storage array 400 may include multiple persistent storage elements 415a-415j configured in various arrangements. In an embodiment, the data storage array 400 may include at least twenty (20) persistent storage elements 415a-415j.

Data may be stored in the persistent storage elements 415a-415j according to various methods. In an embodiment, data may be stored using “thin provisioning” in which unused storage improves system (for example, flash memory) performance and raw storage may be “oversubscribed” if it leads to efficiencies in data administration. Thin provisioning may be implemented, in part, by taking data snapshots and pruning at least a portion of the oldest data.

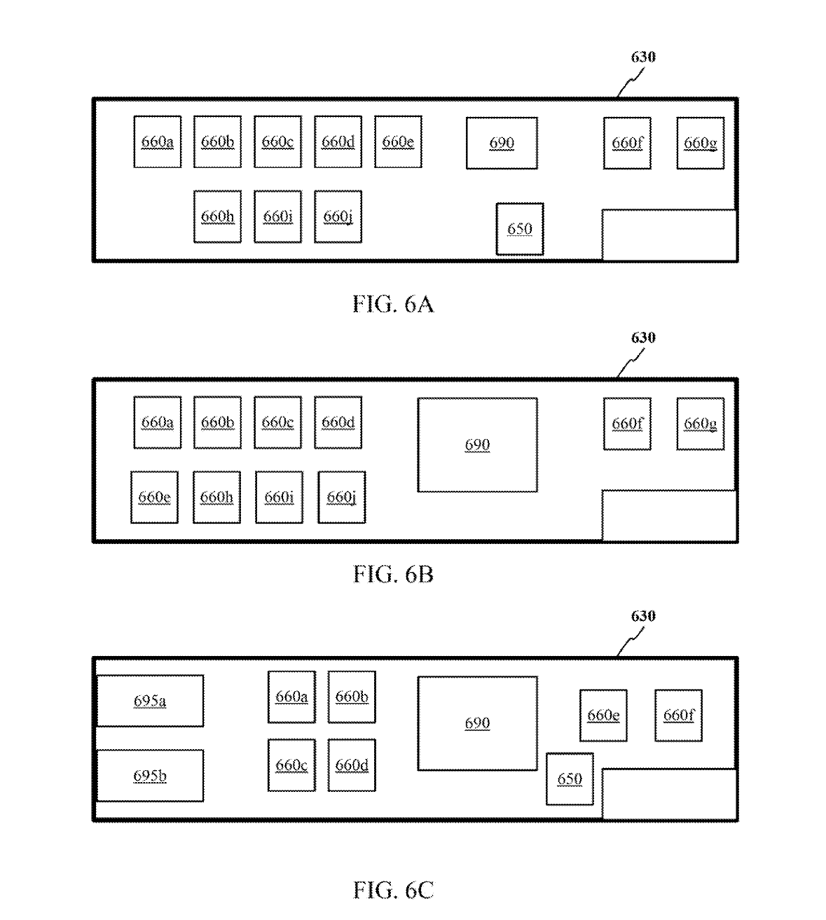

The data storage array 400 may include a plurality of CLMs 410a-410f operatively coupled to the persistent storage elements 415a-415j (see FIGS. 6, 7B and 7C for illustrative connections between CLMs and persistent storage elements according to some embodiments). The persistent storage elements 415a-415j may coordinate the access of the CLMs 410a-410f, each of which may request data be written to and/or or read from the persistent storage elements 415a-415j. According to some embodiments, the data storage array 400 may not include persistent storage elements 415a-415j and may use cache storage implemented through the CLMs 410a-410f for data storage.

As depicted in FIGS. 4A-4D, each CLM 410a-410f may include memory elements configured to store data within the data storage array 400. These memory elements may be configured as the cache storage for the data storage array 400. In an embodiment, data may be mirrored across the CLMs 410a-410f. For example, data and/or meta-data may be mirrored across at least two CLMs 410a-410f. In an embodiment, one of the mirrored CLMs 410a-410f may be “passive” while the other is “active.” In an embodiment, the meta-data may be stored in one or more meta-data tables configured as cache-lines of data, such as 64 bytes of data.

According to some embodiments, data may be stored according to various RAID configurations within the CLMs 410a-410f. For example, data stored in the cache may be stored in single parity RAID across all CLMs 410a-410f. In an embodiment in which there are six (6) CLMs 410a-410f, 4+1 RAID may be used across five (5) of the six (6) CLMs. This parity configuration may be optimized for simplicity, speed and cost overhead as each CLM 410a-410f may be able to tolerate at least one missing CLM 410a-410f.

A plurality of AAMs 420a-420d may be arranged within the data storage array on either side of the CLMs 410a-410f. In an embodiment, the AAMs 420a-420d may be configured as a federated cluster. A set of fans 425a-425j may be located within the data storage array 400 to cool the data storage array. According to some embodiments, the fans 425a-425j may be located within at least a portion of an “active zone” of the data storage array (for example, a high heat zone). In an embodiment fan control and monitoring may be done via low speed signals to control boards which are very small, minimizing the effect of trace lengths within the system. Embodiments are not limited to the arrangement of components in FIGS. 4A-4D as these are for illustrative purposes only. For example, one or more of the AAMs 420a-420d may be positioned between one or more of the CLMs 410a-410f, the CLMs may be positioned on the outside of the AAMs, or the like.

The number and/or type of persistent storage elements 415a-415j, CLMs 410a-410f and AAMs 420a-420d may depend on various factors, such as data access requirements, cost, efficiency, heat output limitations, available resources, space constraints, and/or energy constraints. As shown in FIG. 4A, the data storage array 400 may include six (6) CLMs 410a-410f positioned between four (4) AAMs 420a-420d, with two (2) AAMs on each side of the six (6) CLMs. In an embodiment, the data storage array may include six (6) CLMs 410a-410f positioned between four (4) AAMs 420a-420d and no persistent storage elements 415a-415j. The persistent storage elements 415a-415j may be located on a side opposite the CLMs 410a-410f and AAMs 420a-420d, with the fans 425a-425j positioned therebetween. Midplanes, such as midplane 477, may be used to facilitate data flow between various components, such as between the AAM 420a-420j (only 420a visible in FIG. 4D) and the CLMs 410a-410f (not shown) and/or the CLMs and the persistent storage elements 415a-415t. According to some embodiments, multiple midplanes may be configured to effectively operate as a single midplane

According to some embodiments, each CLM 410a-410f may have an address space in which a portion thereof includes the “primary” CLM. When a “master” CLM 410a-410f is active, it is the “primary;” otherwise, the “slave” for the address is the primary. A CLM 410a-410f may be the “primary” CLM over a particular address space, which may be static or change dynamically based on operational conditions of the data storage array 400.

In an embodiment, data and/or page “invalidate” messages may be sent to the persistent storage elements 415a-415j when data in the cache storage has invalidated an entire page in the underlying persistent storage. Data “invalidate messages” may be driven by client devices entirely overwriting the entry, or partial writes by client and the prior data read from the persistent storage, and may proceed to the persistent storage elements 415a-415j according to various ordering schemes, including a random ordering scheme.

Data and/or page read requests may be driven by client activity, and may proceed to the CLMs 410a-410f and/or persistent storage elements 415a-415j according to various ordering schemes, including a random ordering scheme. Data and/or page writes to the persistent storage elements 415a-415j may be driven by each CLM 410a-410f independently over the address space for which it is the “primary” CLM 410a-410f. Data being written into the flash cards (or “bullets”) of the persistent storage elements 415a-415j may be buffered in the flash cards and/or or the persistent storage elements.

According to some embodiments, writes may be performed on the “logical blocks” of each persistent storage element 415a-415j. For example, each logical block may be written sequentially. A number of the logical blocks may be open for writes concurrently, and in parallel, on each persistent storage element 415a-415j from each CLM 410a-410f. A write request may be configured to specify both the CLM 410a-410f view of the address along with the logical block and intended page within the logical block where the data will be written. The “logical page” should not require remapping by the persistent storage element 415a-415j for the initial write. The persistent storage elements 415a-415j may forward data for a pending write from any “primary” CLM 410a-410f directly to the flash card where it will (eventually) be written. Accordingly, buffering in the persistent storage elements 415a-415j is not required before writing to the flash cards.

Each CLM 410a-410f may write to logical blocks presented to it by the persistent storage elements 415a-415j, for example, to all logical blocks or only to a limited portion thereof. The CLM 410a-410f may be configured to identify how many pages it can write in each logical block it is handling. In an embodiment, the CLM 410a-410f may commence a write once to all CLMs holding the data in their respective cache storage send to the persistent storage (for example, the flash cards of a persistent storage elements 415a-415j) in parallel. The timing of the actual writes to the persistent storage elements 415a-415j (or, the flash cards of the persistent storage elements) may be managed by the persistent storage element 415a-415j and/or the flash cards and/or hard disk drives associated therewith. The flash cards may be configured with different numbers of pages in different blocks. In this manner, when a persistent storage element 415a-415j assigns logical blocks to be written, the persistent storage element may provide a logical block which is mapped by the persistent storage element 415a-415j to the logical block used for the respective flash card. The persistent storage element 415a-415j or the flash cards may determine when to commit a write. Data which has not been fully written for a block (for example, 6 pages per block being written per flash die for 3b/c flash) may be serviced by a cache on the persistent storage element 415a-415j or the flash card.

According to some embodiments, the re-mapping of tables between the CLMs 410a-410f and the flash cards may occur at the logical or physical block level. In such embodiments, the re-mapped tables may remain on the flash cards and page-level remapping may not be required on the actual flash chips on the flash cards (see FIGS. 5D-5F for an illustrative embodiment of a flash card including flash chips according to some embodiments).

In an embodiment, a “CLM page” may be provided to, among other things, facilitate memory management functions, such as garbage collection. When a persistent storage element 415a-415j handles a garbage collection event for a page in physical memory (for example, physical flash memory), it may simply inform the CLM 410a-410f, for example, that the logical page X, formerly at location Y, is now at location Z. In addition, the persistent storage element 415a-415j may inform the CLM 410a-410f which data will be managed (for example, deleted or moved) by the garbage collection event so the CLM 410a-410f may inform any persistent storage element 415a-415j that it may want a read of “dirty” or modified data (as the data may be re-written). In an embodiment, the persistent storage element 415a-415j only needs to update the master CLM 410a-410f which is the CLM that synchronizes with the slave.

A persistent storage element 415a-415j may receive the data and/or page “invalidate” messages, which may be configured to drive garbage collection decisions. For example, a persistent storage element 415a-415j may leverage the flash cards for tracking “page valid” data to support garbage collection. In another example, invalidate messages may pass through from the persistent storage element 415a-415j to a flash card, adjusting any block remapping which may be required.

In an embodiment, the persistent storage element 415a-415j may coordinate “page-level garbage collection” in which both reads and writes may be performed from/to flash cards that are not driven by the CLM 410a-410f. In page-level garbage collection, when the number of free blocks is below a given threshold, garbage collection events may be initiated. Blocks may be selected for garbage collection according to various processes, including the cost to perform garbage collection on a block (for example, the less valid the data, the lower the cost to free the space), the benefits of performing garbage collection on a block (for example, benefits may be measured according to various methods, including scaling the benefit based on the age of the data such that there is a higher benefit for older data), and combinations thereof.

In an embodiment, garbage collection writes may be performed on new blocks. Multiple blocks may be in the process of undergoing garbage collection reads and writes at any point in time. When a garbage collection “move” is complete, the persistent storage element 415a-415j should inform the CLM 410a-410f that the logical page X, formerly at location Y, is now at location Z. Before a move is complete, the CLM 410a-410f may transmit subsequent read requests to the “old” location, as the data was valid there. “Page invalidate” messages sent to a garbage collection item may be managed to remove the “new” location (for example, if the data had actually been written).

The data storage array 400 may be configured to boot up in various sequences. According to some embodiments, the data storage array may boot up in the following sequence: (1) each AAM 420a-420d, (2) each CLM 410a-410f and (3) each persistent storage element 415a-415j. In an embodiment, each AAM 420a-420d may boot from its own local storage or, if local storage is not present or functional, each AAM 420a-420d may boot over Ethernet from another AAM. In an embodiment, each CLM 410a-410f may boot up over Ethernet from an AAM 420a-420d. In an embodiment, each persistent storage element 415a-415j may boot up over Ethernet from an AAM 420a-420d via switches in the CLMs 410a-410f.

In an embodiment, during system shutdown, any “dirty” or modified data and all system meta-data may be written to the persistent storage elements 415a-415j, for example, to the flash cards or hard disk drives. Writing the data to the persistent storage element 415a-415j may be performed on logical blocks that are maintained as “single-level” pages, for example, for higher write bandwidth. On system restart, the “shutdown” blocks may be re-read from the persistent storage element 415a-415j. In an embodiment, system-level power down will send data in the persistent storage elements 415a-415j to “SLC-blocks” that operate at a higher performance level. When a persistent storage element 415a-415j is physically removed (for example, due to loss of power), any unwritten data and any of its own meta-data must be written to the flash cards. As with system shutdown, this data may be written into the SLC-blocks, which may be used for system restore.

Embodiments are not limited to the number and/or positioning of the persistent storage elements 415a-415j, the CLMs 410a-410f, the AAMs 420a-420d, and/or the fans 425a-425j as these are provided for illustrative purposes only. More or fewer of these components may be arranged in one or more different positions that are configured to operate according to embodiments described herein.

FIG. 4B depicts a media-side view of a portion of an illustrative data storage array according to a first embodiment. As shown in FIG. 4B, a media-side view 435 of a portion of data storage array 400 may include persistent storage elements 415a-415t. This view may be referred to as the “media-side” as it is the side of the data storage array 400 where the persistent storage media may be accessed, for example, for maintenance or to swap a faulty component. In an embodiment, the persistent storage elements 415a-415t may be configured as field replaceable units (FRUs) capable of being removed and replaced during operation of the data storage array 400 without having to shut down or otherwise limit the operations of the data storage array. According to some embodiments, field replaceable units (FRUs) may be front-, rear- and/or side-serviceable.

Power units 430a-430h may be positioned on either side of the persistent storage elements 415a-415t. The power units 430a-430h may be configured as power distribution and hold units (PDHUs) capable of storing power, for example, for distribution to the persistent storage elements 415a-415t. The power units 430a-430h may be configured to distribute power from one or more main power supplies to the persistent storage elements 415a-415t (and other FRUs) and/or to provide a certain amount of standby power to safely shut down a storage component in the event of a power failure or other disruption.

FIG. 4C depicts a cable-side view of a portion of an illustrative data storage array according to a first embodiment. The cable-side view 435 presents a view from a side of the data storage array 400 in which the cables associated with the data storage array and components thereof may be accessible. Illustrative cables include communication cables (for example, Ethernet cables) and power cables. For example, an operator may access the AAMs 420a-420d from the cable-side as they are cabled to connect to external devices. As shown in FIG. 4C, the cable-side view 435 presents access to power supplies 445a-445h for the data storage array 400 and components thereof. In addition, communication ports 450a-450p may be accessible from the cable-side view 435. Illustrative communication ports 450a-450p include, without limitation, network interface cards (NICs) and/or HBAs.

FIG. 4D depicts a side view of a portion of an illustrative data storage array according to a first embodiment. As shown in FIG. 4D, the side view 460 of the data storage array 400 provides a side view of certain of the persistent storage elements 415a, 415k, the fans 425a-425h, an AAM (for example, AAM 420a from one side view and AAM 420e from the opposite side view), power units 430a-430e, and power supplies 445a-445e. Midplanes 477a-477c may be used to facilitate data flow between various components, such as between the AAM 420a-420j (only 420a visible in FIG. 4D) and the CLMs 410a-410f (not shown) and/or the CLMs and the persistent storage elements 415a-415t. In an embodiment, one or more of the CLMs 410a-410f may be positioned on the outside, such that a CLM is located in the position of the AAM 420a depicted in FIG. 4D.

Although the data storage array 400 is depicted as having four (4) rows of fans 425a-425h, embodiments are not so limited, as the data storage array may have more or fewer rows of fans, such as two (2) rows of fans or six (6) rows of fans. The data storage array 400 may include fans 425a-425h of various dimensions. For example, the fans 425a-425h may include 7 fans having a diameter of about 60 millimeters or about 10 fans having a diameter of about 40 millimeters. In an embodiment, a larger fan 425a-425h may be about 92 millimeters in diameter.

As shown in FIG. 4D, the data storage array 400 may include a power plane 447, which may be common between the power units 430a-430e, power supplies 445a-445e, PDHUs (not shown) and the lower row of persistent storage devices 415a-415j. In an embodiment, power may be connected to the top of the data storage array 400 for powering the top row of persistent storage devices 415a-415j. In an embodiment, the power subsystem or components thereof (for example, the power plane 447, the power units 430a-430e, the power supplies 445a-445e, and/or the PDHUs) may be replicated, for instance, in an inverted manner at the top of the system. In an embodiment, physical cable connections may be used for the power subsystem.

FIG. 4E depicts a top view of a portion of an illustrative data storage array according to a second embodiment. As shown in FIG. 4E, The data storage array 400 may include system control modules 455 arranged between the CLMs 410a-410f and the AAMs 420a, 420b. The system control modules 455a and 455b may be configured to control certain operational aspects of the data storage array 400, including, but not limited to, storing system images, system configuration, system monitoring, Joint Test Action Group (JTAG) (for example, IEEE 1149.1 Standard Test Access Port and Boundary-Scan Architecture) processes, power subsystem monitoring, cooling system monitoring, and other monitoring known to those having ordinary skill in the art.

FIG. 4F depicts a top view of a portion of an illustrative data storage array according to a third embodiment. As shown in FIG. 4F, the top view 473 of the data storage array 400 may include a status display 471 configured to provide various status display elements, such as lights (for example, light emitting diode (LED) lights), text elements, or the like. The status display elements may be configured to provide information about the operation of the system, such as whether there is a system failure, for example, through an LED that will light up in a certain color if a persistent storage elements 415a-415j fails. The top view 473 may also include communication ports 450a, 450b or portions thereof. For example, communication ports 450a, 450b may include portions (for example, “overhangs”) of an HBA.

FIG. 4G depicts a top view of a portion of an illustrative data storage array according to a fourth embodiment. As shown in FIG. 4G, the data storage array 400 may include a plurality of persistent storage elements 415a-415j and PDHUs 449a-449e (visible in FIG. 4G, for example, because the fans 425a-425h are not being shown). For example, fans 425a-425h may be located behind the persistent storage elements 415a-415j and the PDHUs 449a-449e in the view depicted in FIG. 4G. The persistent storage elements 415a-415j and PDHUs 449a-449e may be arranged behind a faceplate (not shown) and may be surrounded by sheet metal 451a-451d.

The data storage arrays 400 depicted in FIGS. 4A-4G may provide data storage that does not have a single point of failure for data loss and includes components that may be upgraded “live,” such as persistent and cache storage capacity, system control modules, communication ports (for example, PCIe, NICs/HBAs), and power components.

According to some embodiments, power may be isolated into completely separate midplanes. In a first midplane configuration, the connections of the “cable-aisle side” cards to the power may be via a “bottom persistent storage element midplane.” In a second midplane configuration, the persistent storage elements 415a-415j on the top row may receive power from a “top power midplane,” which is distinct from the “signal midplane” which connects cards on the cable-isle side. In a third midplane configuration, the persistent storage elements 415a-415j on the bottom row may receive power from a “bottom power midplane.” According to some embodiments, the power midplanes may be formed from a single, continuous board. In some other embodiments, the power midplanes may be formed from separate boards, for example, which connect each persistent storage element 415a-415j at the front and the “cable-aisle side” cards at the back (for instance, CLMs, AAMs, system controller cards, or the like). The use of separate power midplanes may allow modules on the media-aisle side (for example, the persistent storage elements 415a-415j) to have high speed signals on one corner edge and power on another corner edge, may allow for an increased number of physical midplanes for carrying signals, may provide the ability to completely isolate the boards with the highest density of high speed connections from boards carrying high power, may allow the boards carrying high power to be formed from a different board material, thicknesses, or other characteristic as compared to cards carrying high speed signals.

FIG. 4H depicts an illustrative system control module according to some embodiments. The system control module 455 may include a processor 485 and memory elements 475a-475d. The processor 485 may include processors known to those having ordinary skill in the art, such as an Intel® IA-64 architecture processor. According to embodiments, each of memory elements 475a-475d may be configured as a data channel, for example, memory elements may be configured as data channels A-D, respectively. The system control module 455 may include its own power circuitry 480 to power various components thereof. Ethernet communication elements 490a and 490b, alone or in combination with an Ethernet switch 495, may be used by the processor 485 to communicate to various external devices and/or modules through communication connections 497a-497c. The external devices and/or modules may include, without limitation, AAMs, LMs, CMs, CLMs, and/or external computing devices.

FIGS. 5A and 5B depict an illustrative persistent storage element according to a first embodiment and second embodiment, respectively. A persistent storage element 505 (for example, a PSM) may be used to store data that cannot be stored in the cache storage (for example, because there is not enough storage space in the memory elements of a CLM) and/or is being redundantly stored in persistent storage in addition to the cache storage. According to some embodiments, the persistent storage element 505 may be configured as a FRU “storage clip” or PSM that includes various memory elements 520, 530a-530f. For example, memory element 520 may include a DIMM memory element configured to store, among other things, data management tables. The actual data may be stored in flash memory, such as in a set of flash cards 530a-530f (see FIGS. 5D-5F for illustrated flash cards according to some embodiments) arranged within complementary slots 525a-525f, such as PCIe sockets. In an embodiment, the persistent storage element 505 may be configured to include forty (40) flash cards 530a-530f.

In an embodiment, each persistent storage element 505 may include about six (6) flash cards 530a-530f. In an embodiment, data may be stored in a persistent storage element 505 using a parity method, such as dual parity RAID (P/Q 9+2), erasure code parity (9+3), or the like. This type of parity may enable the system to tolerate multiple hard failures of persistent storage.

A processor 540 may be included to execute certain functions for the persistent storage element 505, such as basic table management functions. In an embodiment, the processor 540 may include a system-on-a-chip (SoC) integrated circuit. An illustrative SoC is the Armada™ XP SoC manufactured by Marvell, another is Intel® E5-2600 series server processor. A communication switch 550 may also be included to facilitate communication for the persistent storage element 505. In an embodiment, the communication switch 550 may include a PCIe switch, (for example, such as a thirty-two (32) lane PCIe Gen 3 switch). The communication switch 550 may use a four (4) lane PCIe connection for communication to each clip holding one of the flash cards 530a-530f and the processor 540.

The persistent storage element 505 may include a connector 555 configured to operatively couple the persistent storage element 505 within the data storage array. Ultracapacitors and/or batteries 575a-575b may be included to facilitate power management functions for the persistent storage element 505. According to some embodiments, the ultracapacitors 575a-575b may provide power sufficient to enable the de-staging of “dirty” data from volatile memory, for example, in the case of a power failure.

According to some embodiments using flash (for example, flash cards 530a-530f), various states may be required to maintain tables to denote which pages are valid for garbage collection. These functions may be handled via the processor 540 and/or SoC thereof, for instance, through dedicated DRAM on a standard commodity DIMM. Persistence for the data stored on the DIMM may be ensured by the placement of ultracapacitors and/or batteries 575a-575b on the persistent storage element 505. In an embodiment using a persistent memory elements on the persistent storage element 505, the ultracapacitors and/or batteries 575a-575b may not be required for memory persistence. Illustrative persistent memory may include magnetoresistive random-access memory (MRAM) and/or parameter random access memory (PRAM). According to some embodiments, the use of ultracapacitors and/or batteries 575a-575b and/or persistent memory elements may allow the persistent storage element 505 to be serviced, for example, without damage to the flash medium of the flash cards 530a-530f.

FIG. 5C depicts an illustrative persistent storage element according to a third embodiment. A processor 540 may utilize a plurality of communication switches 5501-d both for connection to both storage cards 530 as well as connections with other cards, such as through unidirectional connectors 555 (transmit) and 556 (receive). According to some embodiments, certain switches, such as switch 550a, may only connect to storage devices, whereas other switches, such as switch 550c, may connect only to the connector 555. Rotational media 585a-d may be directly supported in such a system, by way of a device controller 580b which may either be connected directly 580a to the processor 540, and, as an example may be a function of the processor's chipset or connected indirectly via a communication switch 550d.

FIG. 6A depicts an illustrative flash card according to a first embodiment. As shown in FIG. 6A, the flash card 630 may include a plurality of flash chips or dies 660a-660g configured to have one or more different memory capacities, such as 8K×14 words of program memory. In an embodiment, the flash card 630 may be configured as a “clear not-and (NAND)” technology (for example, triple-level cell (TLC), 3b/c, and the like) having an error correction code (ECC) engine. For example, the flash card 630 may include an integrated circuit 690 configured to handle certain flash card functions, such as ECC functions. According to some embodiments, the flash cards 630 may be arranged as expander devices of the persistent storage element essentially connecting a number of ECC engines to a PCIe bus interface (for example, through communication switch 650 in FIGS. 6A-6C) to process certain commands within the data storage array. Non-restrictive examples of such commands include IO requests and garbage collection commands from the persistent storage element 605. In an embodiment, the flash card 630 may be configured to provide data, for example, to a CLM, in about four (4) kilobyte entries.

According to some embodiments, flash cards 630 may be used as parallel “managed-NAND” drives. In such embodiments, each interface may function independently at least in part. For example, a flash card 630 may perform various bad block detection and management functions, such as migrating data from a “bad” block to a “good” block to offload external system requirements, provide external signaling so that higher level components are aware of delays resulting from the bad block detection and management functions. In another example flash cards may perform block-level logical to physical remapping and block-level wear-leveling. According to some embodiments, to support block-level wear-leveling, each physical block in each flash card may retain a count value that is maintained on the flash card 630 that equals the number of writes to a physical block. According to some embodiments, the flash card may perform read processes, manage write processes to the flash chips 660a-660g, ECC protection on the flash chips (for example, provide data on bits of error seen during a read event), read disturb count monitoring, or any combination thereof.

If any data, such as table and/or management data, is kept external to the flash card 630, the integrated circuit 690 may be configured as an aggregator integrated circuit (“aggregator”). In an embodiment, the error correction logic for the flash card 630 may reside either in the aggregator, on the flash packages, elsewhere on the boards (for example, a PSM board, persistent storage element 505, or the like), or some combination thereof.

Flash memory may have blocks of content which fail in advance of a chip or package failure. A remapping of the physical blocks to those addressed logically may be performed at multiple potential levels. Embodiments provide various remapping techniques. A first remapping technique may occur outside of the persistent storage subsystem, for example, by the CLMs. Embodiments also provide for remapping techniques that occur within the persistent storage subsystem. For example, remapping may occur at the level of the persistent storage element 505, such as through communication that may occur between the processor 540 (and/or a SoC thereof) and the flash cards 530a-530f. In another example, remapping may occur within the flash cards 530a-530f, such as through the flash cards presenting a smaller number of addressable blocks to the aggregator. In a further example, the flash cards 530a-530f may present themselves as a block device that abstracts bad blocks and the mapping to them from the external system (such as to a persistent storage element 505, a CLM, or the like). According to some embodiments, the aggregator 690 may maintain a own block mapping addressed external thereto, such as through the persistent storage element 505 a CLM. The remapping of data may allow the persistent storage element 505 to only be required to maintain its own pointers for the memory and also allow the memory to be usable by the data storage array system without also requiring the maintenance of additional address space used for both abstracting “bad blocks” and performing wear-leveling of the underlying media.

According to some embodiments, the flash card 630 may maintain a bit for each logical page to denote whether the data is valid or if it has been overwritten or freed in its entirety by the data management system. For example, a page which is partially overwritten in the cache should not be freed at this level as it may have some valid data remaining in the persistent storage. The persistent storage element 505 may be configured to operate largely autonomously from the data management system to determine when and how to perform garbage collection tasks. Garbage collection may be performed in advance. According to some embodiments, sufficient spare blocks may be maintained such that garbage collection is not required during a power-failure event.

The processor 540 may be configured to execute software for monitoring the blocks to select blocks for collecting remaining valid pages and to determine write locations. Transfers may either be maintained within a flash card 530a-530f or across cards on a common persistent storage element 505. Accordingly, the distributed PCIe network that provides access between the persistent storage element 505 and the CLMs may not be required to directly connect clips to one another.

In an embodiment, when a persistent storage element 505 moves a page, the persistent storage element 505 may complete the copy of the page before informing the CLM holding the logical address-to-physical address map, and directly or indirectly its mirror, of the data movement. If during the data movement the originating page is freed, both pages may be marked as invalid (for instance, because the data may be separately provided by the CLM). Data being read from a persistent storage element 505 to the CLM cache may be provided in data and parity, the parity generation may be done either local to the persistent storage element 505, for instance, in the processor 540, or some combination thereof.

FIGS. 6B and 6C depict illustrative flash cards according to a second and third embodiment, respectively. For instance, FIG. 6C depicts a flash card 630 that includes external connection elements 695a, 695b configured to connect the flash card to one or more external devices, including external storage devices. According to some embodiments, the flash card 630 may include about eight (8) to about sixteen (16) flash chips 660a-660f.

According to some the data management system may be configured to map data between a performance and one or more lower tiers of storage (for example, lower-cost, lower-performance, or the like, or any combination thereof). As such, the individual storage modules and/or components thereof may be of different capacities, have different access latencies, use different underlying media, and/or any other property and/or element that may affect the performance and/or cost of the storage module and/or component. According to some embodiments, different media types may be used in the data management system and pages, blocks, data or the like may be designated as only being stored in memory with certain attributes. In such embodiments, the page, block, data or the like may have the storage requirements/attributes designated, for instance, throughs meta-data that would be accessible by the persistent storage element 505 and/or flash card 630. For example, as shown in FIG. 6C, at least one of the external connection elements 695a, 695b may include a serial attached SCSI (SAS) and/or SATA connection element. In this manner, the data storage array may de-stage data, particularly infrequently used data, from the flash cards 630 to a lower tier of storage. The de-staging of data may be supported by the persistent storage element 505 and/or one or more CLMs.

FIG. 7A depicts connections between AAMs and CLMs according to an embodiment. As shown in FIG. 7A, a data storage array 700 may include CLMs 710a-710f operatively coupled with AAMs 715a-715d. According to some embodiments, each of the AAMs 715a-715d may be connected to each other and to each of the CLMs 710a-710f. The AAMs 715a-715d may include various components as described herein, such as processors 740a, 740b, communication switches 735a-735e (for example, PCIe switches), and communication ports 1130a, 1130b (for example, NICs/HBAs). Each of the CLMs 710a-710f may include various components as described herein, for instance, processors 725a, 725b and communication switches 720a-720e (for example, PCIe switches). The AAMs 715a-715d and the CLMs 710a-710f may be connected through the communication buses arranged within a midplane 705 (for example, a passive midplane) of the data storage array 700.

The communication switches 720a-720e, 735a-735e may be connected to the processors 725a, 725b, 740a, 740b (for instance, through processor sockets) using various communication paths. In an embodiment, the communication paths may include eight (8) and/or sixteen lane (16) wide PCIe connections. For example, communication switches 720a-720e, 735a-735e connected to multiple (for instance, two (2)) processor sockets on a card may use eight (8) lane wide PCIe connections and communication switches connected to one processor socket on a card may use a sixteen lane (16) wide PCIe connection.

According to some embodiments, the interconnection on both the AAMs 715a-715d and the CLMs 710a-710f may include QPI connections between the processor sockets, sixteen (16) lane PCIe between each processor socket and the PCIe switch connected to that socket, and eight (8) lane PCIe between both processor sockets and the PCIe switch which is connected to both sockets. The use of multi-socket processing blades on the AAMs 715a-715d and CLMs 710a-710f may operate to provide higher throughput and larger memory configurations. The configuration depicted in FIG. 7A provides a high bandwidth interconnection with uniform bandwidth for any connection. According to some embodiments, an eight (8) lane PCIe Gen 3 interconnect may be used between each AAM 715a-715d and every CLM 710a-710f, and a four (4) lane PCIe Gen 3 interconnect may be used between each CLM 710a-710f and every persistent storage device. However, embodiments are not limited to these types of connections as these are provided for illustrative purposes only.

In an embodiment, the midplane 705 interconnection of AAMs 715a-715d and CLMs 710a-710f may include at least two (2) different types of communication switches. For example, the communication switches 735a-735e and the communication switches 720a-720e may include single sixteen (16) lane and dual eight (8) lane communication switches. In an embodiment, the connection type used to connect the AAMs 715a-715d to the CLMs 710a-710f alternates such that each switch type on one card is connected to both switch types on the other cards.

In an embodiment, AAMs 715a and 715b may be connected to the CLMs 710a-710f on the “top” socket, while AAMs 715c and 715d may be connected to the CLMs 710a-710f on the “bottom” socket. In this manner, the cache may be logically partitioned such that the addresses whose data is designated to be accessed (for example, through a read/write request in a non-fault process) by certain AAMs 715a-715d may have the data cached in the socket to which is it most directly connected. This may avoid the need for data in the cache region of a CLM 710a-710f to transverse the QPI link between the processor sockets. Such a configuration may operate, among other things, to alleviate congestion between the sockets during non-fault operations (for example, when all AAMs 715a-715d are operable) via a simple topology in a passive midplane without loss of accessibility in the event of a fault.

As shown in FIG. 7A, certain of the connections between the CLMs 710a-710f, the AAMs 715a-715d and/or components thereof may include NT port connections 770. Although FIG. 7A depicts multiple NT port connections 770, only one is labeled to simplify the diagram. According to some embodiments, the NT port connections 770 may allow any PCIe socket in each AAM 715a-715d to connect directly to any a certain number of the total available CLMs 710a-710f (for example, four (4) of the six (6) CLMs shown in FIG. 7A) via PCIe and any PCIe socket in each CLM to connect directly to any a certain number of the total available AAMs (for example, three (3) of the four (4) AAMs shown in FIG. 7A). A direct connection may include a connection not requiring a processor-to-processor communication channel (for example, a QPI communication channel) hop on the AAM 715a-715d and/or CLM 710a-710f card. In this manner, the offloading of data transfers off of the processor-to-processor communication channel may significantly improve system data throughput.

FIG. 7B depicts an illustrative CLM according to an embodiment. The CLM 710 shown in FIG. 7B represents a detailed depiction of a CLM 710a-710f of FIG. 7A. The CLM 710 may include communication buses 745a-745d configured to operatively couple the CLMs to persistent storage devices (not shown, see FIG. 7E). For example, communication buses 745a and 745c may connect the CLM 710 to three (3) persistent storage devices, while communication buses 745b and 745d may connect the CLM 710 to seven (7) persistent storage devices.

FIG. 7C depicts an illustrative AAM according to an embodiment. The AAM 715 depicted in FIG. 7C may include one or more processors 740a, 740b in communication with a communication element 780 for facilitating communication between the AAM and one or more CLMs 710a-710f. According to some embodiments, the communication element 780 may include a PCIe communication element. In an embodiment, the communication element may include a PCIe fabric element, for example, having ninety-seven (97) lanes and eleven (11) communication ports. In an embodiment, the communication switches 735a, 735b may include thirty-two (32) lane PCIe switches. The communication switches 735a, 735b may use sixteen (16) lanes for processor communication. A processor-to-processor communication channel 785 may be arranged between the processors 740a, 740b, such as a QPI communication channel. The communication element 780 may use one sixteen (16) lane PCIe channel for each processor 740a, 740b and/or dual eight (8) lane PCIE channels for communication with the processors. In addition, the communication element 780 may use one eight (8) lane PCIe channel for communication with each CLM 710a-710f. In an embodiment, one of the sixteen (16) lane PCIe channels may be used for configuration and/or handling PCIe errors among shared components. For instance, socket “0,” the lowest socket for the AAM 715 may be used for configuration and/or handling PCIe errors.

FIG. 7D depicts an illustrative CLM according to an embodiment. As shown in FIG. 7C, a CLM 710 may include one or more processors 725a, 725b in communication with one or more communication elements 790. According to some embodiments, the communication elements 790 may include PCIe fabric communication elements. For instance, communication element 790a may include a thirty-three (33) lane PCIe fabric having five (5) communication ports. In another instance, communication elements 790b, 790c may include an eighty-one (81) lane PCIe fabric having five (14) communication ports. The communication element 790a may use eight (8) lane PCIe channels for communication to connected AAMs 715b, 715c and to the processors 725a, 725b. The communication elements 790b, 790c may use four (4) lane PCIe channels for communication to connected PSMs 750a-750t, sixteen (16) lane PCIe channels for communication to each processor 725a, 725b and eight (8) lane PCIe channels for communication to each connected AAM 715a, 715d.

FIG. 7E depicts illustrative connections between a CLM and a plurality of persistent storage devices. As shown in FIG. 7E, a CLM 710 may be connected to a plurality of persistent storage devices 750a-750t. According to some embodiments, each persistent storage device 750a-750t may include a four (4) lane PCIe port to each CLM (for example, CLMs 710a-710f depicted in FIG. 7A). In an embodiment a virtual local area network (VLAN) may be rooted at each CLM 710 that does not use any AAM-to-AAM links, for example, to avoid loops in the Ethernet fabric. In this embodiment, each persistent storage device 750a-750t sees three (3) VLANs, one per CLM 710 that it is connected to.

FIG. 7F depicts illustrative connections between CLMs, AAMs and persistant storage (for example, PSMs) according to an embodiment. As shown in FIG. 7F, AAMs 715a-715n may include various communication ports 716a-716n, such as an HBA communication port. Each AAM 715a-715n may be operatively coupled with each CLM 710a-710f. The CLMs 710a-710f may include various communication elements 702a-702f for communicating with persistent storage 750. Accordingly, the CLMs 710a-710f may be connected directly to the persistent storage 750 (and components thereof, such as PSMs). For example, the communication elements 702a-702f may include PCIe switches, such as forty-eight (48) lane Gen3 switches. The data storage array may include system control modules 704a-704b, which may be in the form of cards, boards, or the like. The system control modules 704a-704b may include a communication element 708a-708b for communicating to the CLMs 710a-710f and a communication element 706a-706b for communicating directly to the communication elements 702a-702f of the CLMs. The communication elements 708a-708b may include an Ethernet switch and the communication element 706a-706b may include a PCIe switch. The system control modules 704a-704b may be in communication with an external communication element 714a-714b, such as an Ethernet connection, for instance, that is isolated from internal Ethernet communication. As shown in FIG. 7F, the external communication element 714a-714b may be in communication with a control plane 712a-712b.

FIG. 7G depicts illustrative connections between CLMs and persistent storage (for instance, PSMs) according to an embodiment. As shown in FIG. 7, CLMs 715a-715n may include multiple communication elements 702a-702n for communicating to PSMs 750a-750n. In an embodiment, the CLMs 715a-715n may be connected to the PSMs 750a-750n through a midplane connector 722a-722n. Although each CLM 715a-715n may be connected to each PSMs 750a-750n, only connections for CLM 715a is depicted to simplify FIG. 7G as all CLMs may be similarly connected to each PSM. As shown in FIG. 7G, each CLM 715a-715n may have a first communication element 702a that connects the CLM to a first set of PSMs 750a-750n (for example, the bottom row of PSMs) and a second communication element 702b that connects the CLMs to a second set of PSMs (for example, the top row of PSMs). In this manner, board routing may be simplified on the CLM 715a-715n.

In an embodiment, the communication elements 702a-702n may include PCIe communication switches (for instance, forty-eight (48) lane Gen3 switches). The PSMs 750a-750n may include the same power-of-two (2) number of PCIe lanes between it and each of the CLMs 715a-715n. In an embodiment, the communication elements 702a-702n may use different communication midplanes. According to some embodiments, all or substantially all CLMs 715a-715n may be connected to all or substantially all PSMs 750a-750n.

According to some embodiments, if the Ethernet (control plane) connections from the PSMs 750a-750n are distributed on the CLMs 715a-715n, each CLM may be configured to have the same number or substantially the same number of connections such that traffic may be balanced. In a non-limiting example involving six (6) CLMs and balanced connections on a top and bottom midplane, four connections may be established from the CLM board to each midplane. In another non-limiting example, wiring may be configured such that the outer-most CLMs 715a-715n (for instance, the outermost two CLMs) have a certain number of connections (for instance, about six connections) whereas the inner-most CLMs (for instance, inner-most four CLMSs) have another certain number of connections (for instance, about seven connections).

In an embodiment, each PSM 750a-750n on a connector 722a-722n may have Ethernet connectivity to one or more CLMs 715a-715n, such as to two (2) CLMs. The CLMs 715a-715n may include an Ethernet switch for control plane communication (for example, communication elements 708a-708b of FIG. 7F).

As shown through FIGS. 7A-7G, the AAMs 715a-715d may be connected to the CLMs 710a-710f and indirectly, through the CLMs, to the persistent storage devices 750a-750t. In an embodiment, PCIe may be used for data plane traffic. In an embodiment, Ethernet may be used for control plane traffic.

According to some embodiments, the AAMs 715a-715d may communicate directly with the CLMs 710a-710f. In an embodiment, the CLMs 710-710f may be configured as effectively RAID-protected RAM. Single parity for cache access may be handled in software on the AAM. The system control modules 704a-704b may be configured to separate system control from data plane, which may be merged into the AAMs 715a-715d. In an embodiment, the persistent storage 750 components (for example, PSMs 750a-750t) may have Ethernet ports connected to the system control modules 704a-704b and/or a pair of CLMs 710-710f. The persistent storage 750 components may be connected the system control modules 704a-704b through communication connections on the system control modules. The persistent storage 750 components may be connected the system control modules 704a-704b through the CLMs 710-710f. For example, each persistent storage 750 components may connect to two CLMs 710-710f, which may include Ethernet switches that connect both to the local CLM 710-710f and both of the system control modules 704a-704b.

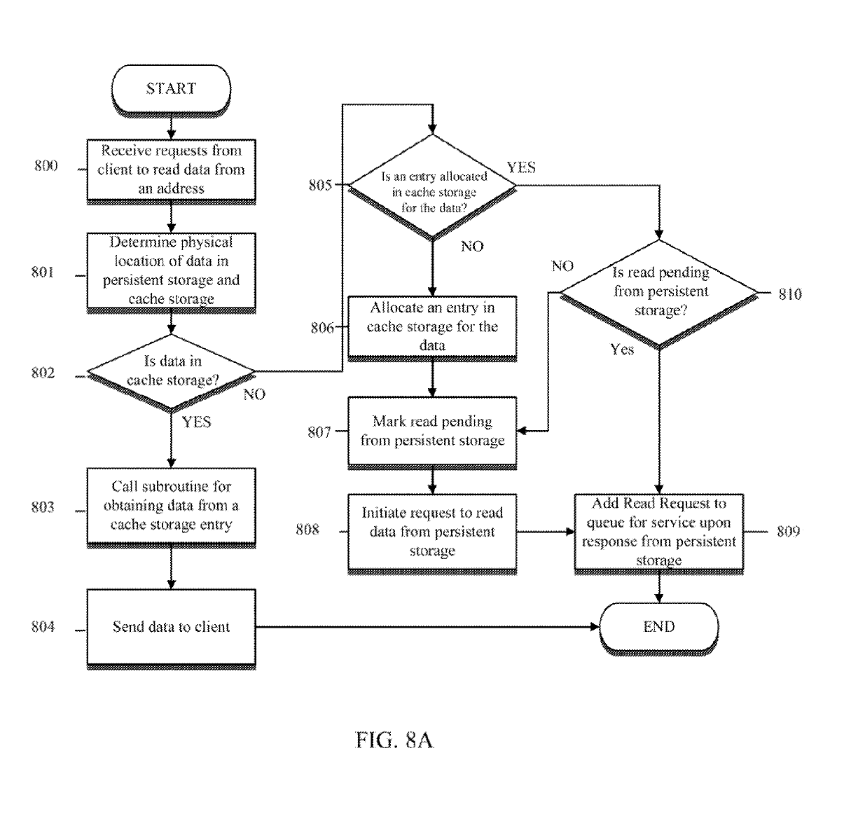

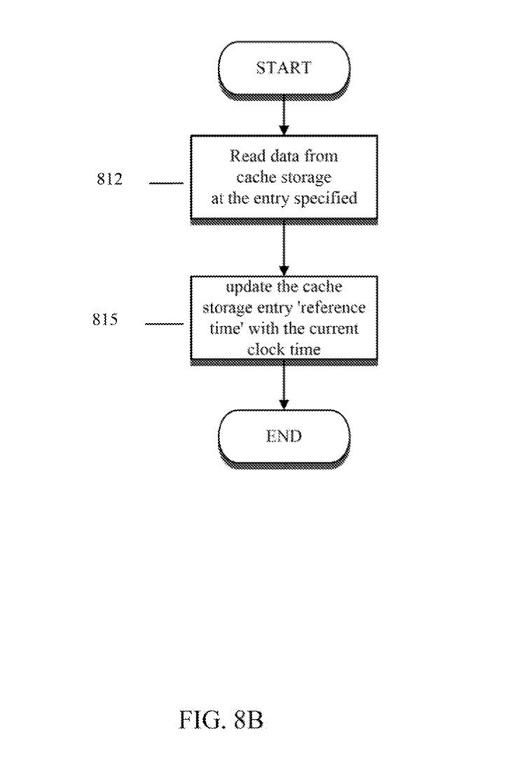

FIG. 8 depicts an illustrative system stack according to an embodiment. The data storage array 865 includes an array access core 845 and at least one data storage core 850a-850n, as described herein. The data storage array 865 may interact with a host interface stack 870 configured to provide an interface between the data storage array and external client computing devices. The host interface stack 870 may include applications, such as an object store and/or key-value store (for example, hypertext transfer protocol (HTTP)) applications 805, a map-reduce application (for example, Hadoop™ MapReduce by Apache™), or the like. Optimization and virtualization applications may include file system applications 825a-825n. Illustrative file system applications may include a POSIX file system and a Hadoop™ distributed file system (HDFS) by Apache™.

The host interface stack 870 may include various communication drivers 835a-835n configured to facilitate communication between the data storage array (for example, through the AAM 845), such as drivers for NICs, HBAs, and other communication components. Physical servers 835a-835n may be arranged to process and/or route client IO within the host interface stack 870. The client IO may be transmitted to the data storage array 860 through a physical network device 840, such as a network switch. Illustrative and non-restrictive examples of network switches include TOR, converged network adapter (CNA), FCoE, InfiniBand, or the like.

The data storage array may be configured to perform various operations on data, such as respond to client read, write and/or compare and swap (CAS) IO requests. FIGS. 8A and 8B depict flow diagrams for an illustrative method of performing a read IO request according to a first embodiment. As shown in FIG. 8A, the data storage array may receive 800 requests from a client to read data from an address. The physical location of the data may be determined 801, for example, in cache storage or persistent storage. If the data is in the cache storage 802, a process may be called 803 for obtaining the data from a cache storage entry and the data may be sent 804 to the client as presented by an AAM.

If the data is not in the cache storage 802, it is determined 805 whether there is an entry allocated in cache storage for the data. If it is determined 805 that there is not an entry, an entry in cache storage is allocated 806. Read pending may be marked 807 from persistent storage and a request to read data from persistent storage may be initiated 808.

If it is determined 805 that there is an entry, it is determined 810 whether a read pending request from persistent storage is active. If it is determined 810 that a read pending request from persistent storage is active, a read request is added 809 to the queue for service upon response from persistent storage. If it is determined 810 that a read pending request from persistent storage is not active, read pending may be marked 807 from persistent storage, a request to read data from persistent storage may be initiated 808 and a read request is added 809 to the queue for service upon response from persistent storage.

FIG. 8B depicts a flow diagram of an illustrative method for obtaining data from a cache storage entry. As shown in FIG. 8B, data may be 815 read 812 from cache storage at the specified entry and the cache storage entry “reference time” may be updated 815 with the current system clock time.

FIG. 9A depicts a flow diagram for an illustrative method of writing data to the data storage array from a client according to an embodiment. As shown in FIG. 9A, the data storage array may receive 900 write requests from a client to write data to an address. The physical location of the data may be determined 901 in persistent storage and/or cache storage. It may be determined 902 whether an entry is allocated in cache storage for the data. If it is determined 902 that there is not an entry, an entry may be allocated 903 in cache storage for the data. A process may be called 904 for storing data to a cache storage entry and a send write acknowledgement may be sent 905 to the client. If it is determined 902 that there is an entry, it may be determined 906 whether the data is in cache storage. If it is determined 906 that the data is in cache storage, a process may be called 904 for storing data to a cache storage entry and a send write acknowledgement may be sent 905 to the client.

If it is determined 906 that the data is not in cache storage, a process may be called 907 for storing data to a cache storage entry and a write acknowledgement may be sent 908 to the client. It may be determined 909 whether persistent storage is valid. If persistent storage is determined 909 to be valid, it may be determined 910 whether all components in cache storage entry are valid. If it is determined 910 that all components in cache storage are valid, then a data entry may be marked 911 in persistent storage as being outdated and/or invalid.

FIG. 9B depicts a flow diagram for an illustrative method of storing data to a cache storage entry. As shown in FIG. 9B, components of the data storage array may specify 912 the writing of data to cache storage at a specified entry. The contents written to the cache storage entry may be marked 913 as valid. It may be determined 914 whether the cache storage entry is marked as dirty. If the cache storage entry is determined 914 to be marked as dirty, the cache storage entry “reference time” is updated 915 with the current system time. If the cache storage entry is determined 914 to not be marked as dirty, the cache storage entry is marked 916 as dirty and the number of cache entries marked as dirty may be increased 917 by one (1).

FIG. 9C depicts a flow diagram for an illustrative method of writing data from a client supporting compare and swap (CAS). As shown in FIG. 9C, the data storage array may receive 900 write requests from a client to write data to an address. The physical location of the data may be determined 901 in persistent storage and/or cache storage. It may be determined 902 whether an entry is allocated in cache storage for the data. If it is determined 902 that there is not an entry, an entry may be allocated 903 in cache storage for the data. A process may be called 904 for storing data to a cache storage entry and a send write acknowledgement may be sent 905 to the client. If it is determined 902 that there is an entry, it may be determined 906 whether the data is in cache storage. If it is determined 906 that the data is in cache storage, a process may be called 904 for storing data to a cache storage entry and a send write acknowledgement may be sent 905 to the client.

If it is determined 906 that the data is not in cache storage, it may be determined 918 whether CAS requests are required to be processed in order with writes to common address. If it is determined 918 that CAS requests are not required to be processed in order with writes to common address, a process may be called 907 for storing data to a cache storage entry and a write acknowledgement may be sent 908 to the client. It may be determined 909 whether persistent storage is valid. If persistent storage is determined 909 to be valid, it may be determined 910 whether all components in cache storage entry are valid. If it is determined 910 that all components in cache storage are valid, then a data entry may be marked 911 in persistent storage as being outdated and/or invalid.

If it is determined 918 that CAS requests are not required to be processed in order with writes to common address, it may be determined 919 whether a CAS request is pending for components of the cache line requested to be written. If it is determined 919 that a CAS request is pending for components of the cache line requested to be written, a write request may be added 1020 to queue for service upon response from persistent storage.

If it is determined 919 that a CAS request is not pending for components of the cache line requested to be written, a process may be called 907 for storing data to a cache storage entry and a write acknowledgement may be sent 908 to the client. It may be determined 909 whether persistent storage is valid. If persistent storage is determined 909 to be valid, it may be determined 910 whether all components in cache storage entry are valid. If it is determined 910 that all components in cache storage are valid, then a data entry may be marked 911 in persistent storage as being outdated and/or invalid.

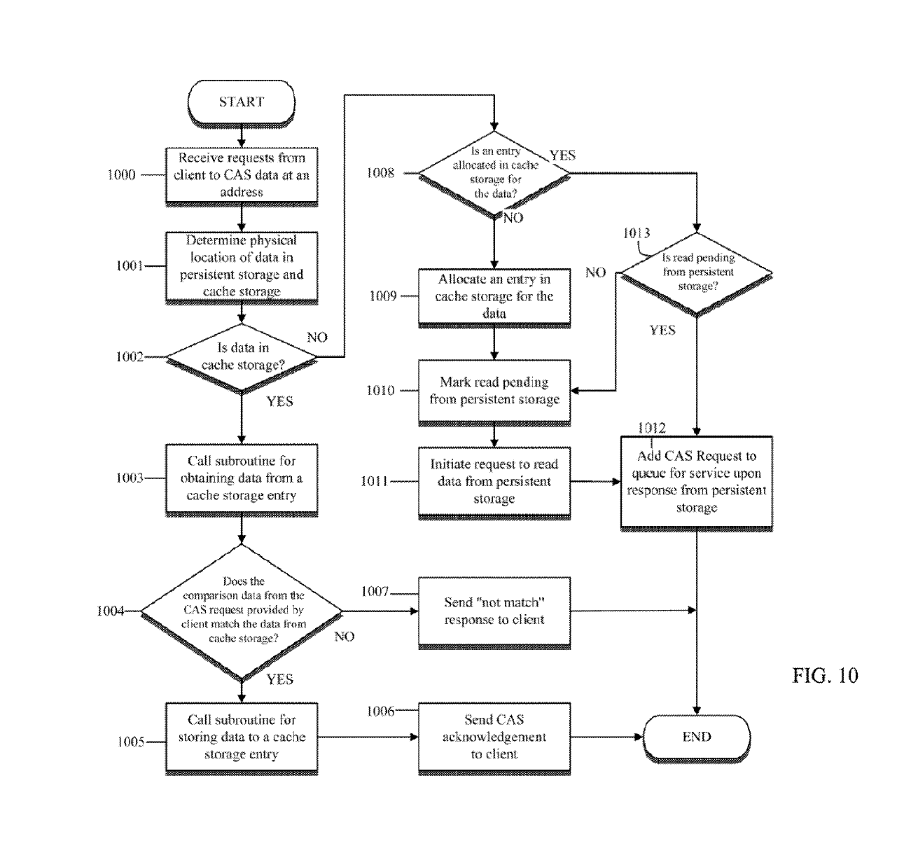

FIG. 10 depicts a flow diagram for an illustrative method for a compare and swap IO request according to an embodiment. As shown in FIG. 10, the data storage array may receive 1000 from a client to CAS data at an address. The physical location of the data may be determined 1001 in persistent storage and/or cache storage. It may be determined 1002 whether an entry is allocated in cache storage for the data. If it is determined 1002 that there is not an entry, a process may be called 1003 for storing data to a cache storage entry.

It may be determined 1004 whether the comparison data from the CAS request matches the data from cache storage. If it is determined 1004 that the comparison data from the CAS request matches the data from cache storage, a process may be called 1005 for storing data to a cache storage entry and CAS acknowledgement may be sent 1106 to the client. If it is determined 1004 that the comparison data from the CAS request does not match the data from cache storage, a “not match” response may be sent 1106 to the client.

If it is determined 1002 that there is an entry, it may be determined 1008 whether an entry is allocated in cache storage for the data. If it is determined 1008 that there is not an entry, an entry in cache storage is allocated 1009. Read pending may be marked 1010 from persistent storage and a request to read data from persistent storage may be initiated 1011.

If it is determined 1008 that there is an entry, it may be determined 1013 whether a read pending request from persistent storage is active. If it is determined 1013 that a read pending request from persistent storage is active, a CAS request is added 809 to the queue for service upon response from persistent storage.

If it is determined 1013 that a read pending request from persistent storage is not active, read pending may be marked 1010 from persistent storage, a request to read data from persistent storage may be initiated 1011 and a CAS request is added 809 to the queue for service upon response from persistent storage.

FIG. 11 depicts a flow diagram for an illustrative method of retrieving data from persistent storage. As shown in FIG. 11, data may be retrieved 1201 from persistent storage and it may be determined 1202 whether the cache storage entry is dirty. If it is determined 1202 that the cache storage entry is dirty, for all components in the cache storage entry not marked as valid, write 1203 the data retrieved from the persistent storage, inside the cache storage entry, mark all components as valid 1204, and mark data entry in persistent storage as outdated/invalid.

If it is determined 1202 that the cache storage entry is not dirty, inside the cache storage entry, mark 1206 all components as valid. If the request queue is determined 1207 to be empty for data retrieved, process longest pending request from queue.

As described above, data may be stored within a data storage array in various configurations and according to certain data protection processes. The cache storage may be RAID protected in an orthogonal manner to the persistent storage in order to, among other things, facilitate the independent serviceability of the cache storage from the persistent storage.

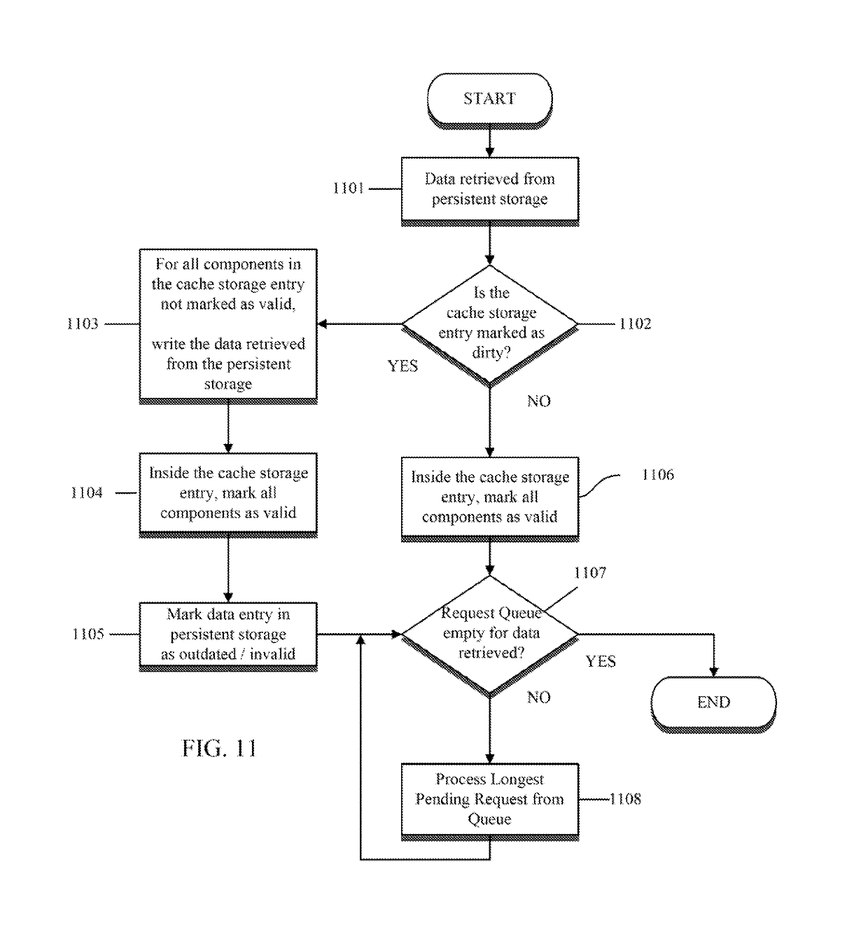

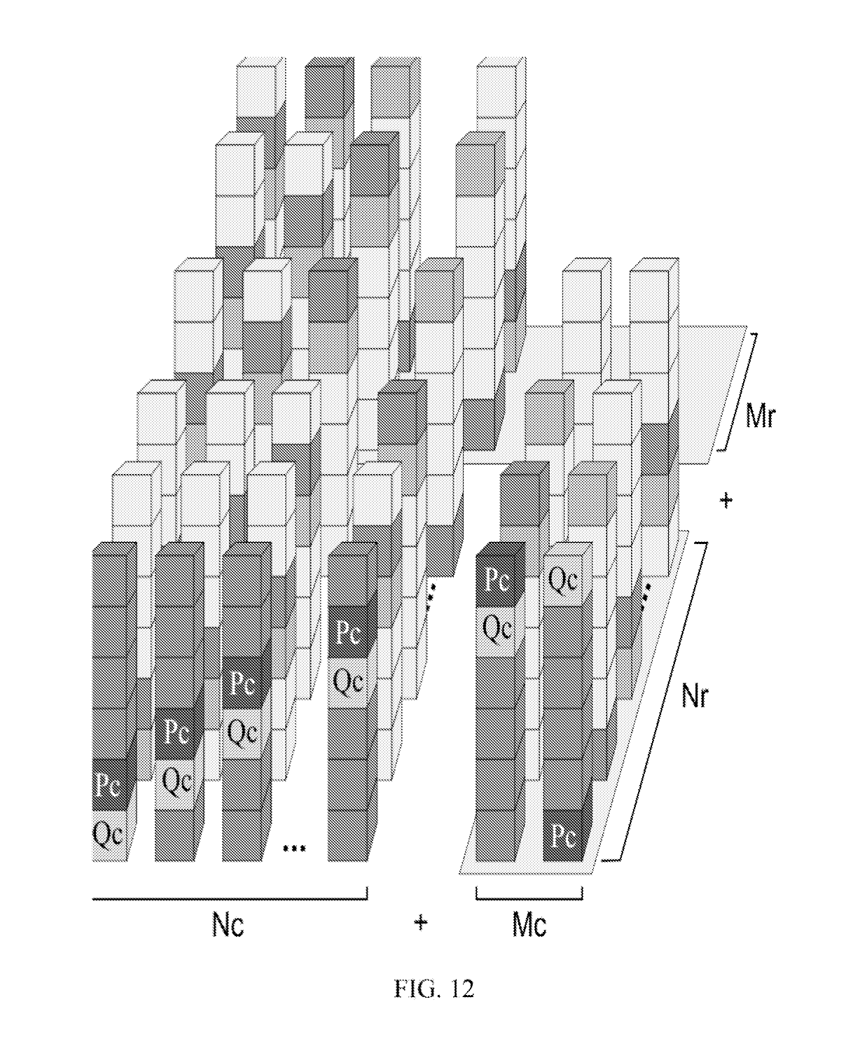

FIG. 12 depicts an illustrative orthogonal raid configuration according to some embodiments. FIG. 12 shows that data may be maintained according to an orthogonal protection scheme across storage layers (for example, cache storage layers and persistent storages). According to some embodiments, cache storage and persistent storage may be implemented across multiple storage devices, elements, assemblies, CLMs, CMs, PSMs, flash storage elements, hard disk drives, or the like. In an embodiment, the storage devices may be configured as part of separate failure domains, for instance, in which data components storing a portion of a data row/column entry in on storage layer do not store any data row/column entry in another storage layer.

According to some embodiments, each storage layer may implement an independent protection scheme. For example, when data is moved from cache storage to persistent storage, a “write to permanent storage” instruction, command, routine, or the like may use only the data modules (for instance, CMs, CLMs, and PSMs), for example, to avoid the need to perform data reconstruction. The data management system may use various types and/or levels of RAID. For instance, parity (if using single parity) or P/Q (using 2 additional units for fault recovery) may be employed. Parity and/or P/Q parity data may be read from cache storage to persistent storage when writing to persistent storage so the data can also be verified for RAID consistency. In an embodiment using erasure codes, if erasure codes that enable greater than two (2) protection fields or if greater than four (4) storage components are employed parity and/or P/Q parity data may also be read from cache storage to persistent storage when writing to persistent storage so the data can also be verified for RAID consistency.

As the data is encoded orthogonally across storage layers, the size of the data storage component in each layer may be different. In an embodiment, the data storage container side of the persistent storage may be at least partially based on the native storage size of the device. For example, in the case of NAND flash memory, 16 kilobyte data storage container per persistent storage element may be used.

According to some embodiments, the size of the cache storage entry may be variable. In an embodiment, larger cache storage entries may be used for cache storage entries. To ensure that additional space is available for holding internal and external meta-data, some embodiments may employ a 9+2 arrangement of data protection across a persistent storage comprised of NAND flash, for instance, employing about 16 kilobyte pages to hold about 128 kilobytes of external data and about 16 kilobytes of total system and external meta-data. In such an instance, cache storage entries may be about 36 kilobytes per entry, which may not include CLM local meta-data that refers to the cache entry.

Each logical cache address across the CLMs may have a specific set of the CLMs which hold the data columns and optional parity and dual parity columns. CLMs may also have data stored in a mirrored or other data protection scheme.

According to some embodiments, writes may be performed from the cache storage in the CLMs to the PSMs in a coordinated operation to send the data to all recipients/PSMs. Each of the persistent storage modules can determine when to write data to each of its components at its own discretion without the coordination of any higher level component (for instance, CLM or AAM). Each CLM may use an equivalent or substantially equivalent amount of data and protection columns as any other data module in the system.

PSMs may employ an equivalent or substantially equivalent amount of data and protection rows and/or columns as any other in the system. Accordingly, some embodiments provide that the computational load throughout the system may be maintained at a relatively constant or substantially constant level during operation of the data management system.

According to some embodiments, a data access may include some or all of the following: (a) the AAM may determine the master(s) and slave(s) LMs; (b) the AAM may obtain the address of the data in the cache storage from the CLM; (d) the data may be accessed by the AAM if available in the cache; (e) if the data is not immediately available in the cache, access to the data may be deferred until the data is located in persistent storage and written to the cache.

According to some embodiments, addresses in the master and slave CLMs may be synchronized. In an embodiment, this synchronization may be performed via the data-path connections between the CLMs as provided by the AAM for which the access is requested. Addresses of data in persistent storage may be maintained in the CLM. Permanent storage addresses may be changed when data is written. Cache storage addresses may be changed when an entry is allocated for a logical address.

The master (and slave copies) of the CLM that hold the data for a particular address may maintain additional data for the cache entries holding data. Such additional data may include, but is not limited to cache entry dirty or modified status and structures indicating which LBAs in the entry are valid. For example, the structures indicating which LBAs in the entry are valid may be a bit vector and/or LBAs may be aggregated into larger entries for purpose of this structure.

The orthogonality of data access control may involve each AAM in the system accessing or being responsible for a certain section of the logical address space. The logical address space may be partitioned into units of a particular granularity, for instance, less than the size of the data elements which correspond to the size of a cache storage entry. In an embodiment, the size of the data elements may be about 128 kilobytes of nominal user data (256 LBAs of about 512 bytes to about 520 bytes each). A mapping function may be employed which takes a certain number of address bits above this section. The section used to select these address bits may be of a lower order of these address bits. Subsequent accesses of size “cache storage entry” may have a different “master” AAM for accessing this address. Clients may be aware of the mapping of which AAM is the master for any address and which AAM may cover in the event the “master” AAM for that address has failed.

According to some embodiments, the coordination of AAMs and master AAMs may be employed by the client using an Multi-Path IO (MPIO) driver. The data management system does not require clients to have an aware MPIO driver. In an embodiment without an MPIO driver, the AAM may identity for any storage request if the request is one where the AAM is the master, in which case the master AAM may process the client request directly. If the AAM is not the master AAM for the requested address, the AAM can send the request through connections internal (or logically internal) to the storage system to that AAM which is the master AAM for the requested address. The master AAM can then perform the data access operation.

According to some embodiments, the result from the request may either be (a) returned directly to the client which had made the request, or (b) returned to the AAM for which the request had been made from the client so the AAM may respond directly to the client. The configuration of which AAM is the master for a given address is only changed when the set of working AAMs changes (for instance, due to faults, new modules being inserted/rebooted, or the like). Accordingly, a number of parallel AAMs may access the same storage pool without conflict needing to be resolved for each data plane operation.

In an embodiment, a certain number of AAMs (for example, four (4)) may be employed, in which all of the number of AAMs may be similarly connected to all CLMs and control processor boards. The MPIO driver may operate to support a consistent mapping of which LBAs are accessed via each AAM in a non-fault scenario. When one AAM has faulted, the remaining AAMs may be used for all data accesses in this example. In an embodiment, the MPIO driver which connects to the storage array system may access the 128 KB (256 sectors) on either AAM, for example, such that AAM0 is used for even and AAM1 is used for odd. Larger stride-sizes may be employed, for example, on power of two (2) boundaries of LBAs.

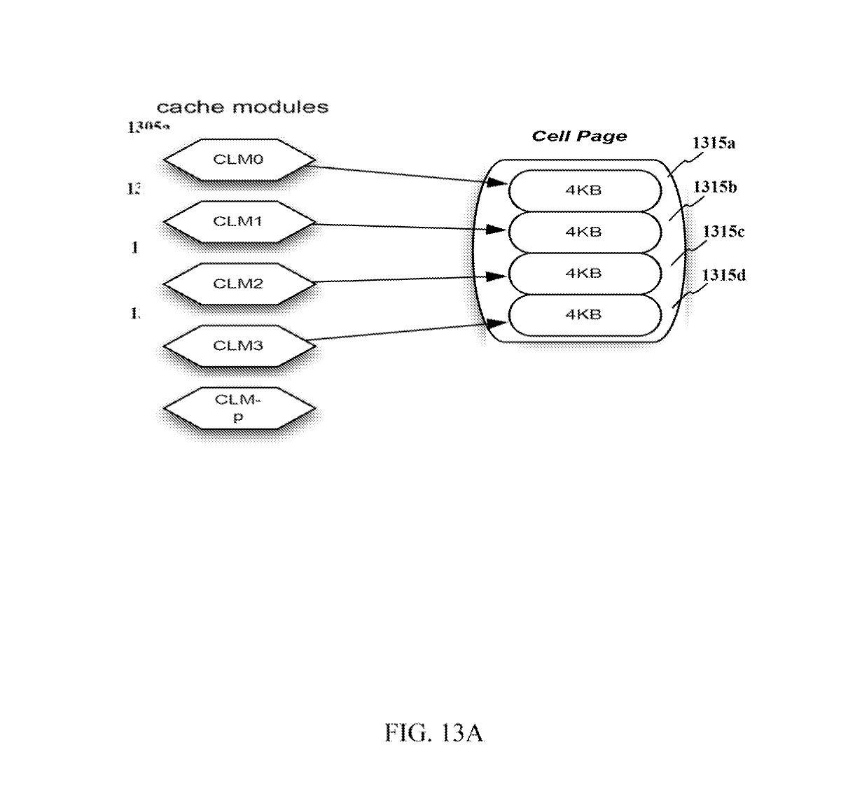

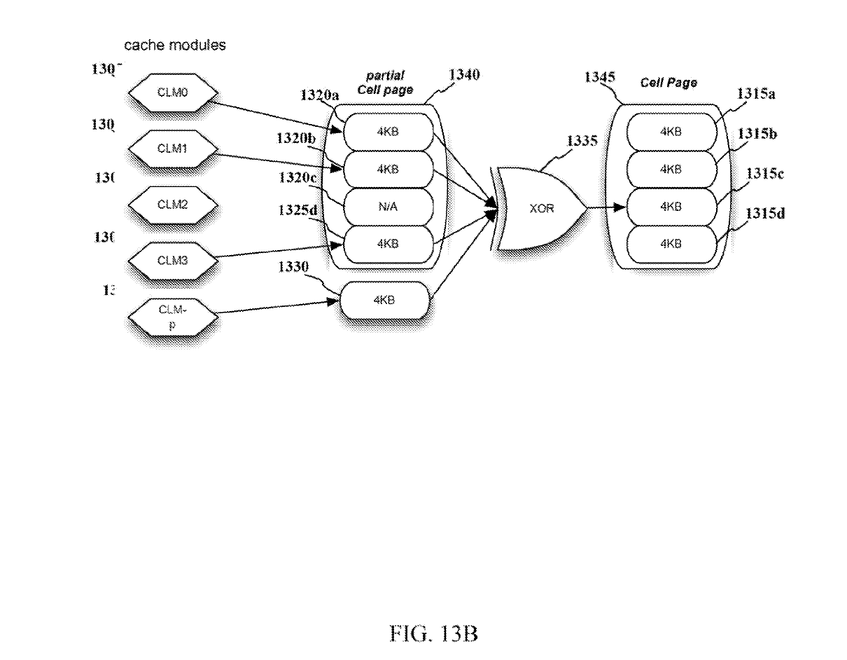

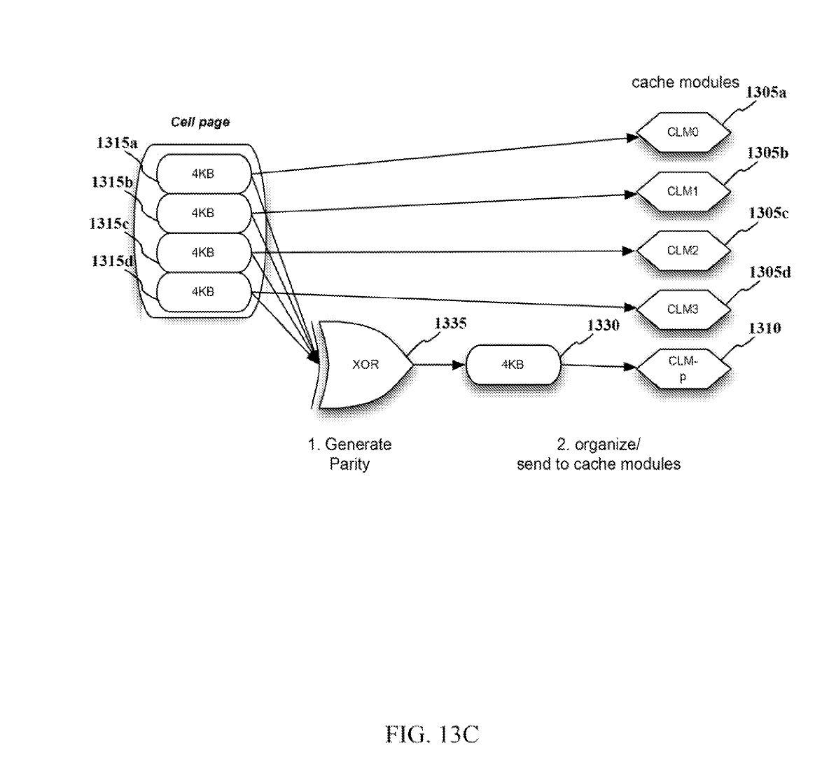

FIG. 13A depicts an illustrative non-fault write in an orthogonal RAID configuration according to an embodiment. As shown in FIG. 13, the CLMs 1305a-1305d may write data to their respective cell pages 1315a-1315d. In a non-fault embodiment, the parity module 1310 may not be employed when writing data to permanent storage.

In the case that a data module has faulted, the parity module 1310 may be employed to reconstruct the data for the cell page. FIG. 13B depicts an illustrative data write using a parity module according to an embodiment. As shown in FIG. 13B, when a data carrying module has faulted, such as one of the partial cells 1320a-1320d (for example, 1320c) in the partial cell page 1340, the parity module 310 carrying the parity is read. The data passes through a logic element 1335, such as an XOR logic gate, and is written into the cell 1315c corresponding to the faulted partial cell (1320c). FIG. 13C depicts an illustrative cell page to cache data write according to an embodiment. As shown in FIG. 13C, parity is generated through the logic element 1335 and is then organized and sent to the cache modules 1315a-1315d.

According to some embodiments, methods for writing to persistent storage may be at least partially configured based on various storage device constraints. For example, flash memory may be arranged in pages having a certain size, such as 16 kilobytes per flash page. As shown in FIG. 13, when four (4) CLMs 1305a-1305d store data, each of the CLMs may be configured to contribute one quarter of the storage to the underlying cell pages 1305a-1305d in the persistent storage.

In an embodiment, data transfer from a CLM to a persistent storage component may be handled through 64 bit processors. As such, an efficient form of interleaving between cell pages is to alternate bit words from each CLM “cell page” which is prepared for writing to permanent storage.

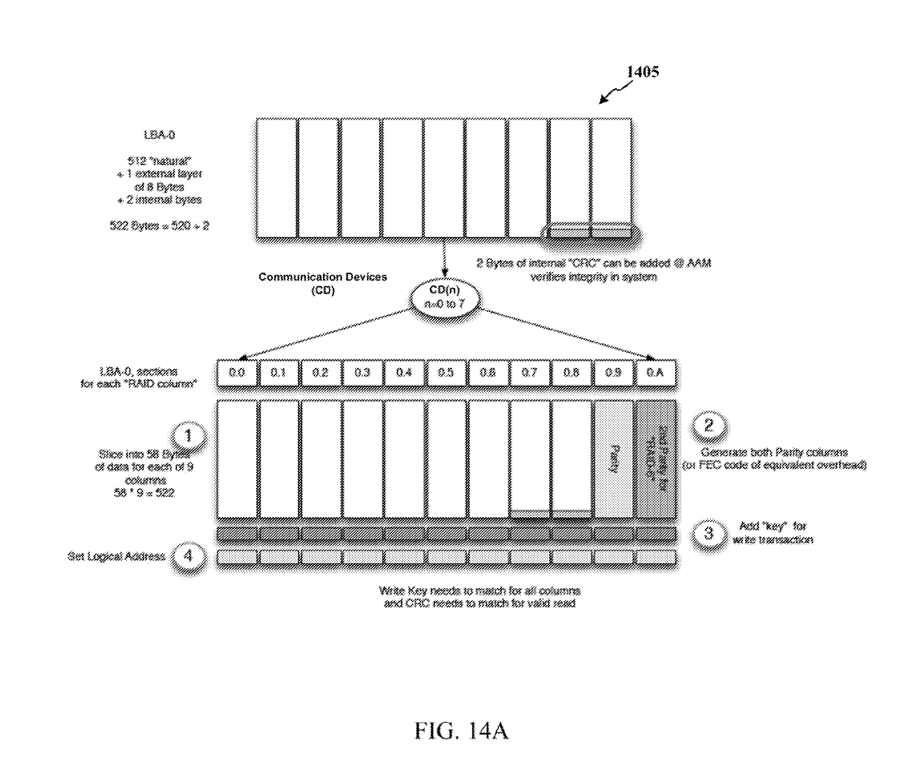

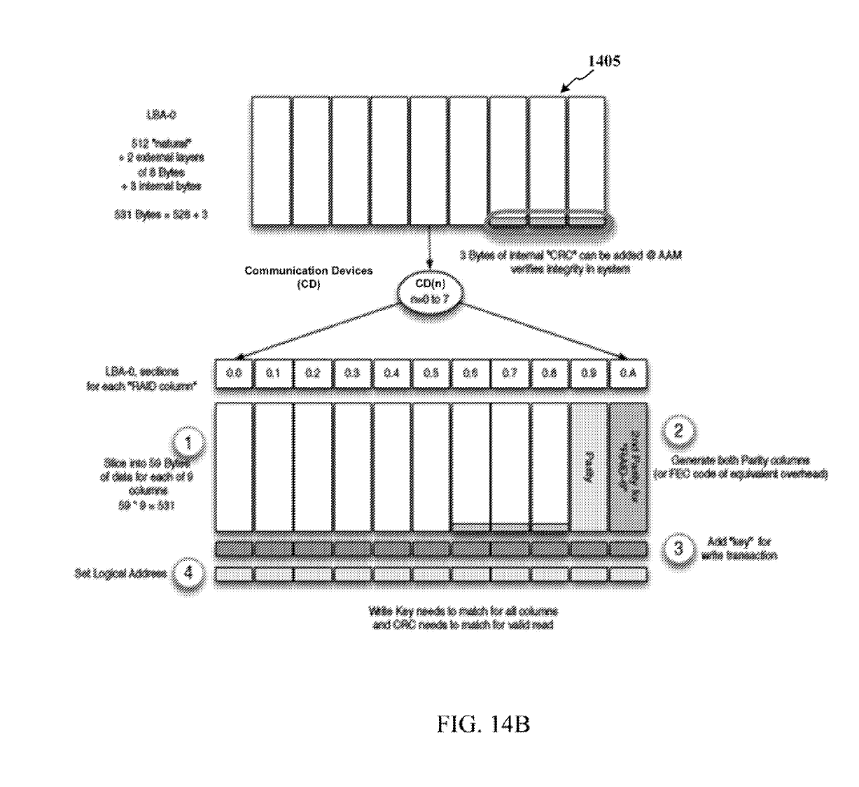

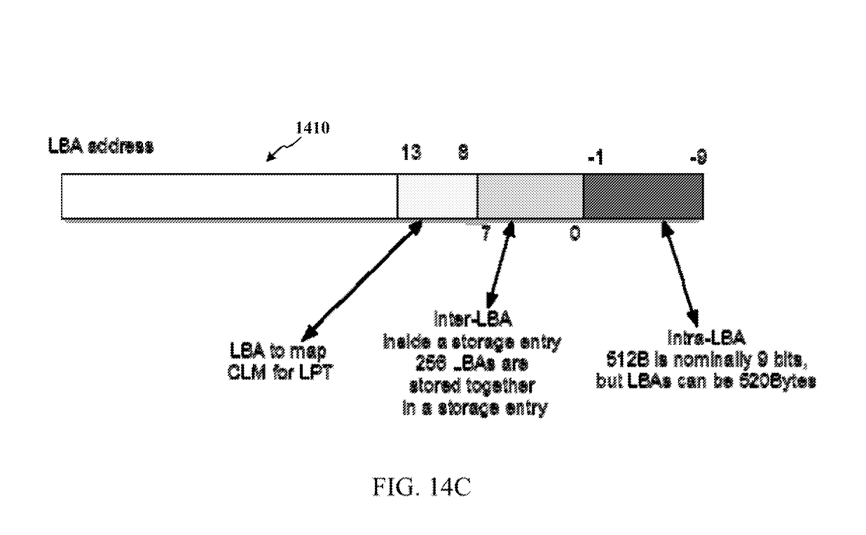

FIGS. 14A and 14B depict illustrative data storage configurations using LBA according to some embodiments. For example, 14A depicts writing data to an LBA 1405 including external LBAs with 520 bytes configured for P/Q parity, while FIG. 14B depicts writing data to an LBA 1405 including external LBAs with 528 bytes configured for P/Q parity. A smaller LBA size (for example, 520 bytes) may operate to enable more space for internal meta-data. In an embodiment, both encoding formats may be supported such that if the lesser amount of internal meta data is employed, no encoding differences may be required. If different amounts of internal meta-data are used, then a logical storage unit or pool may be configured to include a mode indicating which encoding is employed. FIG. 14C depicts an illustrative LBA mapping configuration 1410 according to an embodiment.

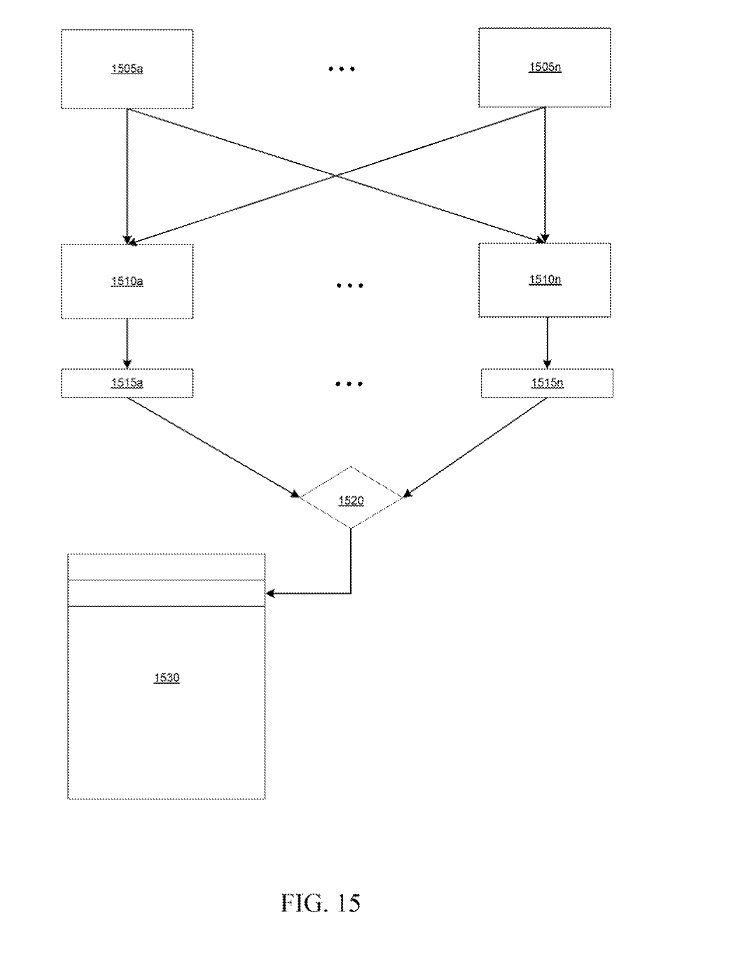

FIG. 15 depicts a flow diagram of data flow from AAMs to persistent storage according to an embodiment. As shown in FIG. 15, data may be transmitted from an AAM 1505a-1505n to any available CLM 1510a-1510n within the data management system. In an embodiment, the CLM 1510a-1510n may be a “master” CLM. The data may be designated for storage at a storage address 1515a-1515n. The storage addresses 1515a-1515n may be analyzed 1520 and the data stored in the persistent storage 1530 at the specified storage addresses.

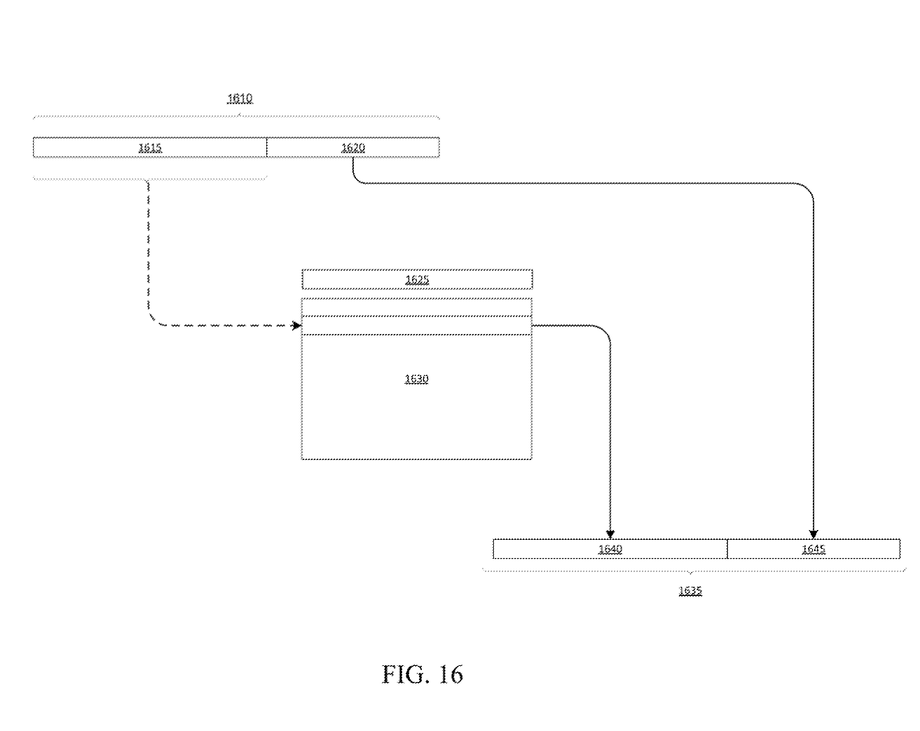

FIG. 16 depicts address mapping according to some embodiments. A logic address 1610 may include a logic block number 1615 segment (labeled, for example, LOGIC_BLOCK_NUM[N-1.0], wherein N is the logic block number) and a page number 1620 segment (labeled, for example, PAGE_NUM[M-1.0], wherein M is the page number). The logic block number 1615 segment may be used for logic block number indexing into a block map table 1630 having physical block numbers 1625 (labeled, for example, as PHYSICAL_BLOCK_NUM[P-1.0], wherein P is the physical block number). A physical address 1635 may be formed from the physical block number 1625 retrieved from the block map table 1630 based on the logic block number 1615 segment and the page number 1620 segment from the logic address 1610.

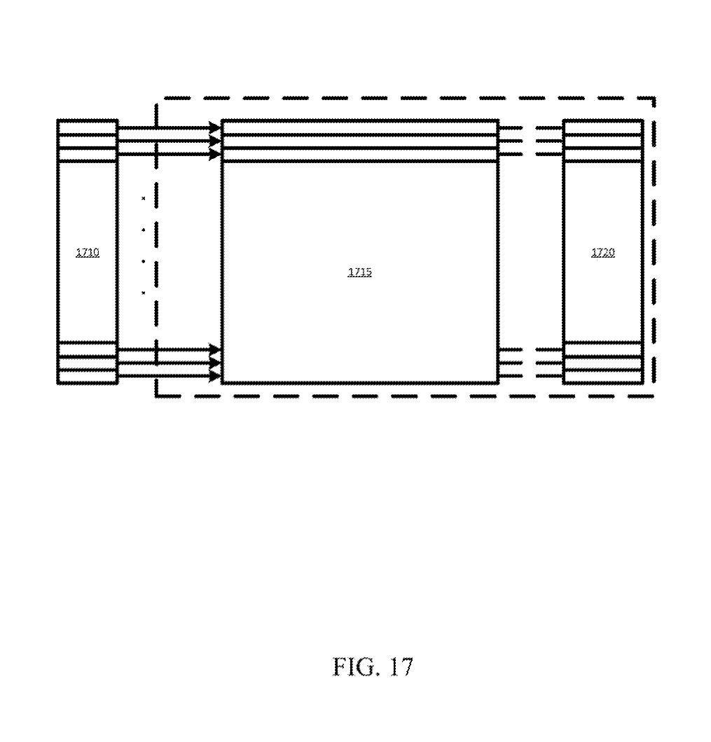

FIG. 17 depicts at least a portion of an illustrative persistent storage element according to some embodiments. Page valid 1710 pointers may be configured to point to valid pages in the persistent storage 1715. The persistent storage 1715 may include a logical address 1720 block for, among other things, specifying the location of blocks of data stored within the persistent storage.

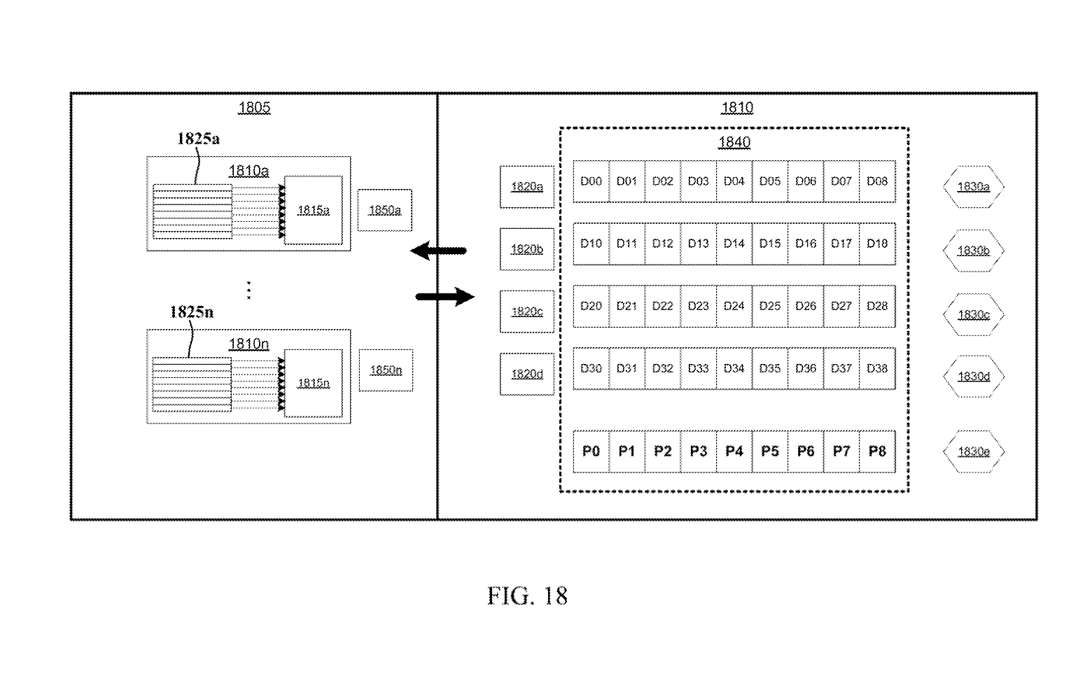

FIG. 18 depicts an illustrative CLM and persistent storage interface according to some embodiments. As shown in FIG. 18, the data management system may include a persistent storage domain 1805 having one or more PSMs 1810a-1810n associated with at least one processor 1850a-1850n. The PSMs 1810a-1810n may include data storage elements 1825a-1825n, such as flash memory devices and/or hard disk drives, and may communicate through one or more data ports 1815a-1815n, including a PCIe port and/or switch.

The data management system may also include a CLM domain 1810 having CLMs 1830a-1830e configured to store data 1840, such as user data and/or meta-data. Each CLM 1830a-1830e may include and/or be associated with one or more processors 1820a-1820c. The CLM domain 1810 may be RAID configured, such as the 4+1 RAID configuration depicted in FIG. 18, with four (4) data storage structures (D00-D38) and a parity structure (P0-P8). According to some embodiments, data may flow from the RAID configured CLM domain 1810 to the persistent storage domain 1805 and vice versa.

In an embodiment, the at least one processor 1850a-1850n may be operatively coupled with a memory (not shown), such as a DRAM memory. In another embodiment, the at least one processor 1850a-1850n may include an Intel® Xeon® processor manufactured by the Intel® Corporation of Santa Clara, Calif., United States

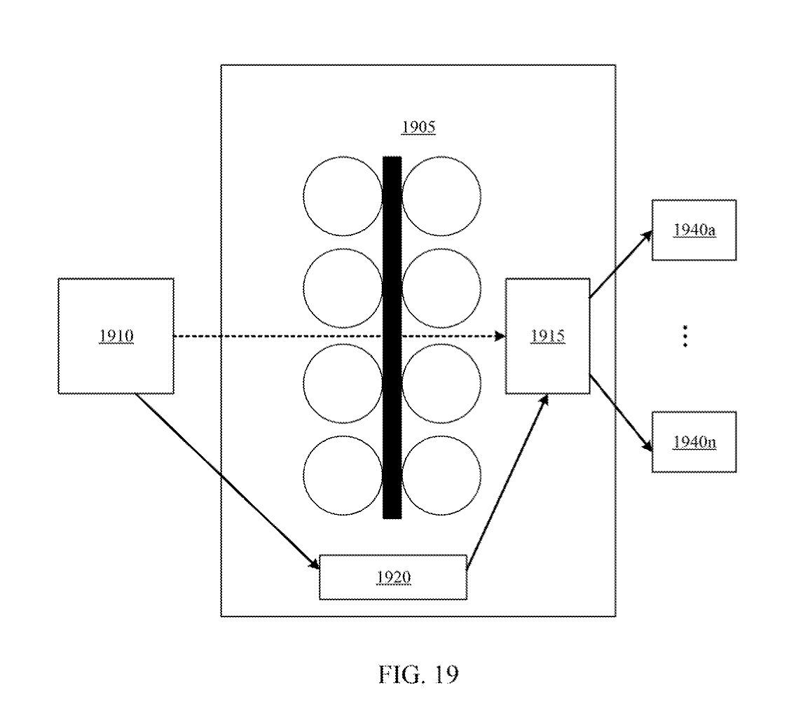

FIG. 19 depicts an illustrative power distribution and hold unit (PDHU) according to an embodiment. As shown in FIG. 19, the PDHU 1905 may be in electrical communication with one or more power supplies 1910. The data management system may include multiple PDHUs 1905. The power supplies 1910 may include redundant power supplies, such as two (2), four (4), six (6), eight (8), or ten (10) redundant power supplies. In an embodiment, the power supplies 1910 may be configured to facilitate load sharing and may be configured as 12 volt supply output/PDHU input load. The PDHU 1905 may include a charge/balance element 1920 (“SuperCap”). The charge/balance element 1920 circuitry may include multiple levels, such as two (2) levels, with balanced charging/discharging at each level. A power distribution element 1915 may be configured to distribute power to various data management system components 1940a-1940n, including, without limitation, LMs, CMs, CLMs, PSMs, AAMs, fans, computing devices, or the like. The power output of the PDHU 1905 may be fed into convertors or other devices configured to prepare the power supply for the components receiving the power. In an embodiment, the power output of the PDHU 1905 may be about 3.3 volts to about 12 volts.

In an embodiment, the PDHUs 1905 may coordinate a “load balancing” power supply to the components 1940a-1940n so that the PDHUs are employed in equivalent or substantially equivalent proportions. For instance, under a power failure, the “load balancing” configuration may enable the maximum operational time for the PDHUs to hold the system power so potentially volatile memory may be handled safely. In an embodiment, once the data management system has changed its state to a persistent storage state, the remaining power in the PDHUs 1905 may be used to power portions of the data management system as it holds in a low-power state until power is restored. Upon restoration of power, the level of charge in the PDHUs 1905 may be monitored to determine at what point sufficient charge is available to enable a subsequent orderly shutdown before resuming operations.

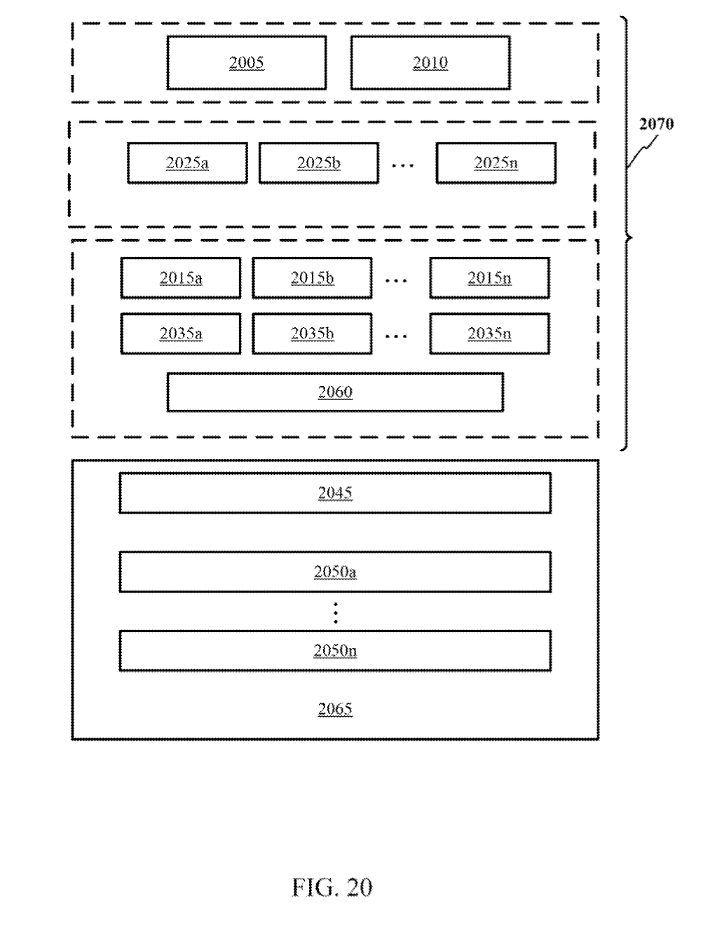

FIG. 20 depicts an illustrative system stack according to an embodiment. The data storage array 2065 may include an array access core 2045 and at least one data storage core 2050a-2050n, as described herein. The data storage array 2065 may interact with a host interface stack 2070 configured to provide an interface between the data storage array and external client computing devices. The host interface stack 2070 may include applications, such as an object store and/or key-value store (for example, hypertext transfer protocol (HTTP)) applications 2005, a map-reduce application (for example, Hadoop™ MapReduce by Apache™), or the like. Optimization and virtualization applications may include file system applications 2025a-2025n. Illustrative file system applications may include a POSIX file system and a Hadoop™ distributed file system (HDFS) by Apache™ MPIO drivers, a logical device layer (for instance, configured to present a block-storage interface), a VMWare API for array integration (VAAI) compliant interface (for example, in the MPIO driver), or the like.

The host interface stack 2070 may include various communication drivers 2035a-2035n configured to facilitate communication between the data storage array (for example, through the array access module 2045), such as drivers for NICs, HBAs, and other communication components. Physical servers 2035a-2035n may be arranged to process and/or route client IO within the host interface stack 2070. The client IO may be transmitted to the data storage array 2060 through a physical network device 2040, such as a network switch (for example, TOR, converged network adapter (CNA), FCoE, InfiniBand, or the like).

In an embodiment, a controller may be configured to provide a single consistent image of the data management system to all clients. In an embodiment, the data management system control software may include and/or use certain aspects of the system stack, such as an object store, a map-reduce application, a file system (for example, the POSIX file system).

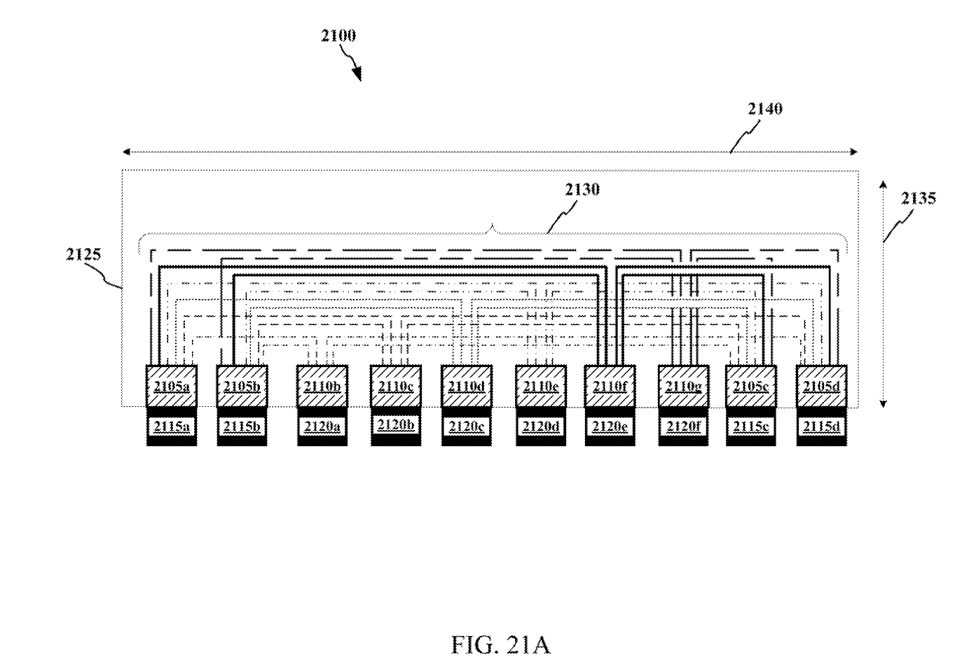

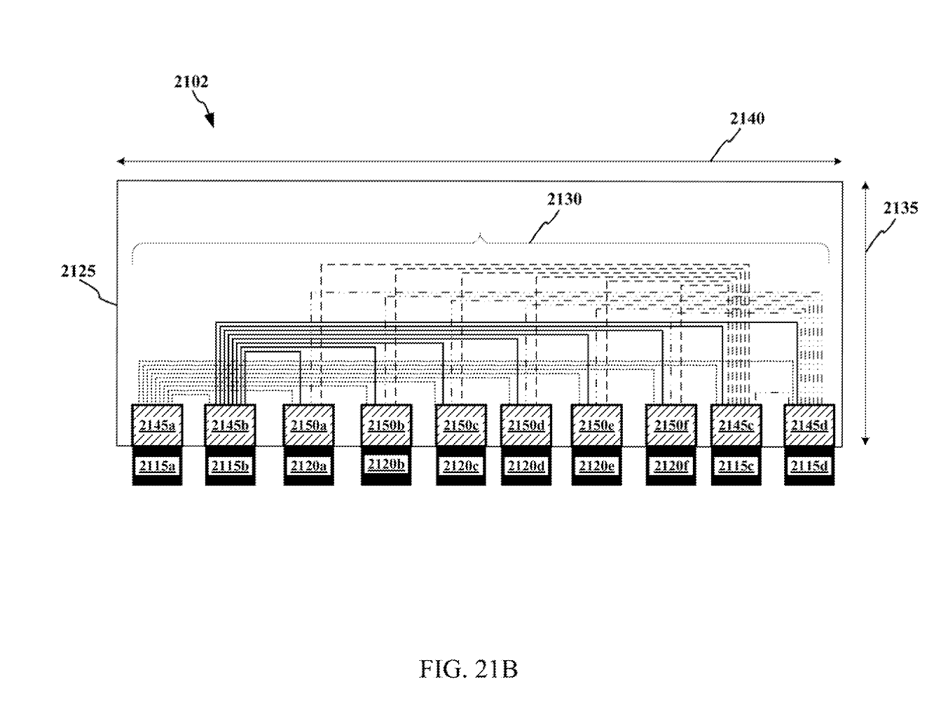

FIG. 21A depicts an illustrative data connection plane according to an embodiment. As shown in FIG. 21A, a connection plane 2125 may be in operable connection with storage array modules 2115a-2115d and 2120a-2120f through connectors 2145a-2145d and 2150a-2150f. In an embodiment, storage array modules 2115a-2115d may include AAM and storage array modules 2120a-2120f may include CMs and/or CLMs. Accordingly, connection plane 2125 may be configured as a midplane for facilitating communication between AAMs 2115a-2115d and CLMs 2120a-2120f through the communication channels 2130 depicted in FIG. 21A. The connection plane 2125 may have various profile characteristics, depending on space requirements, materials, number of storage array modules 2115a-2115d and 2120a-2120f, communication channels 2130, or the like. In an embodiment, the connection plane 2125 may have a width 2140 of about 440 millimeters and a height 2135 of about 75 millimeters.

The connection plane 2125 may be arranged as an inner midplane, with 2 (two) connection planes per unit (for example, per data storage array chassis). For example, one (1) connection plane 2125 may operate as a transmit connection plane and the other connection plane may operate as a receive connection plane. In an embodiment, all connectors 2145a-2145d and 2150a-2150f may be transmit (TX) connections configured as PCIe Gen 3×8 (8 differential pairs). A CLM 2120a-2120f may include two PCIe switches to connect to the connectors 2145a-2145d. The connectors 2145a-2145d and 2150a-2150f may include various types of connections capable of operating according to embodiments described herein. In a non-limiting example, the connections may be configured as PCIe switch, such as an ExpressLane™ PLX PCIe switch manufactured by PLX Technology, Inc. of Sunnyvale, Calif., United States. Another non-limiting example of a connector 2145a-2145d includes an orthogonal direct connector, such as the Molex® Impact part no. 76290-3022 connector and a non-limiting example of a connector 2150a-2150f includes the Molex® Impact part no. 76990-3020 connector, both manufactured by Molex® of Lisle, Ill., United States. The pair of midplanes 2125 may connect two sets of cards, blades, or the like such that the cards which connect to the midplane can be situated at a 90 degree or substantially 90 degree angle to the midplanes.

FIG. 21B an illustrative control connection plane according to a second embodiment. The connection plane 2125 may be configured as a midplane for facilitating communication between AAMs 2115a-2115d and CLMs 2120a-2120f through the communication channels 2130. The connections 2145a-2145d and 2150a-2150f may include serial gigabyte (Gb) Ethernet.

According to some embodiments, the PCIe connections from the CLMs 2120a-2120f to the AAMs 2115a-2115d may be sent via the “top” connector, as this enables the bulk of the connectors in the center to be used for PSM-CLM connections. This configuration may operate to simplify board routing, as there are essentially three midplanes for carrying signals. The data path for the two AAMs 2115a-2115d may be configured on a separate card, such that signals from each AAM to the CLMs 2120a-2120f may be laid out in such a manner that its own connections do not need to cross each other, they only need pass connections from the other AAM. Accordingly, a board with minimal layers may be enabled as if the connections from each AAM 2115a-2115d could be routed to all CLMs 2120a-2120f in a single signal layer that only two such layers would be required (one for each AAM) on the top midplane. In an embodiment, several layers may be employed as it may take several layers to “escape” high density high speed connectors. In another embodiment, the connections and traces may be done in such a manner as to maximize the known throughput which may be carried between these cards, for instance, increasing the number of layers required

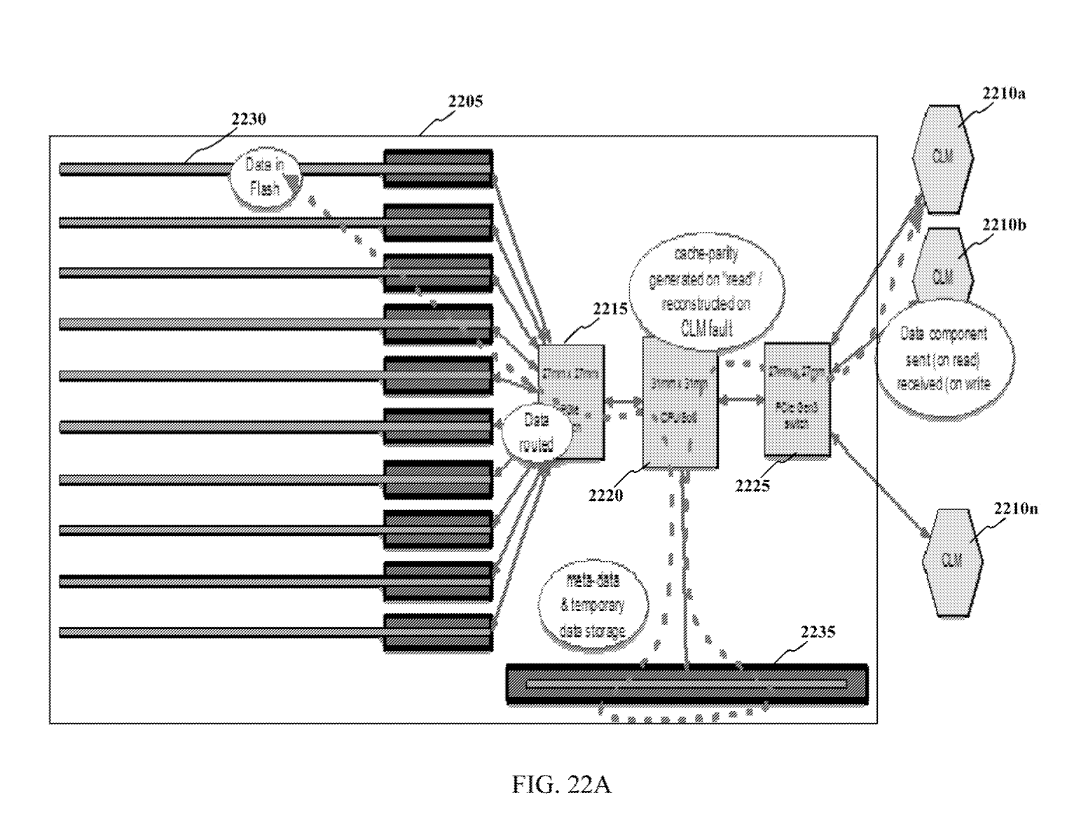

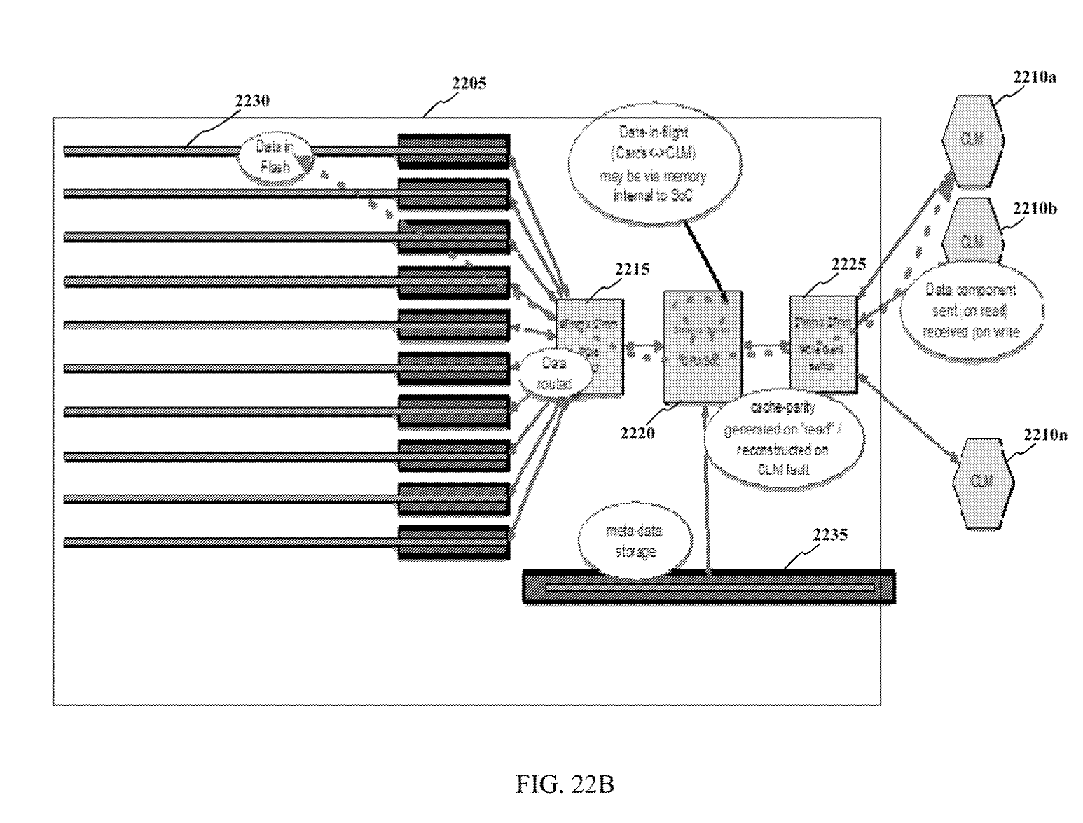

FIG. 22A depicts an illustrative data-in-flight data flow on a persistent storage device (for example, a PSM) according to an embodiment. As shown in FIG. 22A, a PSM 2205 may include a first PCIe switch 2215, a processor 2220, and a second PCIe switch 2225. The first PCIe switch 2215 may communicate with the flash storage 2230 devices and the processor 2220. In an embodiment, the processor 2220 may include a SoC. The second PCIe switch 2225 may communicate with the processor 2220 and the CLMs 2210a-2210n. The processor 2220 may also be configured to communicate with a meta-data and/or temporary storage element 2235. The data flow on the PSM 2205 may operate using DRAM off of the processor 22202 SoC for data-in-flight. In an embodiment, the amount of data-in-flight may be increased or maximized by using memory external to the SoC, employed, for instance, for buffering data moving through the SoC.

FIG. 22B depicts an illustrative data-in-flight data flow on a persistent storage device (for example, a PSM) according to a second embodiment. As shown in FIG. 22B, memory internal to the processor 2220 SoC may be used for data-in-flight. Using memory internal to the SoC for data-in-flight may operate, among other things, to reduce the amount of external memory bandwidth required for servicing requests, for instance, if the data-in-flight can be kept within the internal memory of the SoC.

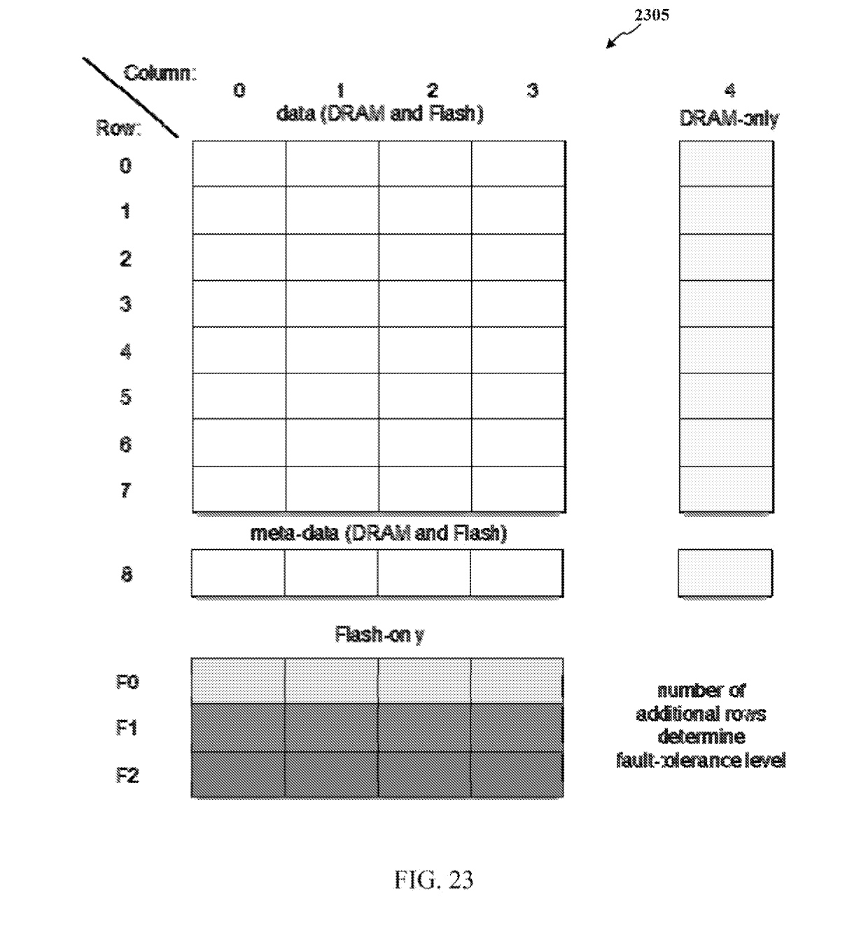

FIG. 23 depicts an illustrative data reliability encoding framework according to an embodiment. The encoding framework 2305 depicted in FIG. 23 may be used, for example, by an array controller to encode data. An array controller may be configured according to certain embodiments to have data encoded orthogonally for reliability across the CLMs (cache storage) and the persistent (flash) storage. In a non-limiting example, data may be encoded for the CLMs in a 4+1 Parity RAID3 configuration for each LBA in a storage block (for example, such that data may be written or read concurrently to the CLMs). Permanent storage blocks for the array controller may be configured in a manner substantially similar to a large array, for example, according to one or more of the following characteristics: data for 256 LBAs (e.g., 128 KB with 512 Byte LBAs) may be stored as a collective group or the system meta-data may be placed in-line using about nine (9) storage entries of 16 kilobytes each in the permanent storage with additional storage entries used for reliability (for example, as FEC/RAID).

In an embodiment, data written to flash memory may include about nine (9) sets of 16 kilobytes plus one (1) set for each level of tolerated errors/unavailability. FEC/RAID may operate to support from one (1), which can be straight parity, to at least two (2) concurrent faults, and even up to three (3) or four (4). Some embodiments provide for accounts configured for dual fault coverage on the flash subsystem(s).

As shown in the encoding framework 2305 depicted in FIG. 23, as the data “rows” in flash are 16 kilobytes each, the DRAM “columns” are each 36 kilobytes in length, with 32 kilobytes in “normal data” and 4 kilobytes in “meta-data.” Each of the logical “rows” in each CLM's cache column may include 4 kilobytes of data, with pieces of 32 LBAs having 128 bytes per LBA. In an embodiment, the DRAM cache parity may be written (unless the designated CLM which serves as parity for the cache entry is missing) but is never read (unless one of the other CLMs is missing).

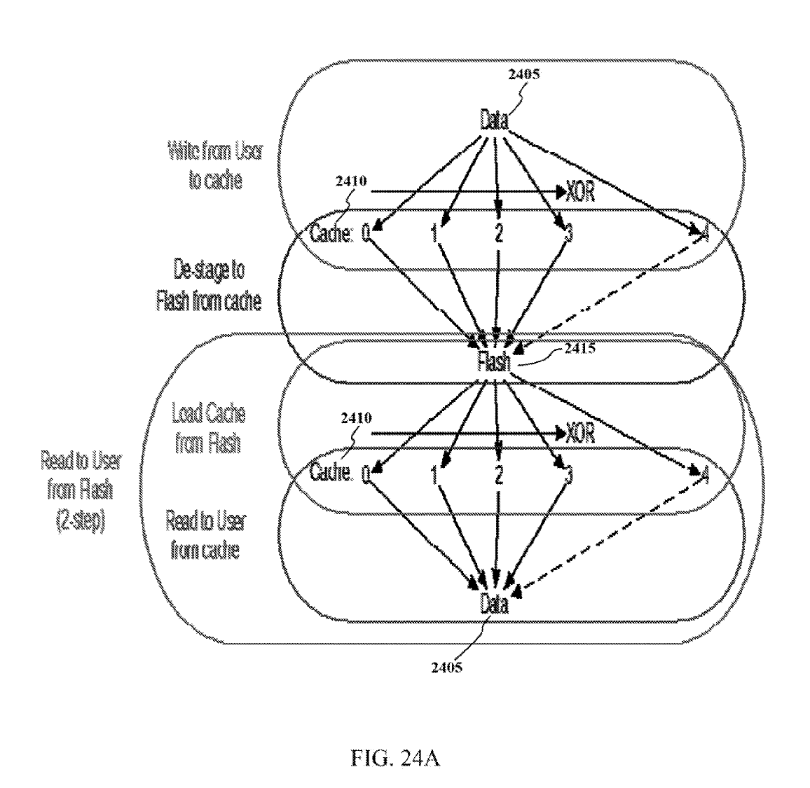

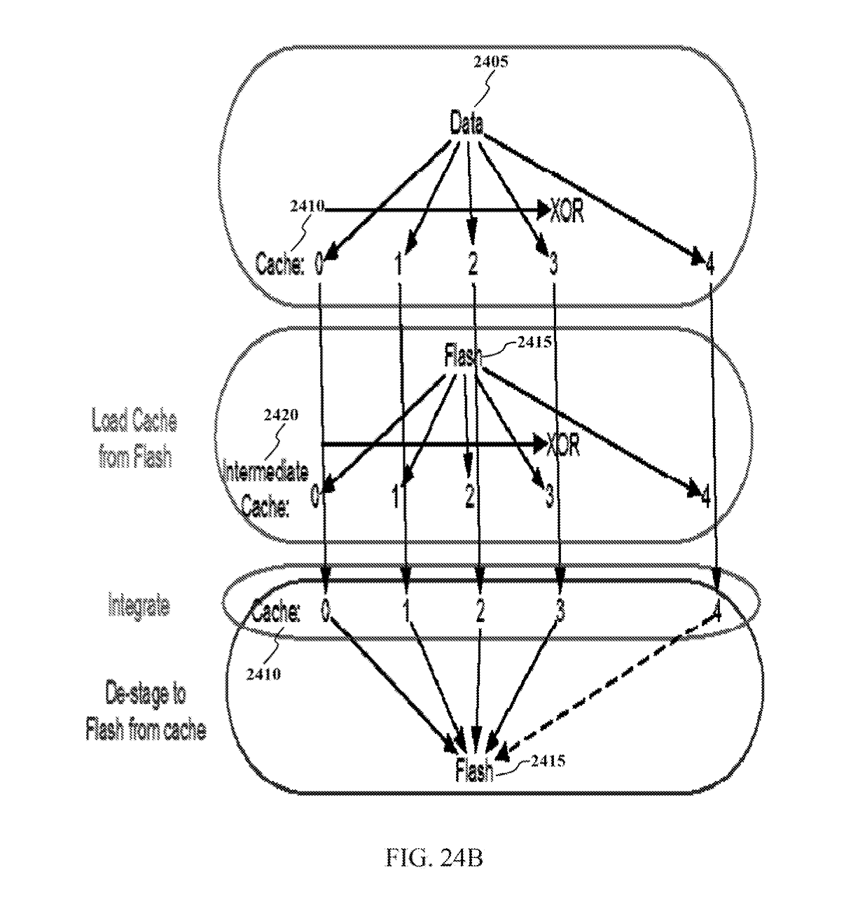

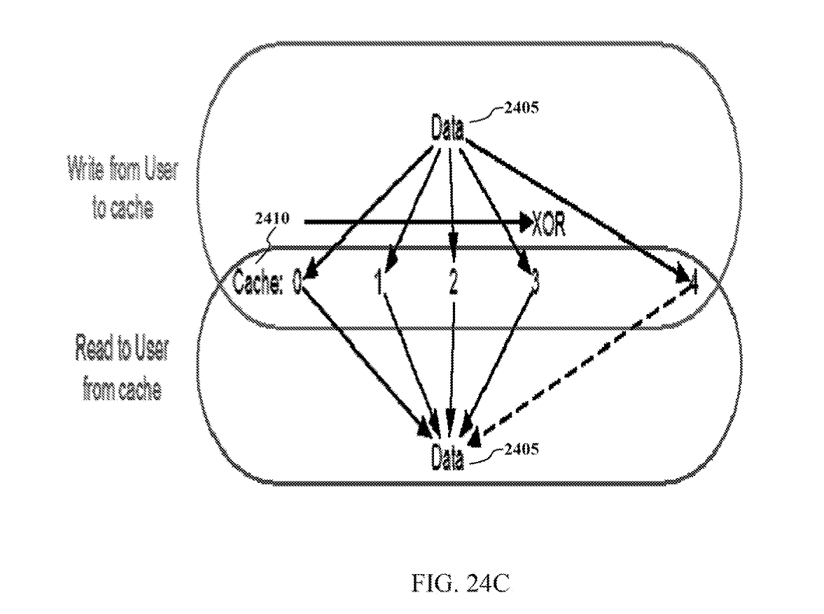

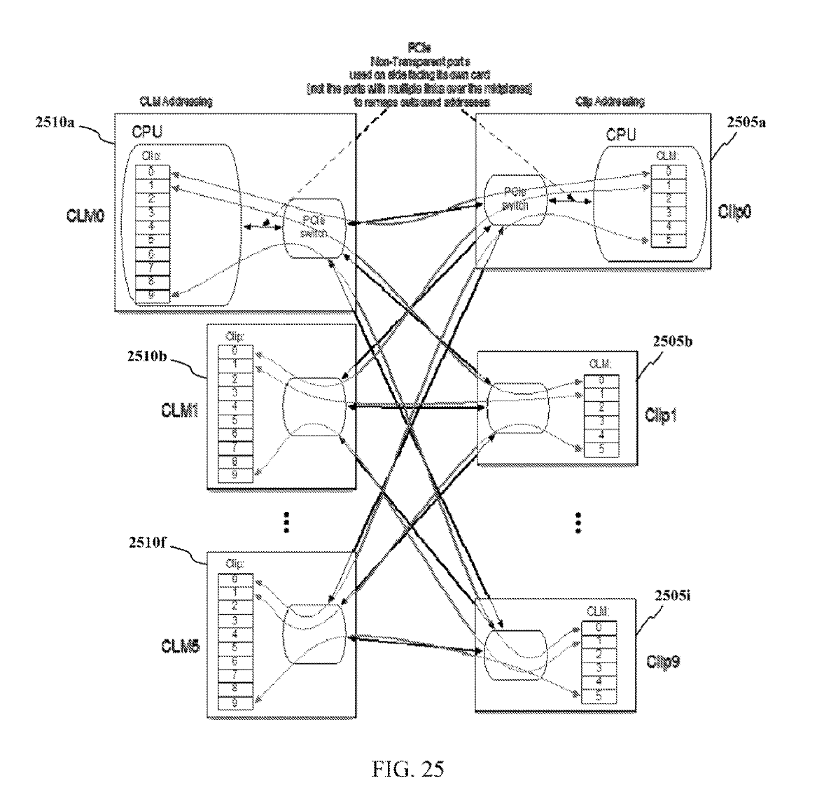

FIGS. 24A-25B depict illustrative read and write data operations according to some embodiments. As shown in FIG. 24A, the user write to user read of data 2405 may be de-staged to flash 2415. FIG. 24C illustrates that a user write to subsequent read may not be de-staged to flash 2415.

As shown in FIG. 24B, some embodiments provide that data 2405 which is partially written in the cache 2410 does not need to be read by the system to integrate the old data, for example, as many cases have data which is written without being read (for instance, circular logs). Depending on the size and nature of the data 2405, such as a log or system meta-data, some blocks may be written frequently in media without the need to read the balance of the data from permanent storage until the data is ready to be de-staged back. In an embodiment, data integration may be configured such that data 2405 written by the user/client is the most current copy, and may completely overwrite the intermediate cache data 2415.

In an embodiment, if data 2405 had never been written by a user, there was no “data in permanent storage.” As such, the system may tolerate gaps/holes in the data 2405 from what was written by the user, as there was no data previously. In a non-limiting example, the system may substitute default values (for instance, one or more zeros alone or in combination with other default values) for space where no data 2405 had been written. This may be done many times, for instance, when the first sector is written into the cache 2410, when the data 2405 is about to be de-staged, points in between, or some combination thereof. A non-restrictive and illustrative example provides that the substitution may occur at a clean decision point. A non-limiting example provides that if the data 2405 is cleared when the cache entry is allocated, the system may no longer need to track that the data did not have a prior state. In another non-limiting example, if it is to be set when the data 2405 is committed, the map of valid sectors in cache 2410 and the fact the block is not valid in permanent storage may operate to denote that the data uses the default, for instance, without requiring the data in the cache to be cleared.

In an embodiment, the system may use an “integration reaper” process which scans data 2405 deemed to be close to the point it may be de-staged to permanent storage and reads any missing components so that the system does not risk getting held up on the ability to make actual writes due to the lack of data. In a non-limiting example, the writer threads can bypass for de-staging items which are awaiting integration. As such, embodiments provide that the system may maintain a “real time clock” of the last time an operation from the client touched a cache address. For instance, least-recently-used LRU may be employed to determine appropriate time for cache entry eviction. When data is requested for a storage unit which is partially in cache 2410, the system may read data from the permanent storage when the cache does not have the components being requested, avoiding unnecessary delay.

FIG. 25 depicts an illustration of non-transparent bridging for remapping addressing to mailbox/doorbell regions according to some embodiments. As depicted in the non-restrictive illustration of FIG. 25, each of the storage clips 2505a-2505i may have a “mailbox” and a “doorbell” for each of the cache lookup modules 2510a-2510f, for instance, numbered from 0 to 5. When sending messages to the memory region for each cache lookup modules 2510a-2510f through the PCIe switches, the addresses would be remapped so that each cache lookup modules 2510a-2510f receives the messages from every source storage clip 2505a-2505i in a memory region which is unique for the storage clips 2505a-2505i 0 to 19. FIG. 18 shows 10 storage clips 2505a-2505i as each PCIe switch shown in the diagrams connects to 10 storage clips 2505a-2505i, for example, the same kind of mapping which may be done separately in each independent switch (e.g., working in their own source memory space). Every storage clips 2505a-2505i may have the same addressing to all cache lookup modules 2510a-2510f, and vice versa. The PCIe switch may further operate to re-map addresses so that when all clips write to “CLM0,” and CLM0 may receive messages uniquely in its mailbox from each storage clip 2505a-2505i.

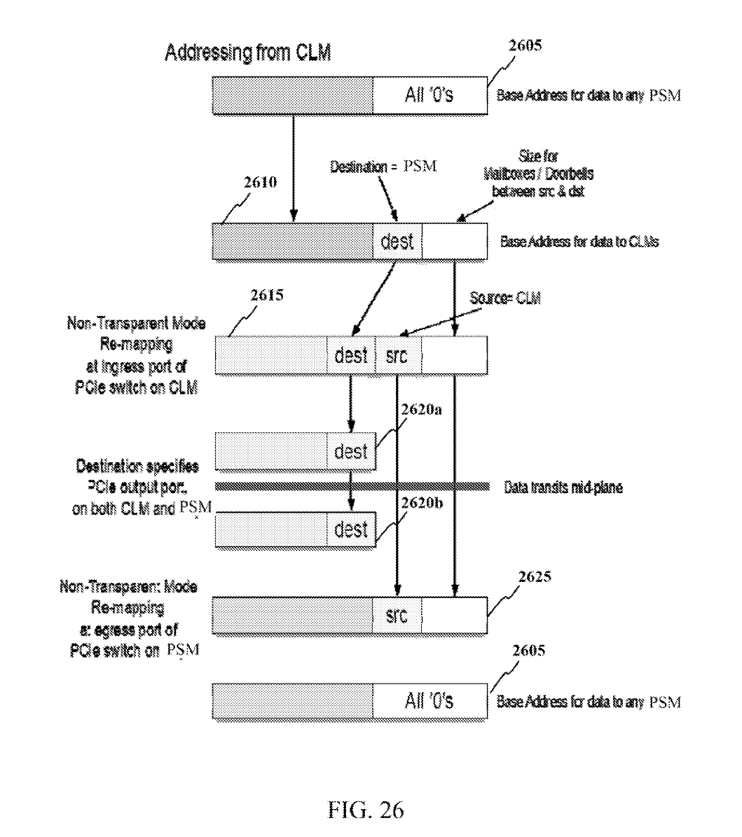

FIG. 26 depicts an illustrative addressing method of writes from a CLM to a PSM according to some embodiments. As shown in FIG. 26, a base address 2605 may be configured for data to any PSM and a base address 2610 may be configured for data to any CLM. The addressing method may include a non-transparent mode 2615 for remapping at an ingress port of a PCIe switch of a CLM. A destination may be specified 2620a, 2620b for the PCIe port of the PSM and CLM. The addressing method may include a non-transparent mode 2625 for re-mapping at egress port of PCIe switch on the PSM.

A reverse path may be determined from FIG. 19 by replacing “CLM” for “PSM,” and vice versa. The base addresses for data being sent outbound may be external to the processor. In an embodiment, the memory used for the reception of data transmissions may be configured to fit in the on-chip memory of each endpoint to avoid the need for external memory references on data-in-flight. The receiver may handle moving data out of the reception area to make room for additional communications with the other endpoint. Some embodiments provide for similar or substantially similar non-transparent bridge re-mapping applied to CLMs communicating with array access modules and each other (for example, via an array access module PCIe switch). The system may be configured according to some embodiments to preclude communication between like-devices (e.g., CLM-to-CLM or PSM-to-PSM), for instance, by defining the accepted range of addresses reachable from the source or similar techniques.

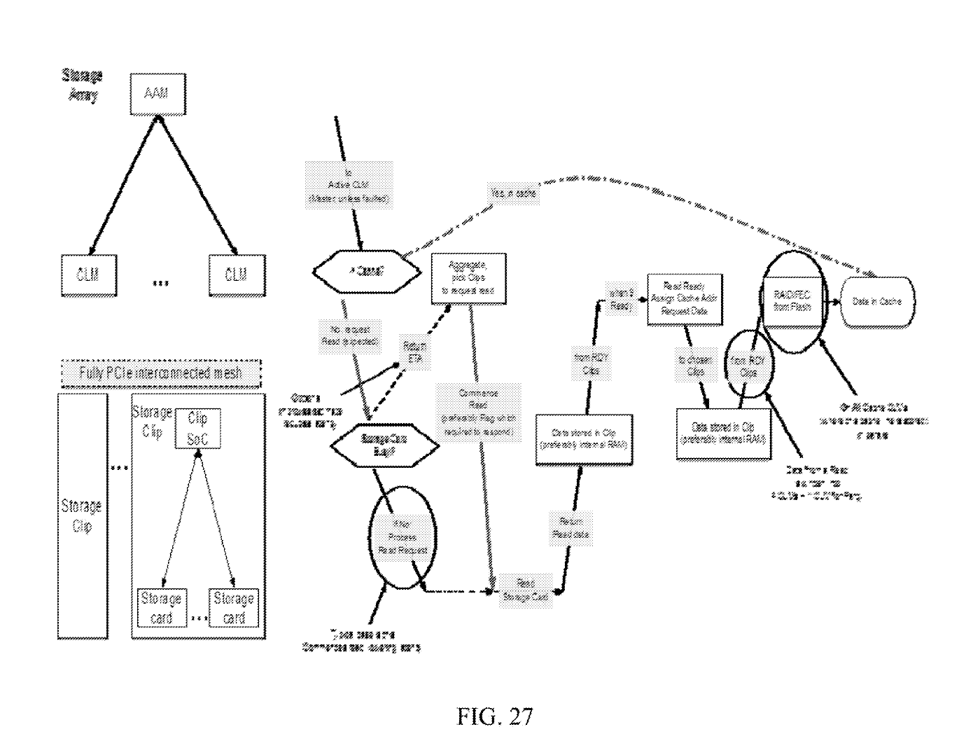

According to some embodiments, a write transaction may include at least the following two components: writing to cache and de-staging to permanent storage. A write transaction may include integration of old data that was not over-written with the data that was newly written. In an embodiment, an “active” CLM may control access to the cache data for each LPT entry, such that all or substantially all CLMs may hold components of the cache that follow the lead, including both masters and slaves. FIG. 27A depicts an illustrative flow diagram of a first part of a read transaction and FIG. 27B depicts a second part of the read transaction according to some embodiments. FIG. 27C depicts an illustrative flow diagram of a write transaction according to some embodiments. FIGS. 27A-27C are non-restrictive and are shown for illustrative purposes only as the data read/write transactions may operate according to embodiments using more or less steps than depicted therein. For instance, additional steps and/or blocks may be added for handling events such as faults, including receiving insufficient acknowledgements, wherein a command may be regenerated to move the process along or step back to a prior state.

### Large-Scale Data Management Systems

Some embodiments described herein provide techniques for enabling effective and efficient web-scale, cloud-scale or large-scale (“large-scale”) data management systems that include, among other things, components and systems described above. In an embodiment, hierarchical access approach may be used for a distributed system of storage units. In another embodiment, logical addresses from hosts may be used for high level distribution of access requests to a set of core nodes providing data integrity to back-end storage. Such an embodiment may be implemented, at least in part, through a MPIO driver. Mapping may be deterministic based on addressing, for example, on some higher-order address bits and all clients may be configured to have the same map. Responsive to a fault event of a core node, the MPIO driver may use alternate tables which determine how storage accesses are provided on a lesser number of core nodes.

In a large scale system, clients may be connected directly or indirectly via an intermediate switch layer. Within each core node, AAMs may communicate to the clients and to a number of component reliability scales, for example, through communication devices, servers, assemblies, boards, or the like (“RX-blades”). Analogous to the MPIO driver balancing across a number of core nodes in a normal or fault-scenario, the AAM may use a deterministic map of how finer granularity accesses are distributed across the RX-blades. For most accesses, data is sent across RX-blades in parallel, either being written to or read from the storage units. The AAM and RX-blades may not have a cache which could be employed to service subsequent requests for the same data, for instance, all data may be accessed natively from the storage units.

Storage units within a large scale system may internally provide a tiered storage system, for example, including one or more of a high performance tier which may service requests and a low-performance tier where for more economical data storage. When both tiers are populated, the high-performance tier may be considered a “cache.” Data accesses between the high and low-performance tier, when both are present, may be performed in a manner that maximizes the benefits of each respective tier.

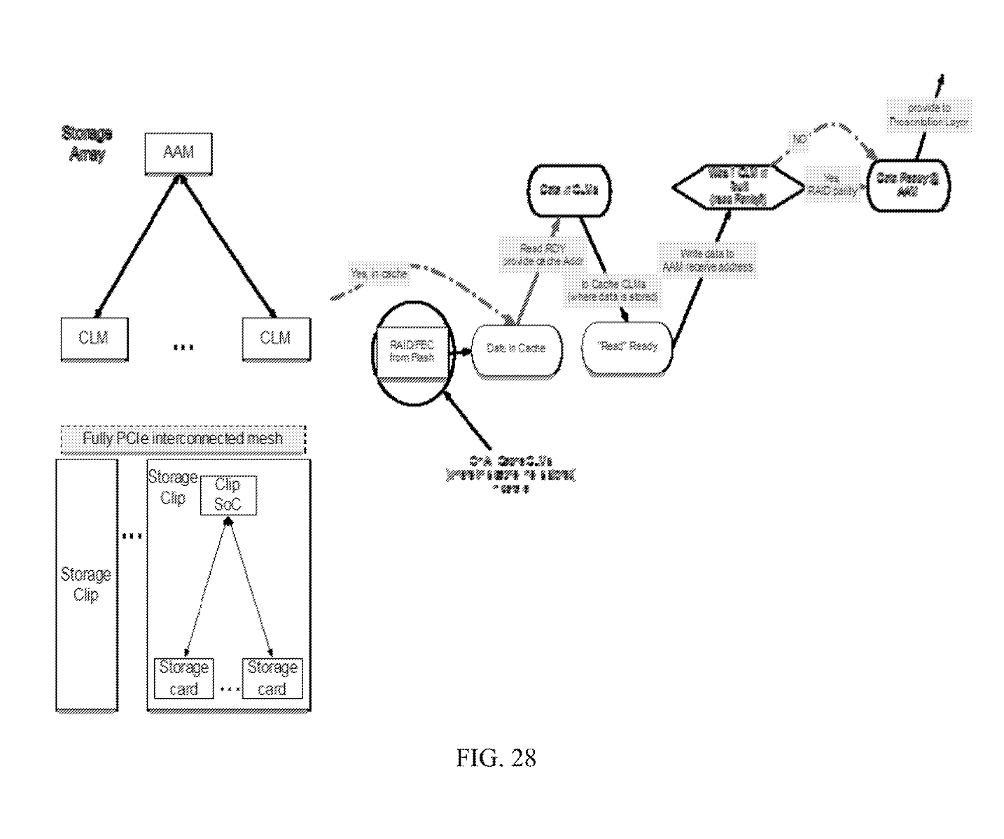

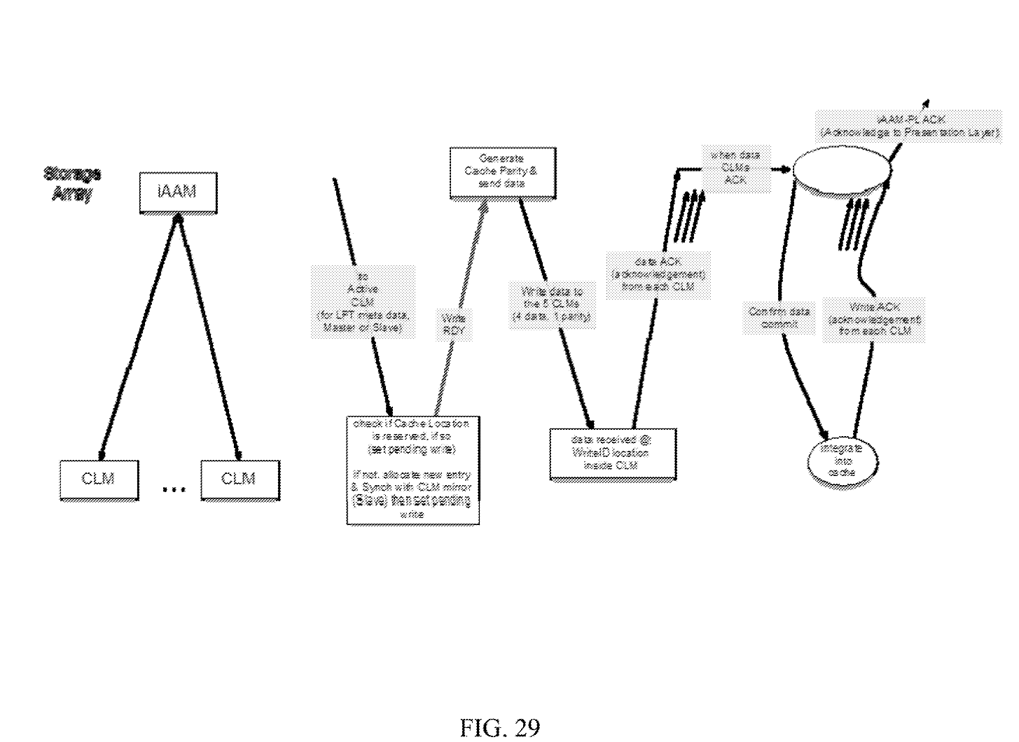

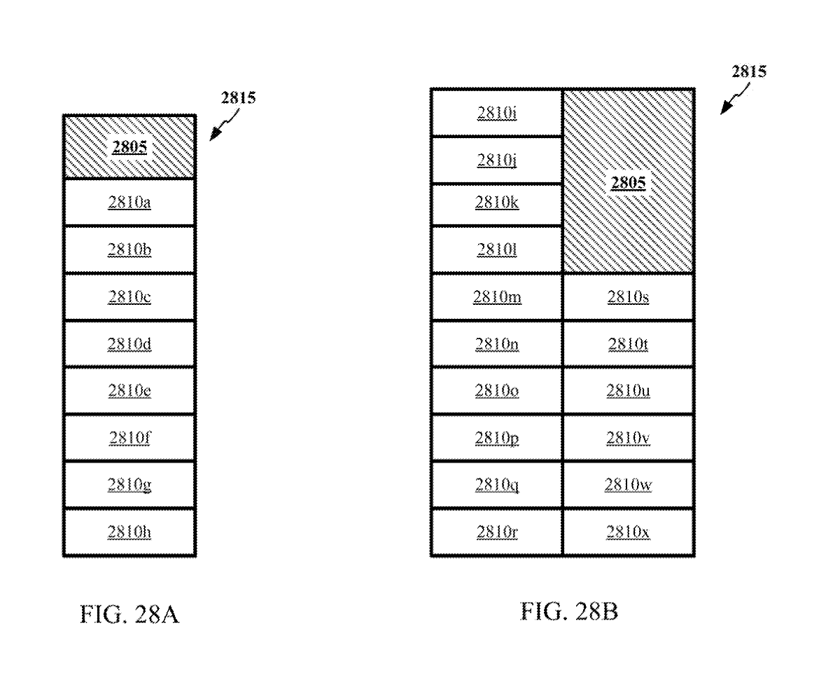

FIGS. 28A and 28B depict illustrative data management system units according to some embodiments. According to some embodiments, data management systems may include units (or “racks”) formed from a data servicing core 2805a, 2805b operatively coupled to storage magazines 2810a-2810x. The data servicing core 2805a, 2805b may include AAMs and other components capable of servicing client IO requests and accessing data stored in the storage magazines 2810a-2810x. As shown in FIG. 2A, a data management unit 2815 may include one data servicing core 2805a and eight (8) storage magazines 2810a-2810h. A data management system may include multiple data management units 2815, such as from one (1) to four (4) units. FIG. 28B depicts a unit 2820, for instance, for a larger, full-scale data management system that includes a data servicing core 2805b and sixteen (16) storage magazines 2810i-2810x. In an embodiment, a data management system may include from five (5) to eight (8) units 2820. Embodiments are not limited to the number and/or arrangement of units 2815, 2820, data servicing cores 2805a, 2805b, storage magazines 2810a-2810x, and/or any other component as these are provided for illustrative purposes only. Indeed, any number and/or combination of units and/or components that may operate according to some embodiments is contemplated herein

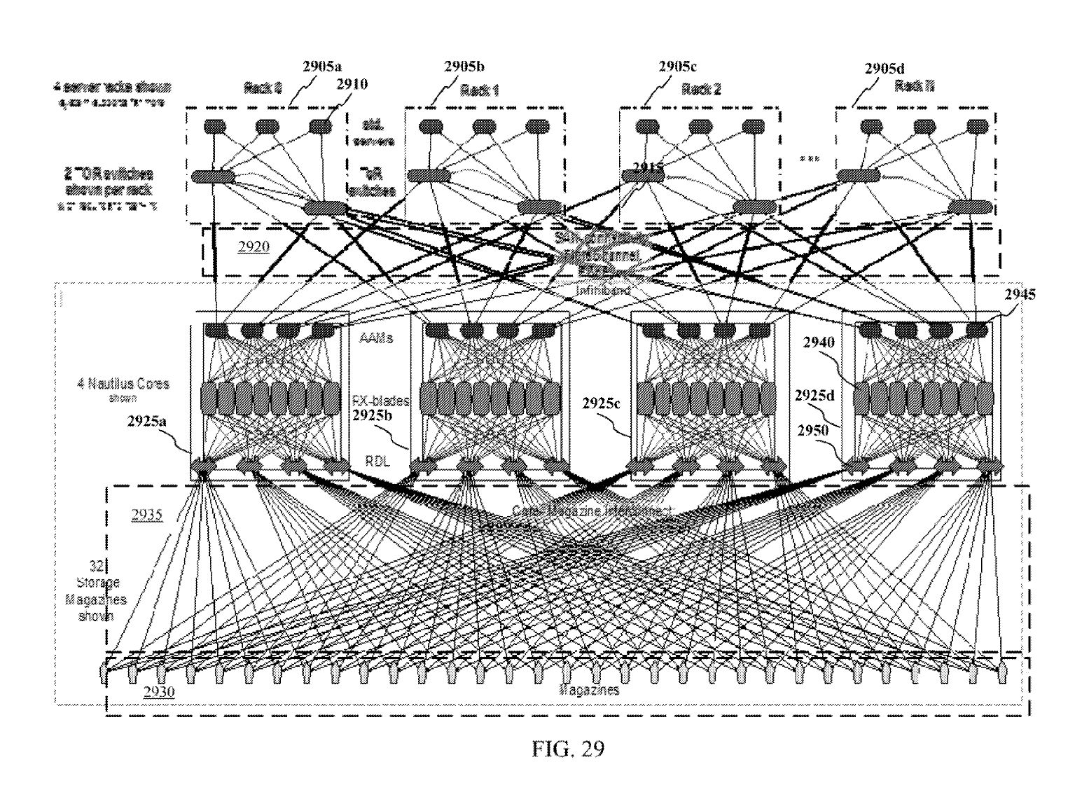

FIG. 29 depicts an illustrative web-scale data management system according to an embodiment. As shown in FIG. 29, a web-scale data management system may include server racks 2905a-2905n that include servers 2910 and switches 2915, such as top-of-rack (TOR) switches to facilitate communication between the data management system and data clients. A communication fabric 2920 may be configured to connect the server racks 2905a-2905n with the components of the data management system, such as the data servicing cores 2925a-2925d. In an embodiment, the communication fabric 2920 may include, without limitation, SAN connectivity, FibreChannel, Ethernet (for example, FCoE), Infiniband, or combinations thereof. The data servicing cores 2925a-2925d (“cores”) may include RX-blades 2940, array access modules 2945 and redistribution layers 2950. A core-magazine interconnect 2930 may be configured to provide a connection between the data servicing cores 2925a-2925d and the storage magazines 2935.

To enable maximum parallelism for high throughput through the data servicing cores 2925a-2925d, certain embodiments provide that data may be divided by LBA across RX-blades 2940. For example, with a fraction of each LBA stored in each component magazine at the back-end. This may operate to provide multiple storage magazines 2935 and multiple RX-blades 2940 to participate in the throughput required for handling basic operations. Inside of a storage magazine 2935, a single pointer group may be employed for each logically mapped data storage block in each storage magazine. A non-limiting example provides that the pointer group may comprised of one or more of a low-performance storage pointer, a high-performance storage pointer and/or an optional flag-bit.

In an embodiment, every RX-blade 2940 in each data servicing core 2925a-2925d may be connected, logically or physically, to every storage magazine 2935 in the system. This may be configured according to various methods, including, without limitation direct cabling from each magazine 2935 to all RX-blades 2940, indirectly via a patch-panel, for example, which may be passive, and/or indirectly via an active switch.

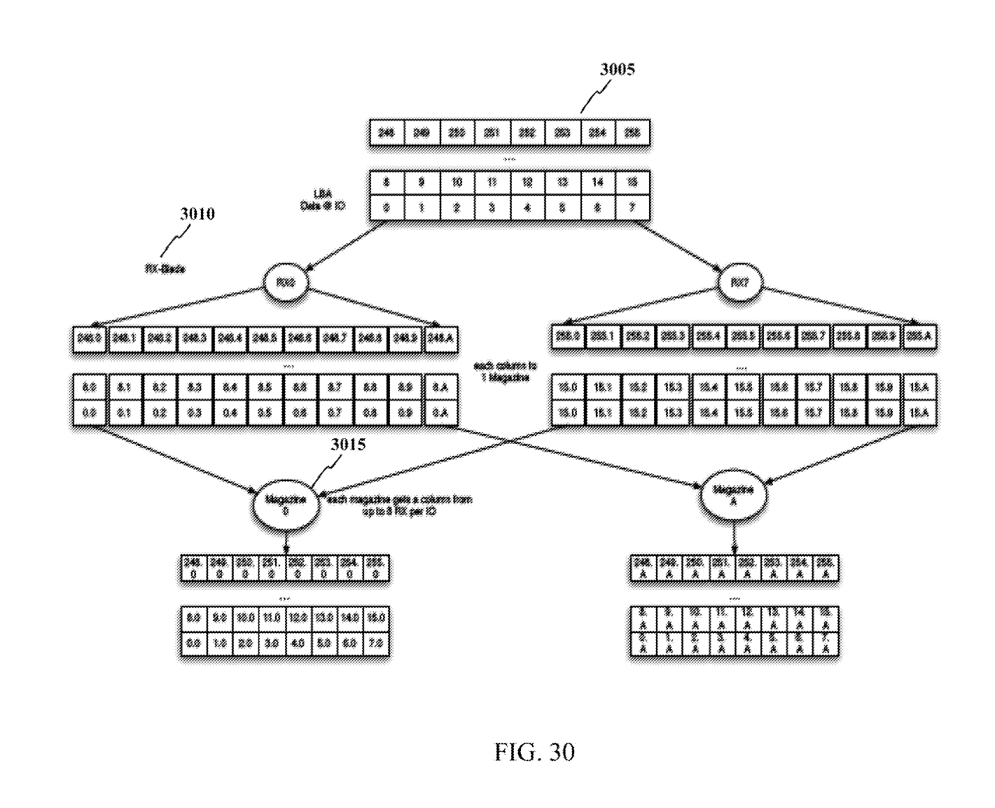

FIG. 30 depicts an illustrative flow diagram of data access within a data management system according to certain embodiments. Data transfers may be established between the AAMs 3005 and the magazines 3015, with the RX-blades 3010 essentially facilitating data transfer while providing a RAID function. As the RAID-engines (for example, the RX-blades 3010) maintain no cache, the devices can employ materially all of their IO pins for reliably transmitting data and internal system control messages from AAM 3005 (toward the clients) to the magazines 3015 (where the data is stored).

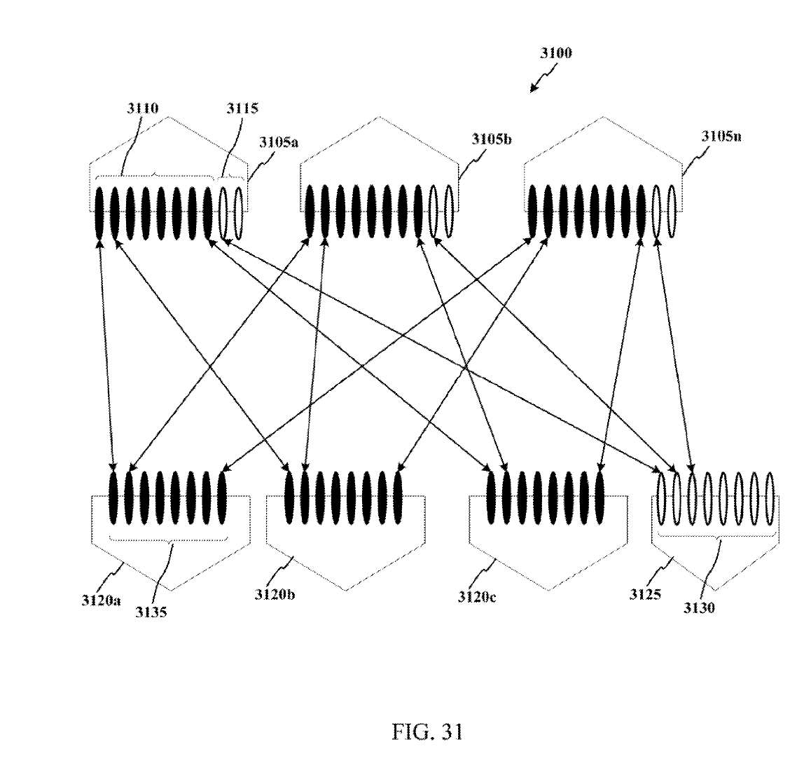

FIG. 31 depicts an illustrative redistribution layer according to an embodiment. According to some embodiments, a redistribution layer 3100 may be configured to provide a connection (for example, a logical connection) between the RX-blades and the storage magazines. As shown in FIG. 31, the redistribution layer 3100 may include redistribution sets 3105a-3105n to the storage chambers 3110 and redistribution sets 3120a-3120b to the RX-blades 3135. A control/management redistribution set 3125 may be configured for the control cards 3115, 3130.

According to some embodiments, the redistribution layer 3100 may be configured to provide such connections via a fixed crossover of the individual fibers from the storage magazines 3110 to the RX-blades 3135. In an embodiment, this cross-over may be passive (for example, configured as a passive optical cross-over), requiring little or substantially no power. In an embodiment, the redistribution layer 3100 may include a set of long-cards which take cables in on the rear from the storage magazines 3110 and have cables in the front to the RX-blades 3135.

RX-blades may be configured to access a consistent mapping of how data is laid out across the individual storage magazines. In an embodiment, data may be laid out to facilitate looking up the tables to determine the storage location or to computationally determinable in a known amount of time. In some embodiments using tables, lookup tables may be used directly, or via a mapping function, a number of bits to find a table entry which stores values. For example, depending on the mapping, some entries may be configured such that no data may ever be stored there, if so, the map function should be able to identify an internal error. In an embodiment, tables may have an indicator to note which magazine stores each RAID column. Efficient packing may have a single bit denote whether an access at this offset either uses or does not use a particular storage magazine. Columns may be employed in fixed order, or an offset may be stored to say which column has the starting column. All bits may be marked in the order the columns are employed, or an identifier may be used to denote which column each bit corresponds to. For example, a field may reference a table that says for each of the N bits marked, which column each successive bit represents Data may be arranged such that all storage magazines holding content may an equivalent or substantially equivalent amount of content in RAID groups with every other storage magazines holding content. This may operate to distinguish storage magazines holding content from those which are designated by the administrator to be employed as “live/hot” spares. With a fixed mapping of storage magazines to columns, in the event of a fault of a storage magazine, only those other magazines in its RAID group may participate in a RAID reconstruction. With a fairly uniform data distribution, any storage magazine failure may have the workload required to reconstitute the data distributed across all other active magazines in the complex.

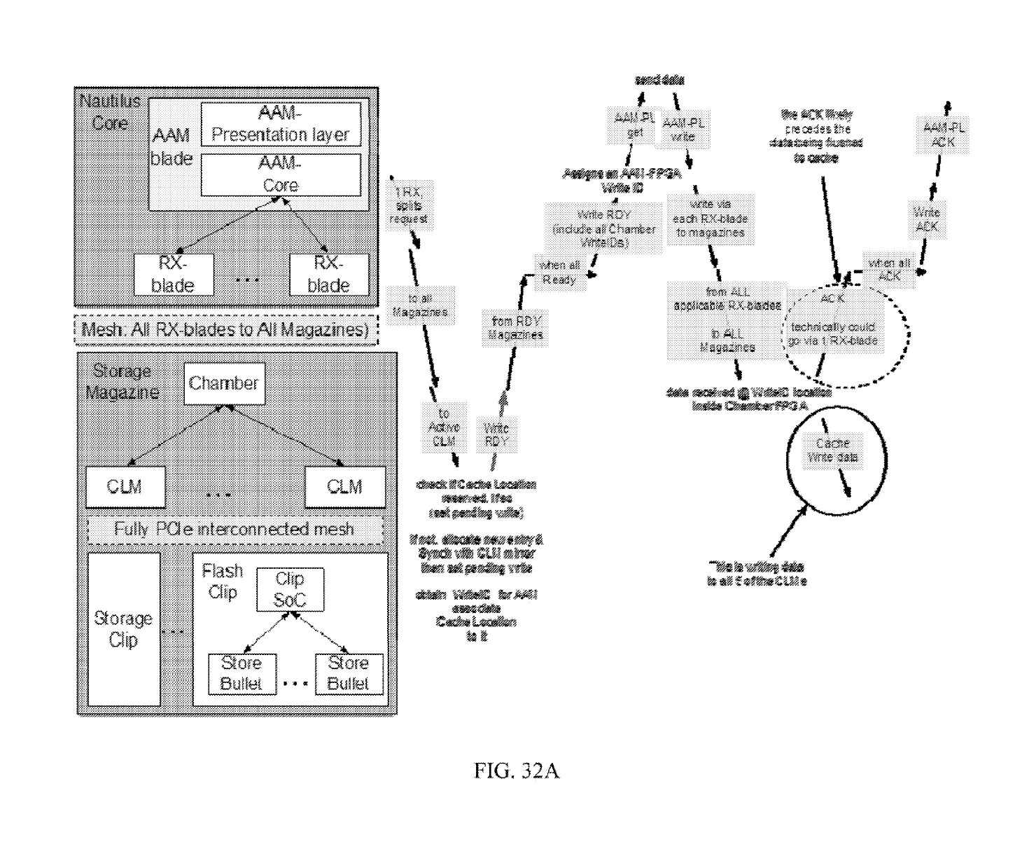

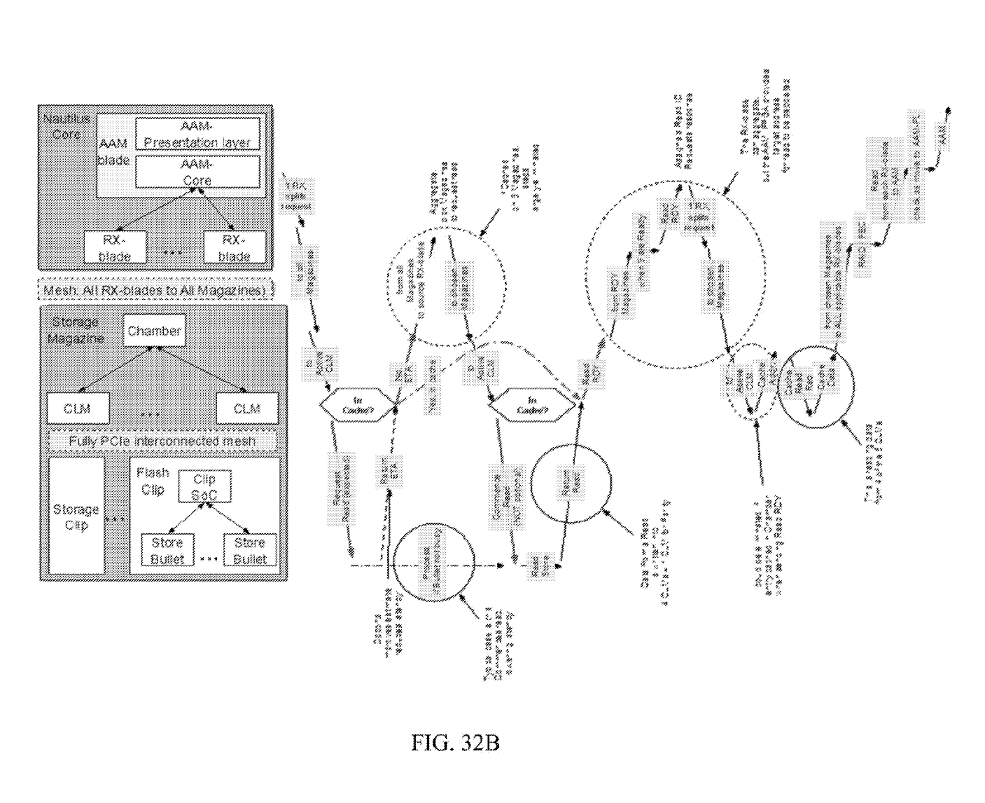

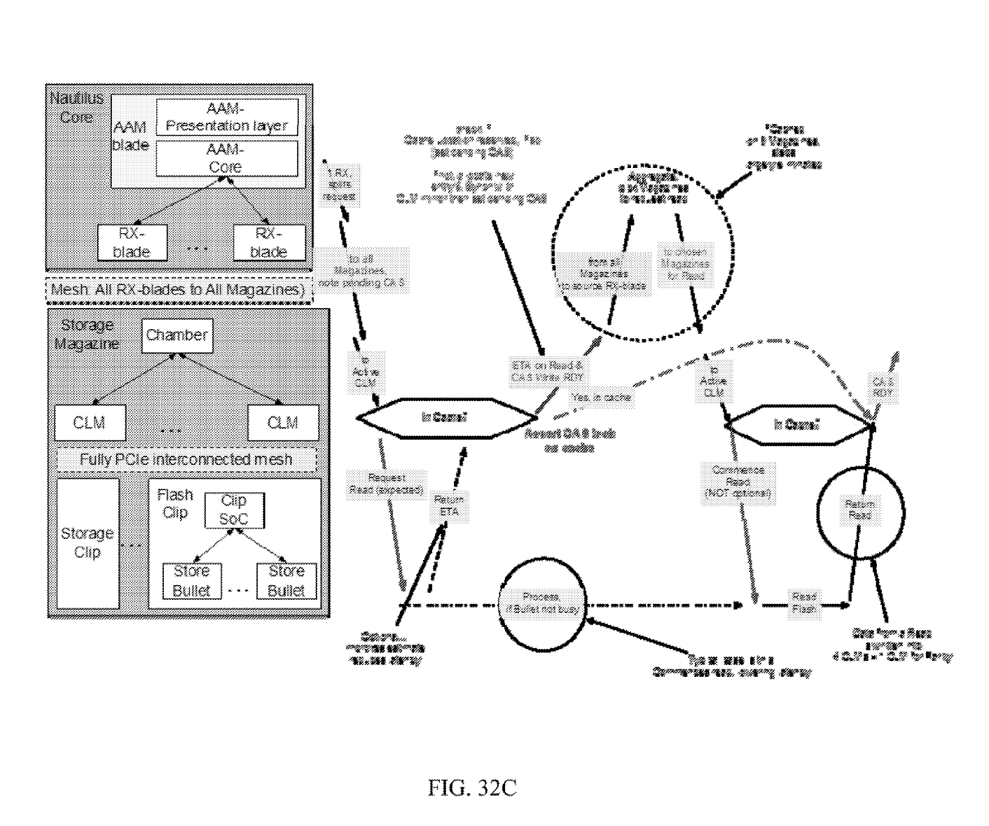

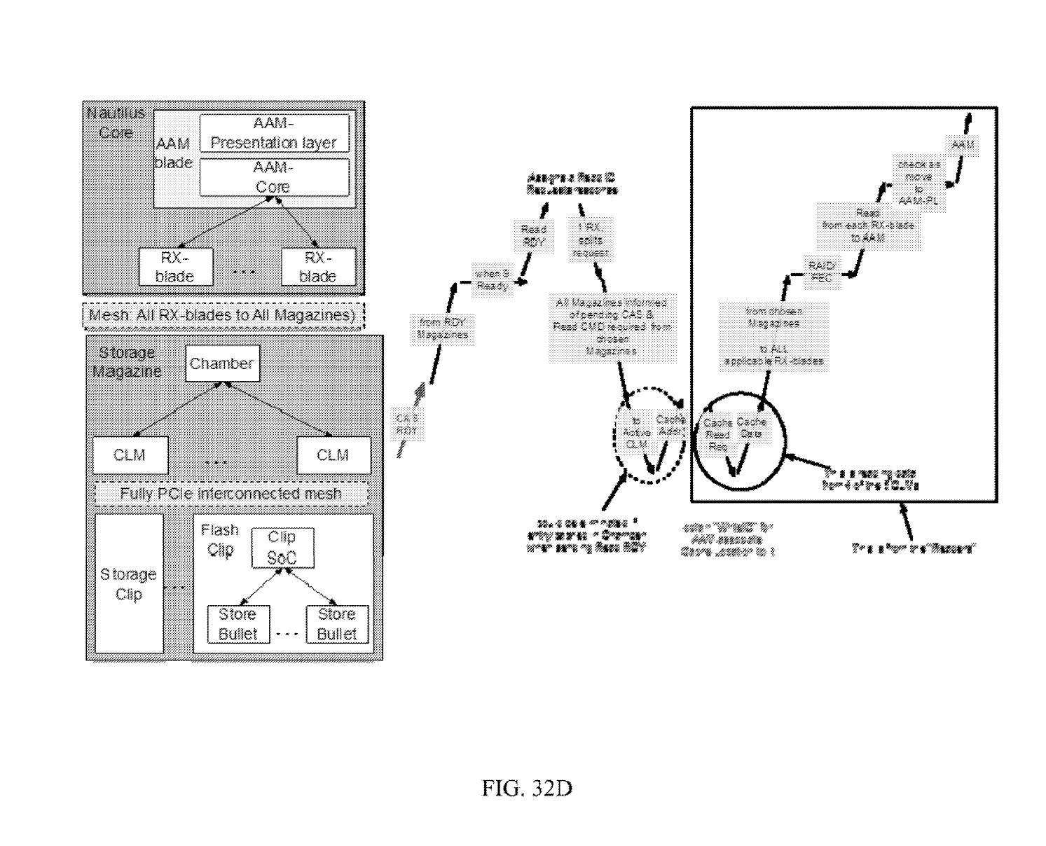

FIG. 32A depicts an illustrative write transaction for a large-scale data management system according to an embodiment. FIG. 32B depicts an illustrative read transaction for a large-scale data management system according to an embodiment. FIGS. 32C and 32D depict a first part and a second part, respectively, of an illustrative compare-and-swap (CAS) transaction for a large-scale data management system according to an embodiment.

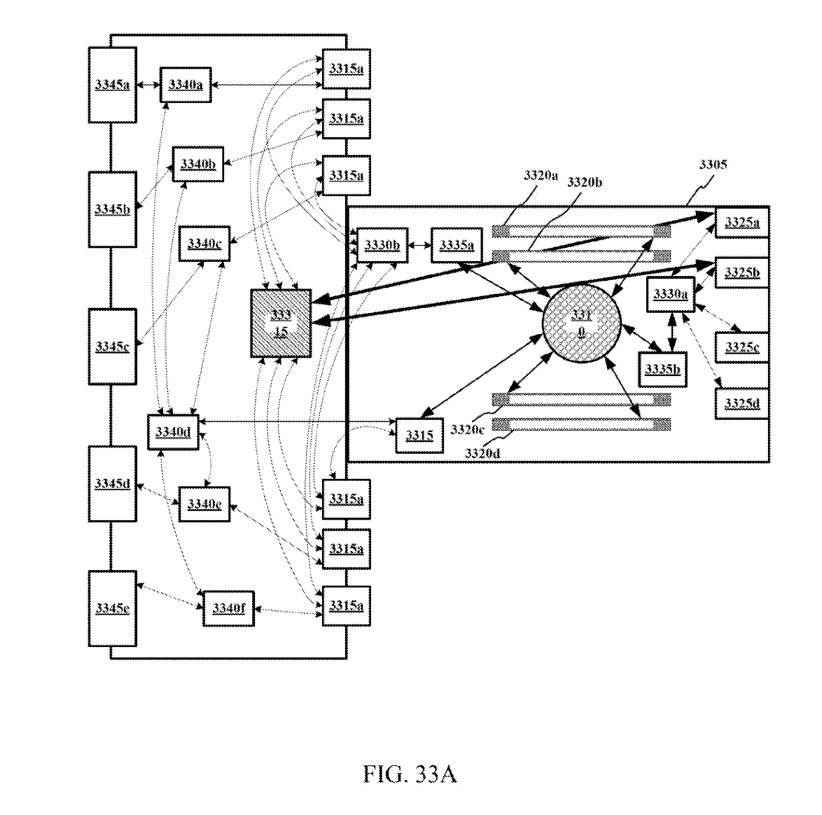

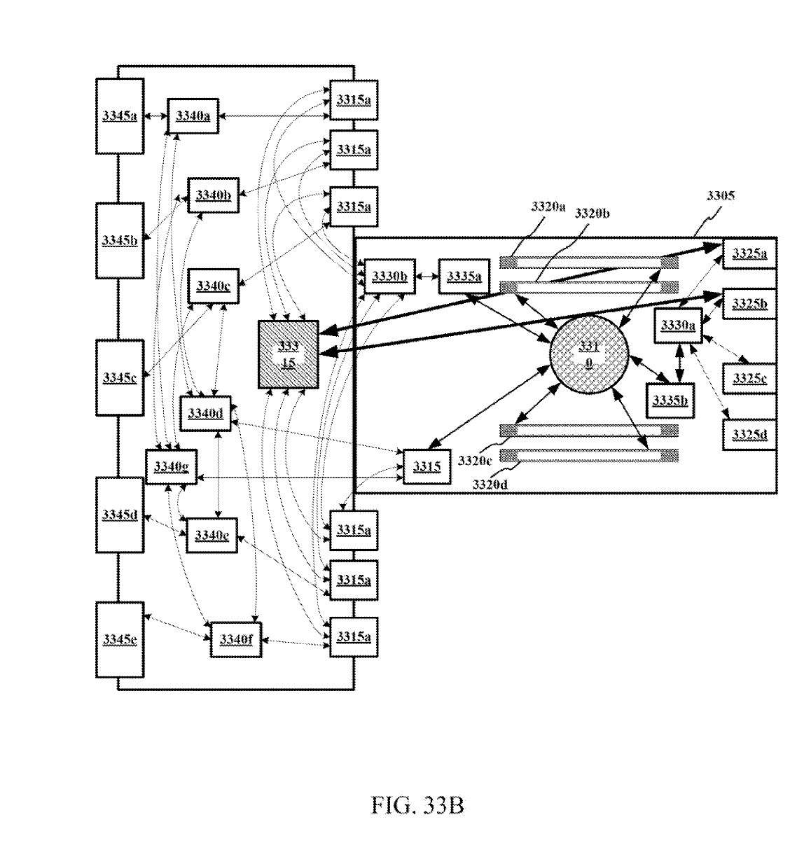

FIGS. 33A and 33B depict an illustrative storage magazine chamber according to a first and second embodiment, respectively. As shown in FIG. 33A, a storage magazine chamber 3305 may include a processor 3310 in operative communication with memory elements 3320a-3320b and various communication elements, such as an Ethernet communication elements 3335a, 3335b and PCIe switch 3340g (for example, a forty-eight (48) lane Gen 3 PCIe switch), for control access. A core controller 3315 may be configured to communicate to the data servicing cores via uplinks 3325a-3325d. A set of connectors 3315a-3315f may be configured to connect the chamber 3305 to cache lookup modules, while connectors 3345a-V45e may be configured to connect the chamber to the storage clips (for example, through risers). In an embodiment, the controller 3315 may be configured to communicate with cache lookup modules for cache and lookup through the connectors 3315a-3315f. Various communication switches 3340a-3340g (for example, PCIe switches) may be configured to provide communication within the chamber.

In an embodiment, all data may be transferred explicitly through the cache when being written by or read to data clients, for example, via the data servicing cores. Not all data need ever actually be written to the secondary store. For example, if some data is temporarily created, written by the core, and then “freed” (e.g., marked as no longer used, such as TRIM), the data may in fact be so transient that it is never written to the next level store. In such an event, the “writes” may be considered to have been “captured” or eliminated from having any impact on the back-end storage. Log files are often relatively small and could potentially fit entirely inside the cache of a system configured according to certain embodiments provided herein. In some embodiments, the log may have more data written to it than the amount of changes to the other storage, so the potential write load that is presented to the back-end storage may be cut significantly, for example, by half.

In an embodiment, workloads accessing very small locations at random order with no locality may see increased write load to the back-end storage because, for example, a small write may generate a read of a larger page from persistent storage and then later a write-back when the cache entry is evicted. More recent applications tend to be more content rich with larger accesses and/or perform analysis on data, which tends to have more locality. For truly random workloads, some embodiments may be configured to use a cache as large as the actual storage with minimal latency.

Additionally, the system may be configured to operate in the absence of any second level store. In an illustrative and non-restrictive example, for persistence, the cache lookup modules may be populated with a form of persistent memory, including, without limitation, magnetoresistive random-access memory (MRAM), phase-change memory (PRAM), capacitor/flash backed DRAM, or combinations thereof. In an embodiment, no direct data transfer path is required from the chamber controller 3315 to the secondary store, as the cache layer may interface directly to the secondary storage layer.

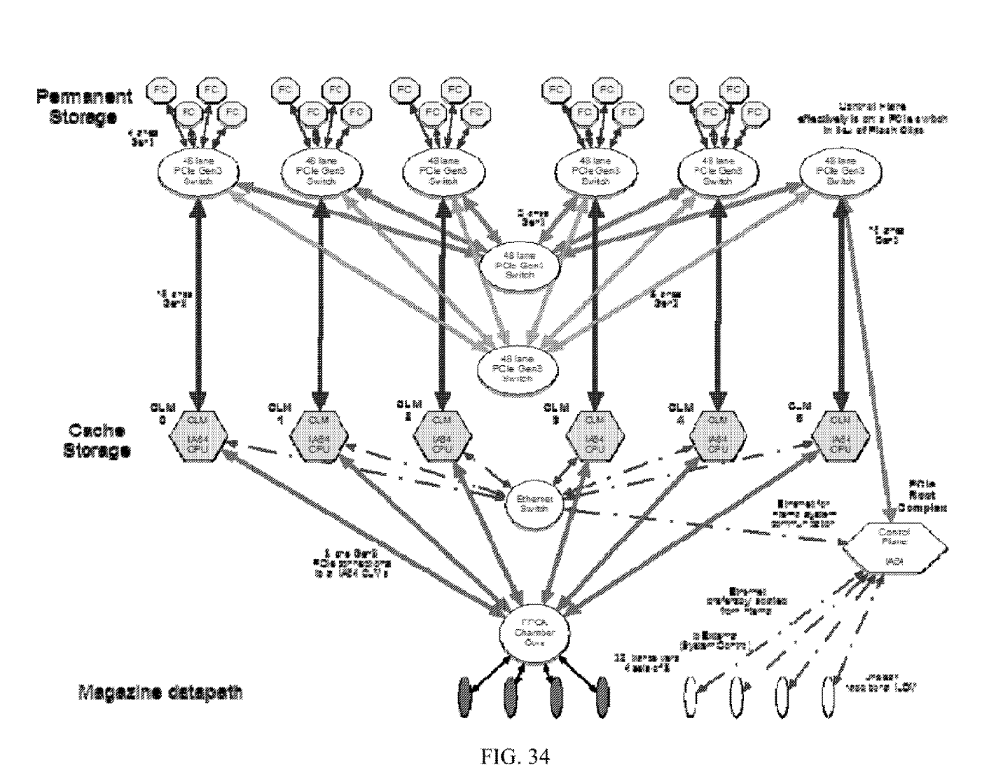

FIG. 34 depicts an illustrative system for connecting secondary storage to a cache. Within a storage magazine, a number of CLMs (such as CLM0-CLM5 in FIG. 34) may have connectivity to a number of persistent storage nodes (for example, PSMs). The RAID storage of the cache enables a large number of processors to share data storage for any data which may be accessed externally. This also provides a mechanism for structuring the connectivity to the secondary storage solution. In an embodiment, a PCIe switch may be directly connected to each CLM, with most of these connecting as well to a back-end storage node (or a central controller) and all of them connected to one or more “transit switches.”

While data in the permanent store may be stored uniquely within a storage magazine, a non-limiting example provides that the CLMs may have data stored in a RAID arrangement, including, without limitation 4+1 RAID or 8+1 RAID. In an embodiment, data transfer in the system may be balanced across the multiple “transit switches” for each transfer in the system. In an embodiment, a XOR function may be employed, where the XOR of the secondary storage node ID and the CLM ID may be used to determine the intermediate switch. Stored data in a RAID arrangement may operate to balance data transfers between the intermediate switches. According to some embodiments, deploying the RAID protected, and potentially volatile, cache may use writes from cache to persistent store that may come from a CLMs. For example, the writes may come from the CLMs which have the portions of real data in a non-fault scenario, as this saves a parity computation at the destination. Reads from the persistent store to cache may send data to all five CLMs where the data components and parity are stored. In an embodiment, a CLM may be configured to not have content for each cache entry. In this embodiment, the LPTs that point to the cache entry may be on any of the CLMs (such as CLM0-CLM5 of FIG. 34 mirrored to any of the remaining five).

Large caches may be formed according to certain embodiments provided herein. A non-limiting example provides that each storage magazine with 6 CLMs using 64 GB DIMMs may enable large-scale cache sizes. In an embodiment, each LPT entry may be 64 bits, for instance, so that it may fit in a single word line in the DRAM memory (64 bits+8 bit ECC, handled by the processor).

In an embodiment in which flash devices are used as the persistent storage, large-scale caches may enhance the lifetime of these devices. The act of accessing flash for a read may cause a minor “disturbance” to the underlying device. The number of reads that may cause a disturbance is generally measured in many thousands of accesses, but may be dependent on the inter-access frequency. The average cache turnover time may determine the effective minimum inter-access time to a flash page. As such, by having a large-scale cache, the time between successive accesses to any given page may be measured in many seconds, allowing for device stabilization.

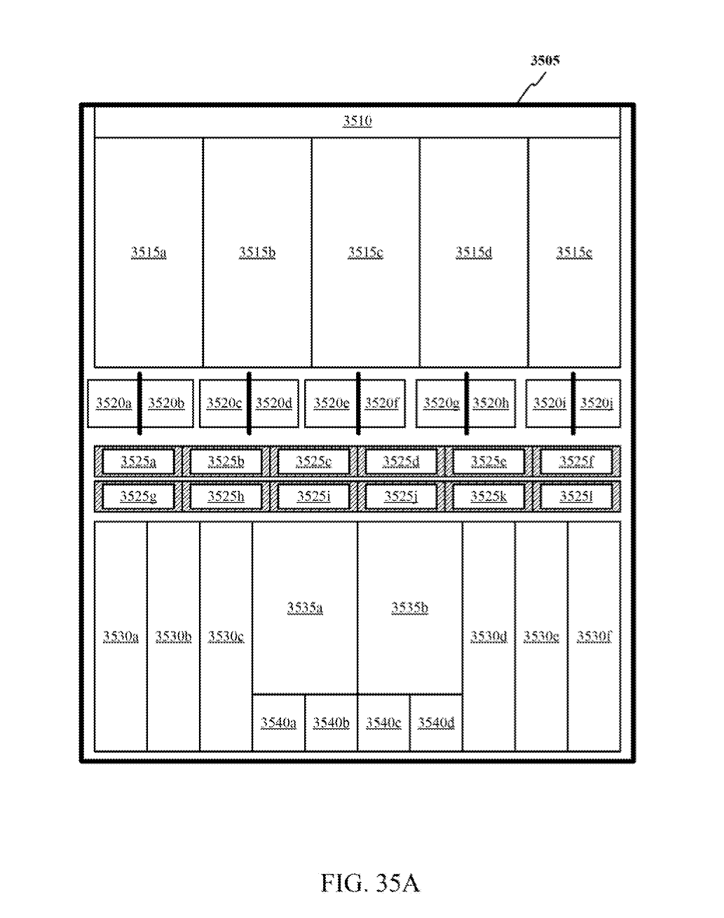

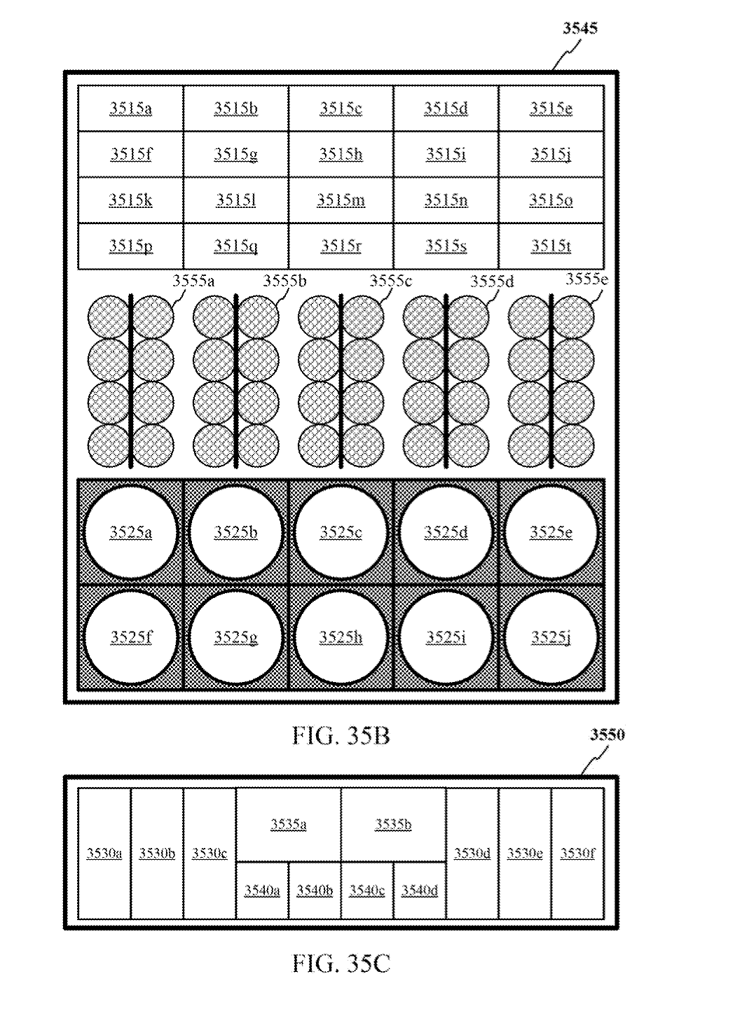

FIG. 35A depicts a top view of an illustrative storage magazine according to an embodiment. As shown in FIG. 35A, a storage magazine 3505 may include persistent storage elements 515a-515e (PSMs or storage clips) in operative communication with cache lookup modules 3530a-3530f. Redundant power supplies 3535a, 3535b and Ultracapacitors and/or batteries 3520a-3520j may be included to power and/or facilitate power management functions for the storage magazine 3505. A set of fans 3525a-35251 may be arranged within the storage magazine 1405 to cool components thereof. FIG. 35B depicts an illustrative media-side view of the storage magazine 1405 depicting the arrangement of power distribution and hold units 3555a-3555e for the storage magazine. FIG. 35C depicts a cable-side view of the storage magazine 3505.

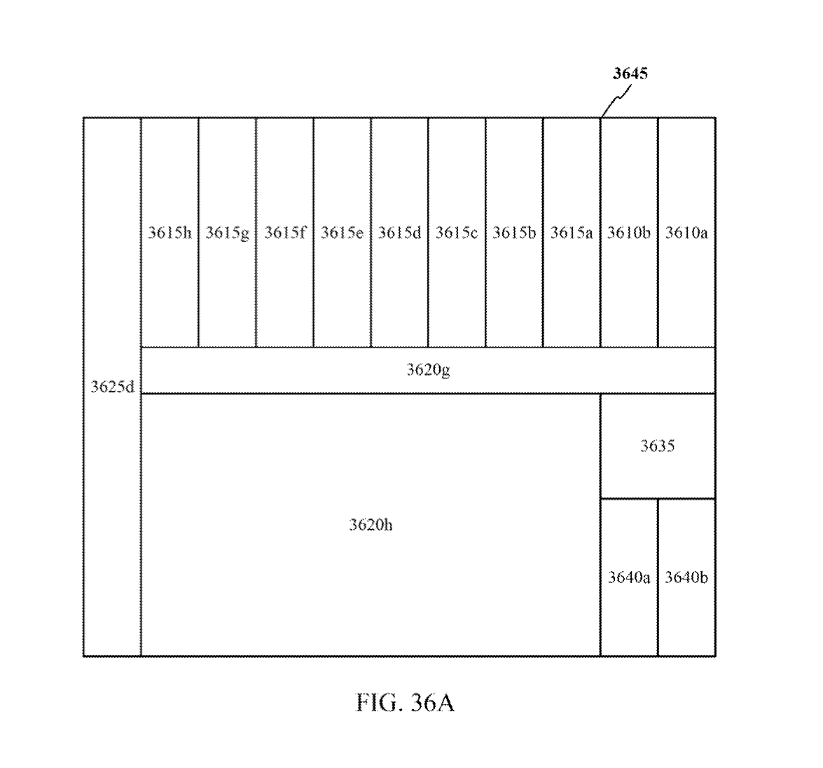

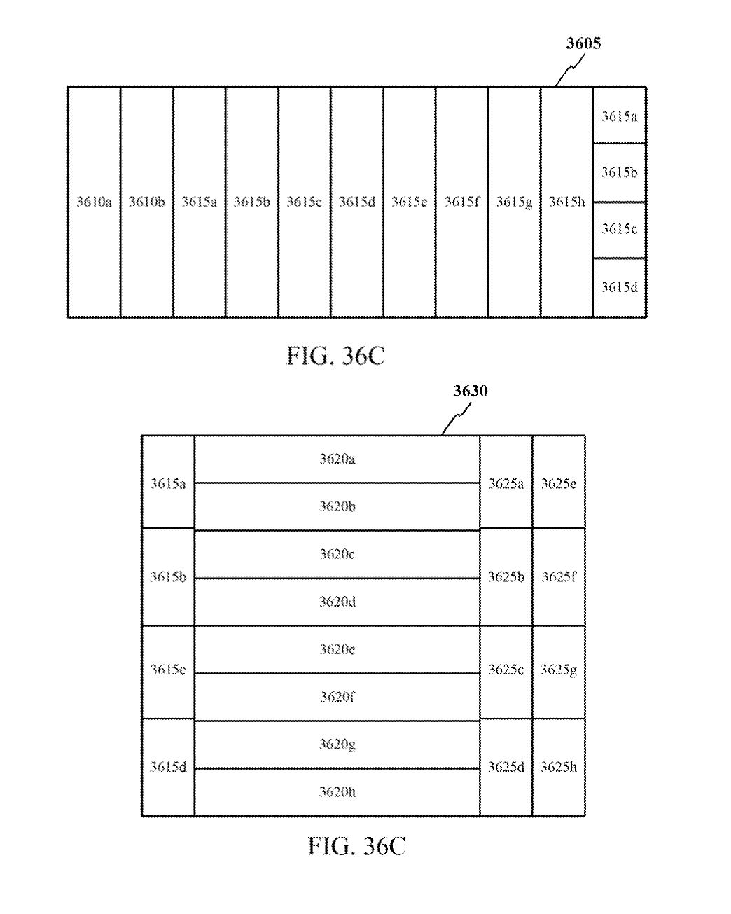

FIG. 36A depicts a top view of an illustrative data servicing core according to an embodiment. As shown in FIG. 36A, a data servicing core 3605 may include RX-blades 3615a-3615h, control cards 3610a, 3610b and AAMs 3620h connected through midplane connectors 3620g. A redistribution layer 3625d may provide connections between the RX-blades 3615a-3615h and the storage magazines. The data servicing core 3605 may include various power supply elements, such as a power distribution unit 3635 and power supplies 3640ab, 3640b. FIGS. 36B and 36C depict a media-side view and a cable-side view, respectively, of the illustrative data servicing core shown in FIG. 36A. In an embodiment, one or more RX-blades 3615a-3615h may implement some or all of a reliability layer, for example, with connections on one side to the magazines via an RDL to the midplane and to the AAMs.

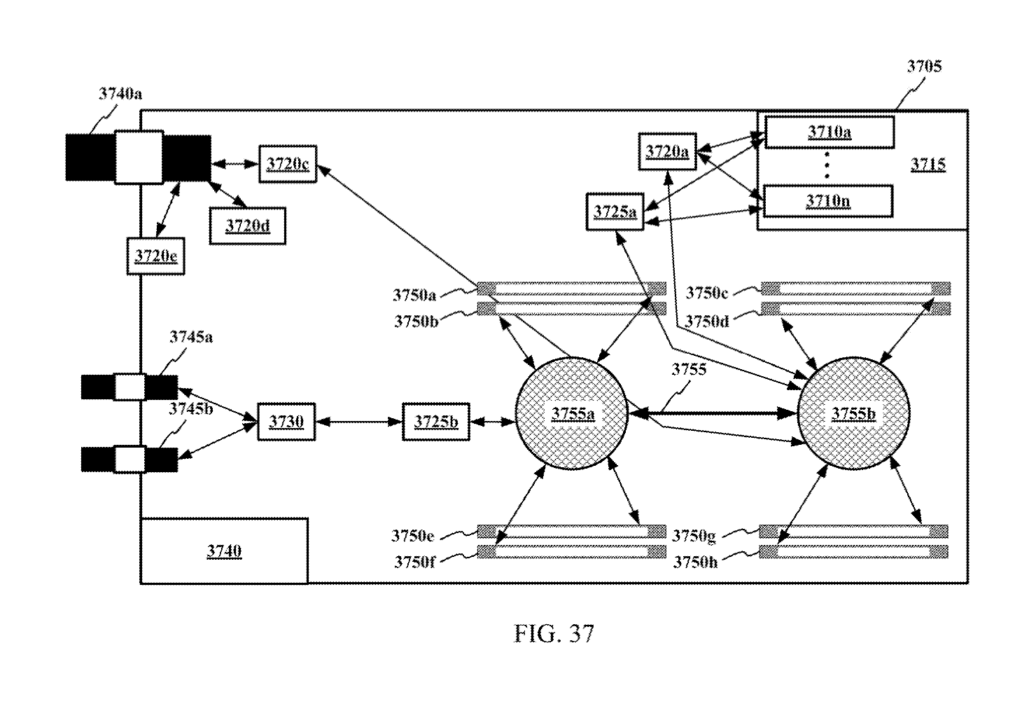

FIG. 37 depicts an illustrative chamber control board according to an embodiment. As shown in FIG. 37, a chamber control board 3705 may include processors 3755a, 3755b in operable communication with memory elements 3750a-3750h. A processor-to-processor communication channel 3755 may interconnect the processors 3755a, 3755. The chamber control board 3705 may be configured to handle, among other things, interfacing of the data servicing core with the chamber, for example through an uplink module 3715. In an embodiment, the uplink modules 375 may be configured as an optical uplink module having uplinks to data servicing core control 3760a, 3760b through an Ethernet communication element 3725a and to RX-blades 3710a-3710n through a PCIe switch 3720a. In an embodiment, each signal may be carried in a parallel link (for example, through wavelength division multiplexing (WDM)). In an embodiment, the PCIe elements 3720a-3720e may auto-negotiate the number of lanes of width as generation for data transmission (e.g., PCIe Gen 1, Gen 2 or Gen 3), such that the width of links on one generation of cards need not be exactly aligned with the maximum capabilities of the system. The chamber control board 3705 may include a PCIe connector 3740, for connecting the chamber control board to cache lookup modules, and Ethernet connectors 3745a, 3745b for connecting to the control communication network of the data management system.

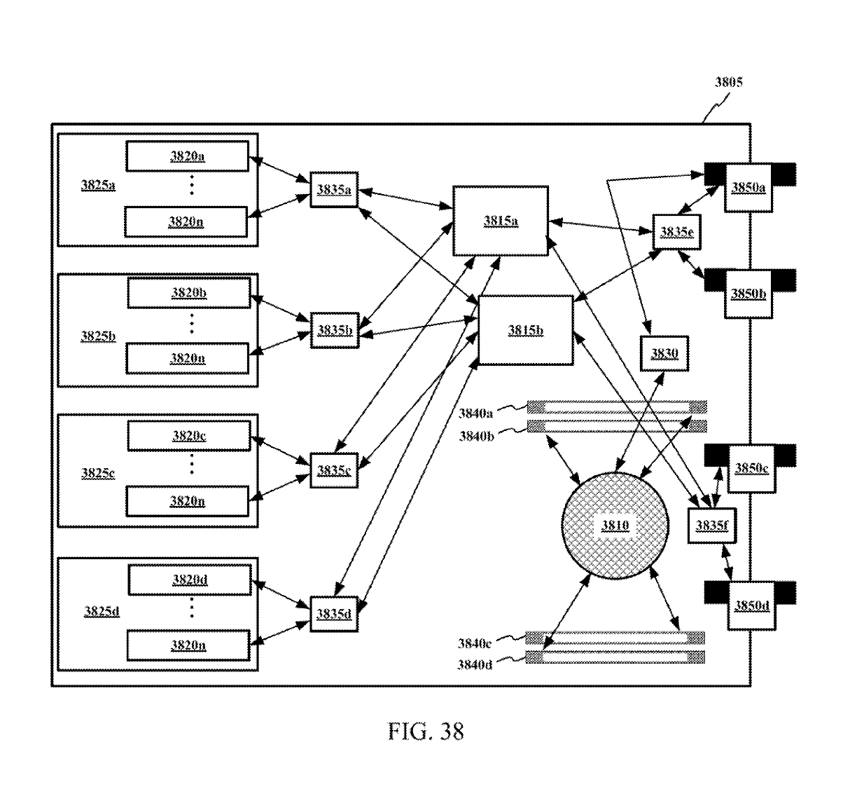

FIG. 38 depicts an illustrative RX-blade according to an embodiment. As shown in FIG. 38, the RX-blade 3805 may include a processor 3810 operatively coupled to memory elements 3840a-3840d. According to some embodiments, the memory elements 3840a-3840d may include DIMM and/or flash memory elements arranged in one or more memory channels for the processor 310. The processor 3810 may be in communication with a communication element 3830, such as an Ethernet switch (eight (8) lane).

The RX-blade 3805 may include uplink modules 3825a-3825d configured to support storage magazines 3820a-3820n. In an embodiment, the uplink modules 3825a-3825d may be optical. In another embodiment, the uplink modules 3825a-3825d may include transceivers, for example, grouped into sets (of eight (8)) with each set being associated with a connector via an RDL.

One or more FEC/RAID components 3815a, 3815b may be arranged on the RX-blade 3805. In an embodiment, the FEC/RAID components 3815a, 3815b may be configured as an endpoint. A non-limiting example provides that if the functionality for the FEC/RAID components 3815a, 3815b is implemented in software on a CPU, the node may be a root complex. In such an example, the PCIe switches which connect to it the FEC/RAID components 3815a, 3815b may employ non-transparent bridging so the processors on either side (Storage Magazine Chamber or AAM) may communicate more efficiently with them.

The FEC/RAID components 3815a, 3815b may be in communication with various communication elements 385a-385e. In an embodiment, at least a portion of the communication elements 385a-385e may include PCIe switches. The FEC/RAID components 3815a, 3815b may be in communication through connectors 3850a-3850d and the uplink modules 3825a-3825d and/or components thereof through the communication elements 385a-385e.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A data storage array comprising:
at least one array access module operatively coupled to a plurality of computing devices, the at least one array access module being configured to:
receive data requests from the plurality of computing devices, the data requests comprising read requests and write requests,
format the data requests for transmission to a data storage system comprising a cache storage component and a persistent storage component, and
format output data in response to a data request for presentation to the plurality of computing devices; and
at least one cache lookup module operatively coupled to the at least one array access module and the persistent storage component, the at least one cache lookup module having at least a portion of the cache storage component arranged therein, wherein the at least one cache lookup module is configured to:
receive the data requests from the at least one array access module, lookup meta-data associated with the data requests in the data storage system, read output data associated with read data requests from the data storage system for transmission to the at least one array access module, and
store input data associated with the write data requests in the data storage system.

2. A data storage array comprising:
at least one access module operatively coupled to a plurality of computing devices, the at least one access module being configured to:
receive data requests from the plurality of computing devices, the data requests comprising read requests and write requests,
format the data requests for transmission to a data storage system comprising a cache storage layer and a persistent storage layer, wherein:
the cache storage layer comprises at least one cache storage component, and
the persistent storage layer comprises at least one persistent storage module, wherein the at least one persistent storage module comprises a plurality of persistent storage components; and
format output data in response to a data request for presentation to the plurality of computing devices; and
at least one cache lookup module operatively coupled to the at least one access module and the persistent storage layer, the at least one cache lookup module having at least a portion of the cache storage layer arranged therein, wherein the at least one cache lookup module is configured to:
receive the data requests from the at least one access module,
lookup meta-data associated with the data requests in the data storage system, read output data associated with read data requests from the data storage system for transmission to the at least one access module, and
store input data associated with the write data requests in the data storage system, and update and record the meta-data associated with the data requests in the data storage system.

3-6. (canceled)

7. The data storage array of claim 2, wherein the at least one access module comprises a processor operatively coupled to the plurality of computing devices, the processor being configured to receive the data requests from the plurality of computing devices and to format the output data for presentation to the plurality of computing devices.

8. The data storage array of claim 2, wherein the at least one access module comprises an integrated circuit operatively coupled to the processor, the integrated circuit being configured to:
receive data requests from the processor, and
format the data requests for presentation to the at least one cache lookup module.

9. (canceled)

10. The data storage array of claim 2, wherein the cache storage component comprises at least one of a dynamic random access memory module, a dual in-line memory module, and a flash memory module.

11. (canceled)

12. (canceled)

13. The data storage array of claim 2, wherein the at least one persistent storage module comprises at least one of a plurality of hard disk drives, a plurality of optical drives, a plurality of solid state drives, and at least one network-connected external storage server.

14-21. (canceled)

22. The data storage array of claim 2, wherein the at least one cache lookup module is further configured to read requested data from the persistent storage layer responsive to the requested data not being stored in the cache storage component.

23. The data storage array of claim 22, wherein the at least one cache lookup module is further configured to store the requested data from the persistent storage layer in the cache storage component before transmitting the requested data to the at least one access module.

24. The data storage array of claim 2, wherein the at least a portion of the plurality of persistent storage components comprise flash cards.

25. The data storage array of claim 24, wherein each of the plurality of flash cards comprises a plurality of flash chips configured to store data.

26-28. (canceled)

29. The data storage array of claim 2, wherein Ethernet is used for control path communications and peripheral component interconnect express is used for internal data path communications.

30-40. (canceled)

41. The data storage array of claim 2, wherein the plurality of persistent storage components are arranged into logical tiers according to characteristics of each of the plurality of persistent storage components.

42. The data storage array of claim 2, wherein a processor-to-processor communication channel is used for control path communication within the data storage array.

43. A method of manufacturing a data storage array, the method comprising:
providing at least one access module configured to be operatively coupled to a plurality of computing devices;
configuring the at least one access module to:
receive data requests from the plurality of computing devices, the data requests comprising read requests and write requests,
format the data requests for transmission to a data storage system comprising a cache storage layer and a persistent storage layer, wherein:
the cache storage layer comprises at least one cache storage component, and,
the persistent storage layer comprises at least one persistent storage module, wherein
the at least one persistent storage module comprises a plurality of persistent storage components; and
format output data in response to a data request for presentation to the plurality of computing devices;
providing at least one cache lookup module configured to be operatively coupled to the at least one access module and the persistent storage layer,
arranging at least a portion of the cache storage layer within the at least one cache lookup module; and
configuring the at least one cache lookup module to:
receive the data requests from the at least one access module,
lookup meta-data associated with the data requests in the data storage system,
read output data associated with read data requests from the data storage system for transmission to the at least one access module, and
store input data associated with the write data requests in the data storage system, and
update and record the meta-data associated with the data requests in the data storage system.

44. (canceled)

45. The method of claim 43, further comprising providing an integrated circuit resident within the at least one access module and operatively coupled to the processor, the integrated circuit being configured to:
receive data requests from the processor, and
format the data requests for presentation to the at least one cache lookup module.

46. (canceled)

47. (canceled)

48. The method of claim 43, further comprising configuring the cache storage component to store data using at least one of a dynamic random access memory module and a flash memory module.

49. (canceled)

50. (canceled)

51. The method of claim 43, further comprising arranging a plurality of flash cards within the persistent storage module for storing data in the persistent storage layer.

52. The method of claim 51, further comprising arranging a plurality of flash chips on the flash cards for storing data on the plurality of flash cards.

53. (canceled)

54. (canceled)

55. A method of managing access to data stored in a data storage array for a plurality of computing devices, the method comprising:
operatively coupling at least one access module to a plurality of computing devices; receiving data requests from the plurality of computing devices at the at least one access module, the data requests comprising read requests and write requests;
formatting, by the at least one access module, the data requests for transmission to a data storage system comprising a cache storage layer and a persistent storage layer, wherein the cache storage layer comprises at least one cache storage component, and the persistent storage layer comprises at least one persistent storage module, wherein the at least one persistent storage module comprises a plurality of persistent storage components; and
formatting, by the at least one access module, output data in response to a data request for presentation to the plurality of computing devices;
operatively coupling at least one cache lookup module to the at least one access module and the persistent storage layer, the at least one cache lookup module having at least a portion of the cache storage layer arranged therein;
receiving the data requests from the at least one access module at the at least one cache lookup module;
looking up, by the at the at least one cache lookup module, meta-data associated with the data requests in the data storage system;
reading, by the at the at least one cache lookup module, output data associated with read data requests from the data storage system for transmission to the at least one access module; and
storing, by the at the at least one cache lookup module, input data associated with the write data requests in the data storage system, and
updating and recording the meta-data associated with the data requests in the data storage system.

56. The method of claim 55, wherein the at least one access module stores the input data in the cache lookup modules.

57. (canceled)

58. The method of claim 55, wherein the data storage array comprises at least 6 cache lookup modules and the at least one access module stores the input data in the at least one cache lookup module using at least one of a 4+1 parity method and a 4+2 parity method.

59. (canceled)

60. The method of claim 55, wherein the data storage array comprises at least 11 persistent storage modules and the at least one access module stores the input data in the at least one cache lookup module using at least one of a 9+2 dual parity method and an erasure code parity method.

61. (canceled)

62. The method of claim 55, wherein the data storage array applies a second parity method to the data in the cache storage components that is separate from and logically orthogonal to the parity method applied to data in the persistent data modules.

63-65. (canceled)

66. The method of claim 55, wherein the at least one access module formats the data requests by arranging the data requests into a fixed size logical data envelope.

67. The method of claim 66, wherein the at least one access module divides the logical data envelope for distribution to a plurality of cache lookup modules.

68. The method of claim 55, further comprising de-staging, by the at least one cache lookup module, infrequently used data from the cache storage layer to the persistent storage layer.

69. The method of claim 68, wherein the cache lookup modules are configured to de-stage based on backup power duration times.

70. The method of claim 55, further comprising evicting, by the at least one cache lookup module, unmodified and infrequently used data from the cache storage layer.

71. The method of claim 70, wherein the cache lookup modules are configured to evict based on backup power duration times.

72. The method of claim 55, further comprising configuring the at least one cache storage components to store data using at least one dual in-line memory module.

73. (canceled)

74. The method of claim 55, wherein the at least one cache lookup module stores the input data in the at least one cache storage components using a multi-way mirroring method.

75. The method of claim 55, wherein the data storage array distributes the meta-data across a number of cache lookup modules such that all incorporated access modules have symmetric access to any data stored in the data storage system.

76-79. (canceled)

80. The method of claim 55, further comprising interconnecting processors within the data storage array via a memory mapped region, wherein non-transparent mode address translation provides each processor with a memory region for writing.

81-83. (canceled)

84. The method of claim 55, wherein the at least one access module is configured to communicate with the at least one persistent storage module via the at least one cache lookup module.

85. The method of claim 55, wherein the at least one cache lookup module stores data in the persistent storage layer as single level pages under power-loss conditions, thereby improving write bandwidth and reducing power consumption of writes.

86. The method of claim 55, wherein data is stored within the data storage array according to a parity mechanism using a processor to divide a write request among a plurality of cache storage components.

87. The method of claim 55, wherein data is stored within the data storage array according to a parity mechanism using a processor to assemble a read among a plurality of cache storage components.

88. The method of claim 55, wherein peripheral component interconnect express switches are used to divide a write request among a plurality of cache storage components.

89. The method of claim 55, wherein optical data switches are used to divide a write request amongst among a plurality of cache storage components.

90. The method of claim 55, wherein peripheral component interconnect express switches are used to assemble a read request among a plurality of cache storage components.

91. (canceled)

92. The method of claim 55, further comprising configuring the at least one persistent storage module to mark pages to denote whether the data is valid, overwritten, or freed in its entirety.

93. (canceled)

94. (canceled)
